(19) United States
(12) Patent Application Publication
(10) Pub. No.: US 2015/0252255 A1
(43) Pub. Date: Sep. 10, 2015

(54) Compounds and Methods for Enhancing Metal Luminescence that Can be Selectively Turned Off

(71) Applicant: Queen's University at Kingston, Kingston (CA)

(72) Inventors: Suning Wang, Kingston (CA); Maria Vartan, Ottawa (CA); Barry A. Blight, Kingston (CA); Larissa Frances Smith, Kingston (CA); Hee-Jun Park, Kingston (CA)

(21) Appl. No.: 14/430,302

(22) PCT Filed: Sep. 26, 2013
(86) PCT No.: PCT/CA2013/000832

§ 371 Date: Mar. 23, 2015

Related U.S. Application Data
(60) Provisional application No. 61/706,295, filed on Sep. 27, 2012.

(30) Foreign Application Priority Data
Sep. 12, 2013 (CA) 2,827,248

(51) Int. Cl. C09K 11/06; G01N 21/64; C07F 5/02

(52) U.S. Cl. CPC C09K 11/06; C07F 5/027; G01N 21/64; C09K 2211/182; C09K 2211/1096; C09K 2211/1022; C09K 2211/1014; G01N 2201/062

(57) ABSTRACT

Organoboron ligands have been reacted with rare earth metal ions to form complexes. These ligands enhance the metal ion's luminescence, wherein enhancement of luminescence can be turned off selectively by the presence of fluoride or cyanide and luminescence at a different wavelength is turned on. Methods of detection of fluoride, cyanide and biological markers are described.

### FIELD OF THE INVENTION

The field of the invention is complexes of rare earth metal ions bound by organoboron ligands. More specifically, the field of the invention is activation of luminescence of rare earth metal ions and use thereof for detection of chemicals, including biological markers.

### BACKGROUND OF THE INVENTION

Rare earth metal-based luminescent compounds are an attractive class of materials owing to distinct and exceptionally narrow f→f emission bands which result in high colour purity of emitted light (pure blue, pure green, pure red, pure yellow, etc.). When a photon is absorbed and consequently an electron is excited, its excess energy may be dissipated through vibrational relaxation, or by emission of a photon. Emissive colour depends on the rare earth metal ion but is also dependent on the environment of the ion. Their luminescence also has long decay lifetimes (typically millisecond) and large Stokes shifts (i.e., difference in energy between emitted photon and absorbed photon). Unfortunately, rare earth metal ion emission is usually difficult to see because the compounds exhibit low extinction coefficients caused by the forbidden nature of f→f transitions.

There is a need for enhancement of rare earth metal ions' luminescence. With enhancement, the beautifully pure luminescent colours that appear when these compounds are exposed to UV light could be seen and used in, for example, electroluminescent devices, sensors, dyes, inks, and cellular imaging. Insufficient dietary intake of fluoride can lead to poor dental health, osteosclerosis, and osteoporsis. However, excess fluoride is known to cause fluorosis, osteosarcoma, and arthritis. There are no simple and inexpensive tests for detecting fluoride in water. There is a need for a simple and inexpensive test for quantifying fluoride in water.

### SUMMARY OF THE INVENTION

An aspect of the invention provides a method of enhancing luminescence of rare earth metal ions comprising reacting rare earth metal ions with a triarylboron ligand to form a complex, and irradiating the complex with UV light, wherein the triarylboron ligand comprises a binding portion and a boron atom that is bound to three aryl moieties such that there are six positions of the aryl moieties that are ortho to the boron and the boron is sterically encumbered by substituents at two or more of the six ortho positions, wherein (i) at least two substituents at the six ortho positions comprise two or more carbons or (ii) at least four substituents at the six ortho positions are C₁.

In an embodiment of this aspect, the aryl moieties are heteroaryl. In certain embodiments of this aspect, the heteroatom of the heteroaryl participates in binding the rare earth metal ion. In another embodiment of this aspect the heteroatom of the heteroaryl participates in binding the rare earth metal ion. In yet another embodiment of this aspect, the rare earth metal is lanthanum, cerium, praseodymium, neodymium, promethium, samarium, europium, gadolinium, terbium, dysprosium, holmium, erbium, thulium, ytterbium, or lutetium. In other embodiments, the rare earth metal is scandium or yttrium. In another embodiment of this aspect, the rare earth metal is Tb or Eu.

In certain embodiments of this aspect, the complex is 1Tb, 1Eu, 2Tb, 2Eu, 3Tb, 4Tb, 5Eu, 6Eu, Tb(L20)₃(Lₙₒₙ₋ₑₘᵢₛₛᵢᵥₑ)ₓ, Tb(L30)₃(Lₙₒₙ₋ₑₘᵢₛₛᵢᵥₑ)ₓ, Tb(L60)₃(Lₙₒₙ₋ₑₘᵢₛₛᵢᵥₑ)ₓ, Eu-10, Eu-20, Eu(L60)₃(Lₙₒₙ₋ₑₘᵢₛₛᵢᵥₑ)ₓ, Tb(L60)₃(Lₙₒₙ₋ₑₘᵢₛₛᵢᵥₑ)ₓ, Tb(L70)₃(Lₙₒₙ₋ₑₘᵢₛₛᵢᵥₑ)ₓ, Tb(L80)₃(Lₙₒₙ₋ₑₘᵢₛₛᵢᵥₑ)ₓ, Eu(L20)₃(Lₙₒₙ₋ₑₘᵢₛₛᵢᵥₑ)ₓ, Eu(L30)₃(Lₙₒₙ₋ₑₘᵢₛₛᵢᵥₑ)ₓ, Eu(L60)₃(Lₙₒₙ₋ₑₘᵢₛₛᵢᵥₑ)ₓ, Eu(L70)₃(Lₙₒₙ₋ₑₘᵢₛₛᵢᵥₑ)ₓ, or Eu(L80)₃(Lₙₒₙ₋ₑₘᵢₛₛᵢᵥₑ)ₓ.

In another aspect of the invention, the triarylboron ligand is represented by a compound of formula (I)

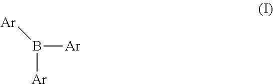

where B is boron, and Ar is an aryl moiety that is a substituted or unsubstituted 5- or 6-membered ring that is optionally part of a fused ring system, wherein the B is sterically encumbered by the presence of same or different non-hydrogen substituents located ortho to the boron, wherein if the substituents are only C₁, then at least four of the ortho positions are C₁, and if the substituents are C_{2-or-higher}, then at least two of the ortho positions are C_{2-or-higher}, and wherein at least one Ar comprises a moiety that can bind to a metal ion.

In an embodiment of this aspect, the ligand is represented by a compound of formula (II):

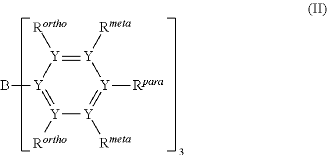

where B is boron, Y is C or a heteroatom, R^{meta} and R^{para} are independently H, C₁-C₆ aliphatic, or aryl, and optionally are further substituted by COOH, COOR; C(O)C═C(OH)R, arylCOOH, aryl(COOH)₂, arylNR₂ (R═H, pyridyl or aliphatic), aliphatic-OH, aliphatic-COOH, or combinations thereof, and R^{ortho} is H or C₁-C₄ aliphatic, wherein B is sterically encumbered such that at least four of the six R^{ortho}'s are non-hydrogen when R^{ortho} is H or C₁, wherein at least two of the six R^{ortho}'s are non-hydrogen when R^{ortho} is H or C_{2-or-higher}, and wherein the compound comprises a moiety that is capable of bonding with a rare earth metal ion. In another embodiment of this aspect, the moiety that is capable of bonding with a rare earth metal ion is carboxy. In another embodiment of this aspect of the invention, all six of the ortho positions are non-hydrogen.

Another aspect of the invention provides a method of detecting fluoride, cyanide or a biological marker comprising contacting a test solution that potentially comprises fluoride, cyanide or a biological marker with a medium comprising a triarylboron bound-rare earth metal complex, irradiating the medium with UV light, and determining whether luminescence is produced at the wavelength of the ligand's fluorescence thereby indicating the presence of fluoride, cyanide or a biological marker, or whether luminescence is produced at the wavelength of the metal ion's emission thereby indicating the absence of fluoride, cyanide or a biological marker, wherein the triarylboron bound-rare earth metal complex comprises a triarylboron ligand, which comprises a boron bound to three aryl moieties having a total of six ortho positions relative to the boron, and the boron is sterically encumbered by substituents that are located at two or more of the six ortho positions, wherein (i) at least two of the six ortho positions are independently C_{2-or-higher}, or (ii) at least four of the six ortho positions are C₁, and optionally all six of the ortho positions are non-hydrogen. In an embodiment of this aspect, the medium is liquid. In another embodiment, the medium is paper impregnated with the complex. In another embodiment of this aspect, the medium is a polymer or resin.

In another aspect, the invention provides a metal complex compound comprising a rare earth metal ion and a triaryl boron ligand, wherein the triarylboron ligand comprises a boron atom bound to three substituted or unsubstituted aryl moieties such that there are six substituent positions on the aryl moieties that are ortho to the boron, and the boron is sterically encumbered by substituents at two or more of the six ortho positions, wherein (i) at least two of the six ortho positions are C_{2-or-higher} or (ii) at least four of the six ortho positions are C₁, and optionally all six of the ortho positions are non-hydrogen, and wherein at least one of the three aryl moieties comprises a moiety that is capable of binding a rare earth metal ion.

In an embodiment of this aspect, the aryl moieties are heteroaryl. In another embodiment of this aspect, the three aryl moieties are mesityl, mesityl and benzoate. In yet another embodiment of this aspect, the three aryl moieties are mesityl, mesityl and diphenylcarboxylate. In certain embodiments of this aspect, at least one aryl moiety is carboxy-substituted. In another embodiment of this aspect, two of the aryl moieties are carboxy-substituted. In another embodiment, the aryl moieties are carboxy-substituted. In yet another embodiment, an aryl moiety is pyridine. In certain embodiments of this aspect of the invention, the moiety that is capable of binding a rare earth metal ion is the nitrogen of the pyridine ring. In embodiments of this aspect, the ligand is a ligand that is shown in Table 3.

Yet another aspect of the invention is Ligand 1. Another aspect of the invention is Ligand 2. Another aspect of the invention is Ligand 3. Yet another aspect of the invention is Ligand 4. Another aspect of the invention is Ligand 5. A further aspect of the invention is Ligand 6. A further aspect of the invention is Ligand L10. A further aspect of the invention is Ligand L20. A further aspect of the invention is Ligand L30. A further aspect of the invention is Ligand L40. A further aspect of the invention is Ligand L50. A further aspect of the invention is Ligand L60. A further aspect of the invention is Ligand L70. Another aspect of the invention is Ligand L80.

Another aspect of the invention is complex 1Tb (Another aspect of the invention is complex 1Eu. Yet another aspect of the invention is complex 2Tb. Another aspect of the invention is complex 2Eu. Yet another aspect of the invention is complex 3Tb. A further aspect of the invention is complex 4Tb. Another aspect of the invention is complex 5Eu. Yet another aspect of the invention is complex 6Eu. Another aspect of the invention is complex Tb(L20)₃(Lₙₒₙ₋ₑₘᵢₛₛᵢᵥₑ)ₓ. Another aspect of the invention is complex Eu(L20)₃(Lₙₒₙ₋ₑₘᵢₛₛᵢᵥₑ)ₓ. Another aspect of the invention is complex Tb(L30)₃(Lₙₒₙ₋ₑₘᵢₛₛᵢᵥₑ)ₓ. Another aspect of the invention is complex Eu(L30)₃(Lₙₒₙ₋ₑₘᵢₛₛᵢᵥₑ)ₓ. Another aspect of the invention is complex Eu-10 (i.e., Eu(L40)₃(Lₙₒₙ₋ₑₘᵢₛₛᵢᵥₑ)ₓ). Another aspect of the invention is complex Eu-20 (i.e., Eu(L50)₃(Lₙₒₙ₋ₑₘᵢₛₛᵢᵥₑ)ₓ). Another aspect of the invention is complex Tb(L60)₃(Lₙₒₙ₋ₑₘᵢₛₛᵢᵥₑ)ₓ. Another aspect of the invention is complex Eu(L60)₃(Lₙₒₙ₋ₑₘᵢₛₛᵢᵥₑ)ₓ. Another aspect of the invention is complex Tb(L70)₃(Lₙₒₙ₋ₑₘᵢₛₛᵢᵥₑ)ₓ. Another aspect of the invention is complex Eu(L70)₃. Yet another aspect of the invention is complex Tb(L80)₃(Lₙₒₙ₋ₑₘᵢₛₛᵢᵥₑ)ₓ. Another aspect of the invention is complex Eu(L80)₃(Lₙₒₙ₋ₑₘᵢₛₛᵢᵥₑ)ₓ.

A further aspect of the invention is use of the metal complexes of any of the above aspects as dye that is substantially non-visible under visible light and becomes visible when contacted with UV light. Another aspect of the invention is use of the complexes of any of the above aspects in paint that is substantially non-visible under visible light and becomes visible when contacted with UV light. Another aspect of the invention is use of the complexes of any of the above aspects in ink that is substantially non-visible under visible light and becomes visible when contacted with UV light. In an embodiment of this aspect, the ink is used as an anti-counterfeiting tool. In another embodiment of this aspect, the ink is used as an anti-theft marking tool. In yet another embodiment of this aspect, the ink is printing ink.

Another aspect of the invention is use of the complexes of any of the above aspects in an electroluminescent device, sensor, or for cellular imaging. In an embodiment of this aspect, the electroluminescent device is an organic light emitting diode (OLED) or a light emitting diode (LED).

Another aspect the invention provides use of a metal complex of any of the above aspects as a molecular switch, wherein presence of fluoride or cyanide acts as a trigger turning luminescence of a particular wavelength on, and absence of fluoride or cyanide acts as a trigger turning such luminescence off.

In another aspect the invention provides a method of making 1Tb (i.e., Tb(1)₃(CH₃OH)₂), comprising combining dissolved potassium 4-(dimesitylboryl)-2,3,5,6-tetramethylbenzoate and dissolved Tb(NO₃)₃.6H₂O to form a mixture, and isolating product 1Tb. A similar aspect provides a method of making 2Tb (e.g., Tb(2)₂(OCH₃)(CH₃OH)₂), comprising combining dissolved potassium 4′-(dimesitylboryl)biphenyl-4-carboxylate and dissolved Tb(NO₃)₃.6H₂O to form a mixture, and isolating product 2Tb. In another aspect a method of making 1Eu (i.e., Eu(1)₃(H₂O)₂(CH₃OH) is provided, comprising combining dissolved Eu(NO₃)₃.6H₂O and dissolved 4-(dimesitylboryl)-2,3,5,6-tetramethylbenzoate to form a mixture, and isolating product 1Eu. In another aspect a method of making 2Eu (i.e., Eu(2)₂(OCH₃)(CH₃OH)₂) is provided, comprising combining dissolved Eu(III) salt (e.g., Eu(NO₃)₃.6H₂O) and dissolved potassium 4′-(dimesitylboryl)biphenyl-4-carboxylate to form a mixture, and isolating product 2Eu. In another aspect a method of making 3Tb is provided, comprising combining dissolved Tb(NO₃)₃.6H₂O and dissolved tris(2′,3′,5′,6′-tetramethylbiphenyl-4-carboxylic acid)borane to form a mixture, and isolating product 3Tb. In another aspect is provided a method of making 4Tb, comprising combining dissolved Tb(NO₃)₃.6H₂O and dissolved tris(2,3,5,6-tetramethyl-4-benzoic acid)borane to form a mixture, and isolating product 4Tb. In another aspect a method of making 5Eu is provided, comprising forming a suspension of 5 and 1,10-phenanthroline, heating, increasing pH, mixing the suspension with dissolved Europium(III)-chloride.6H₂O, and isolating 5Eu (i.e., Eu(5)₃(phen)) In another aspect a method of making 6Eu (i.e., Eu(6)₃(phen)) is provided, comprising forming a suspension of 6 and 1,10-phenanthroline, heating, increasing pH, mixing the suspension with dissolved Eu(III) salt (e.g., Europium(III)-chloride.6H₂O), heating to about 60° C., cooling, and isolating 6Eu.

In yet another aspect, the invention provides a method of making Ln-10, Ln-20, Ln(L30)₃(Lₙₒₙ₋ₑₘᵢₛₛᵢᵥₑ)ₓ, Ln(L40)₃(Lₙₒₙ₋ₑₘᵢₛₛᵢᵥₑ)ₓ, Ln(L50)₃(Lₙₒₙ₋ₑₘᵢₛₛᵢᵥₑ)ₓ, Ln(L60)₃(Lₙₒₙ₋ₑₘᵢₛₛᵢᵥₑ)ₓ, Ln(L70)₃(Lₙₒₙ₋ₑₘᵢₛₛᵢᵥₑ)ₓ, or Ln(L80)₃(Lₙₒₙ₋ₑₘᵢₛₛᵢᵥₑ)ₓ comprising forming a suspension of Lₙₒₙ₋ₑₘᵢₛₛᵢᵥₑ and boryl ligand L-10, L-20, L30, L40, L50, L60, L70, or L80, optionally heating, increasing pH, mixing the suspension with dissolved Ln(III) salt, optionally heating, cooling, and isolating Ln(boryl ligand)₃(Lₙₒₙ₋ₑₘᵢₛₛᵢᵥₑ)ₓ, where x is a number between 1 and 6 and Lₙₒₙ₋ₑₘᵢₛₛᵢᵥₑ is independently water, alcohol, TOPO, a chelate ligand, or a combination thereof.

In another aspect, the invention provides a compound of general formula Ln(Bacac)₃(Lₙₒₙ₋ₑₘᵢₛₛᵢᵥₑ)ₓ, where Ln is a rare earth metal ion, Bacac can be the same or different and is a boryl functionalized diketone ligand, Lₙₒₙ₋ₑₘᵢₛₛᵢᵥₑ is the same or different and is a non-emissive ligand, and x is a number from 1 to 6. In some embodiments of this aspect, Lₙₒₙ₋ₑₘᵢₛₛᵢᵥₑ is a chelate ligand, H₂O, alcohol, TOPO, or a combination thereof. In certain embodiments of this aspect, Ln(Bacac)₃(Lₙₒₙ₋ₑₘᵢₛₛᵢᵥₑ)ₓ is Ln(L30)₃(Lₙₒₙ₋ₑₘᵢₛₛᵢᵥₑ)ₓ, or Ln(L60)₃(Lₙₒₙ₋ₑₘᵢₛₛᵢᵥₑ)ₓ. In some embodiments of this aspect, Ln is Tb or Eu.

### BRIEF DESCRIPTION OF THE DRAWINGS

For a better understanding of the invention and to show more clearly how it may be carried into effect, reference will now be made by way of example to the accompanying drawings, which illustrate aspects and features according to embodiments of the present invention, and in which:

FIG. 1 shows structural formulae for ligands 1, 2, 3, 4, 5 and 6.

FIGS. 2A-C show structural formulae for complexes 1Tb, 1Eu, 2Tb, 2Eu, 3Tb, 4Tb, 5Eu, 6Eu, Tb(L70)₃(Lₙₒₙ₋ₑₘᵢₛₛᵢᵥₑ)ₓ and Tb(L30)₃(Lₙₒₙ₋ₑₘᵢₛₛᵢᵥₑ)ₓ.

FIG. 3A shows X-ray crystallography results for ligand 1.

FIG. 3B shows X-ray crystallography results for ligand 3.

FIG. 3C shows X-ray crystallography results for ligand 4.

FIG. 4 shows a schematic depicting the synthetic pathway for preparation of 1Tb, 1Eu, 2Tb and 2Eu.

FIG. 5A shows UV-Vis absorption spectra of ligands 1 and 2 in THF at room temperature (RT).

FIG. 5B shows normalized emission spectra of ligands 1 and 2 in THF at RT.

FIG. 5C shows UV-Vis absorption spectra of complexes 1Tb, 1Eu, 2Tb, and 2Eu in THF at RT.

FIG. 5D shows normalized emission spectra of complexes 1Tb, 1Eu, 2Tb, and 2Eu in THF at RT.

FIG. 6A shows luminescence titration spectra of Tb(Bz)₃ (λₑₓ=300 nm) with 1 in THF (1.0×10⁻⁵ M) at 298 K, initially there are no luminescence peaks but as the concentration of 1 increases and 1Tb forms, luminescence peaks form.

FIG. 6B shows luminescence titration spectra of Eu(Bz)₃ (λₑₓ=330 nm) with 1 in THF (1.0×10⁻⁵ M) at 298 K, initially there are no luminescence peaks but as the concentration of 1 increases and 1Eu forms, luminescence peaks form.

FIG. 7 shows normalized intensity phosphorescence spectra of ligands 1 and 2 at 77K in THF.

FIG. 8A shows detection of DPA and presents luminescence titration spectra of 1Tb (1.0×10⁻⁵ M in THF) by DPA at 298 K, starting at 0 eq. DPA and ending at 1 eq. DPA.

FIG. 8B shows detection of DPA and presents luminescence titration spectra of 1Eu (1.0×10⁻⁵ M in THF) by DPA at 298 K, starting at 0 eq. DPA and ending at 3 eq. DPA.

FIG. 8C shows detection of DPA and presents luminescence titration spectra of 2Eu (1.0×10⁻⁵ M in THF) by DPA at 298 K starting at 0 eq. DPA and ending at 1.5 eq. DPA.

FIG. 9A shows detection of fluoride and presents luminescence titration spectra of 1Tb (1.0×10⁻⁵ M in THF) by TBAF at 298 K (λₑₓ=300 nm), as the concentration of F⁻ increases, fluoride affects the complex's emission pattern.

FIG. 9B shows detection of fluoride and presents UV-vis absorption titration spectra of 1Tb (1.0×10⁻⁵ M in THF) by TBAF at 298 K (λₑₓ=300 nm), as the concentration of F⁻ increases, fluoride affects the complex's absorption bands.

FIG. 9C shows detection of fluoride and presents luminescence titration spectra of 1Eu (1.0×10⁻⁵ M in THF) by TBAF at 298 K, as the concentration of F⁻ increases, fluoride quenches the enhanced Eu ion's emission bands and red-shifts the ligand's emission bands.

FIG. 9D shows detection of fluoride and presents UV-Vis absorption titration spectra of 1Eu (1×10⁻⁵ M) by TBAF in THF at 298 K, as the concentration of F⁻ increases, fluoride affects the complex's absorption bands.

FIG. 9E shows detection of fluoride and presents emission titration spectra of 2Eu (1×10⁻⁵ M) by TBAF in THF at 298 K, as the concentration of F⁻ increases, fluoride quenches both the ligand's and the enhanced Eu ion's emission bands.

FIG. 9F shows detection of fluoride and presents UV-Vis absorption titration spectra of 2Eu (1×10⁻⁵ M) by TBAF in THF at 298 K, as the concentration of F⁻ increases, fluoride affects the complex's absorption bands.

FIG. 9G shows detection of fluoride and presents luminescence titration spectra of Tb(L30)₃(H₂O)ₓ (1.0×10⁻⁵ M in THF) by NBu₄F at 298 K (λₑₓ=335 nm), as the concentration of F increases the complex's emission pattern changes (e.g., peak around 380 nm increases in intensity and peak around 540 nm decreases in intensity as indicated by the arrows).

FIG. 9H shows detection of fluoride by presenting a luminescence titration spectra of Tb(L70)₃(H₂O)ₓ at 1.0×10⁻⁵ M in THF by NBu₄F at 298 K (λₑₓ=330 nm). As shown, as concentration of F⁻ increased, the complex's emission pattern changed. For example, a peak due to ligand emission, at around 395 nm, initially increased in intensity due to F⁻ adding to B as concentration of F⁻ increased. Eventually, the concentration of F⁻ was sufficient to have F⁻ adding directly to Tb. Such metal addition leads to a decrease in the intensity of the boryl ligand emission peak this peak is now emission of the unbound fluoro-substituted boryl ligand. Other examples of the changes include metal emission peaks around 490 and 545 nm, wherein the intensity initially increased with increasing [F⁻], but eventually decreased as the enhancement terminated with replacement of the boryl ligand on the metal with F⁻.

FIG. 10A shows detection of cyanide and presents luminescence titration spectra of 1Tb (1.0×10⁻⁵ M in THF) by TEACN at 298 K (λₑₓ=300 nm), as the concentration of CN⁻ increases, cyanide quenches the enhanced Tb ion's emission bands and red-shifts the ligand's emission bands.

FIG. 10B shows detection of cyanide and presents UV-Vis absorption titration spectra of 1Tb (1×10⁻⁵ M) by TEACN in THF at 298 K, as the concentration of CN increases, cyanide affects the complex absorption pattern.

FIG. 10C shows detection of cyanide and presents emission titration spectra of 1Eu (1×10⁻⁵ M) by TEACN in THF at 298 K, as the concentration of CN⁻ increases, cyanide quenches the enhanced Eu ion's emission bands and red-shifts the ligand's emission bands.

FIG. 10D shows detection of cyanide and presents UV-Vis absorption titration spectra of 1Eu (1×10⁻⁵ M) by TEACN in THF at 298 K, as the concentration of CN⁻ increases, cyanide affects the complex's absorption pattern.

FIG. 10E shows detection of cyanide and presents emission titration spectra of 2Eu (1×10⁻⁵ M) by TEACN in THF at 298 K, as the concentration of CN⁻ increases, cyanide quenches both the ligand's emission bands and the enhanced Eu ion's emission bands.

FIG. 10F shows detection of cyanide and presents UV-Vis absorption titration spectra of 2Eu (1×10⁻⁵ M) by TEACN in THF at 298 K, as the concentration of CN⁻ increases, cyanide affects the complex absorption pattern.

FIG. 11A shows UV-Vis absorption spectra at 298K in dashed line (λₘₐₓ=345 nm) and normalized phosphorescent spectra at 298 K in solid line (λₑₓ=345 nm, λₑₘ=613 nm) of complex 5Eu in THF.

FIG. 11B shows UV-Vis absorption spectra at 298K in dashed line (λₘₐₓ=345 nm) and normalized phosphorescent spectra at 298 K in solid line (λₑₓ=345 nm, λₑₘ=613 nm) of complex 6Eu in THF.

FIG. 11C shows phosphorescent spectra wherein complex 5Eu (1×10⁻⁵ M) is titrated with aliquots of TBAF (3×10⁻³M) in THF at 298K (λₑₓ=370 nm).

FIG. 11D shows phosphorescent spectra wherein complex 6Eu (1×10⁻⁵ M) is titrated with aliquots of TBAF (3×10⁻³M) in THF at 298K (λₑₓ=370 nm).

FIG. 12 shows a schematic representation of energy levels in organoboron ligands and in rare earth metal ions and the emission pathways from such complexes.

FIG. 13A shows UV-Vis absorption spectra at 298K and 1×10⁻⁵ M of complexes Eu-10 (solid line) and Eu-20 (in dashed line) in THF.

FIG. 13B shows emission spectra (following excitation at 340 nm) at 298K and 1×10⁻⁵ M of complexes Eu-10 (solid line) and Eu-20 (dashed line).

FIG. 13C shows excitation and emission (excitation at 350 nm) spectra of Tb(L30)₃(H₂O)ₓ in THF (1.7×10-5 M).

FIG. 13D shows an emission (after excitation at 350 nm) spectrum of Tb(L30)₃(H₂O)ₓ as a neat film.

### DETAILED DESCRIPTION OF PREFERRED EMBODIMENTS

### Definitions

As used herein the term “luminescence” means emission of light by a substance as a result of exciting the substance by means other than heat. Types of luminescence include: electroluminescence (light emission as a result of an electric current passed through a substance), photoluminescence (light emission as a result of absorption of photons), fluorescence (light emission in which emitted photons are of lower energy than those absorbed, usually referring to a spin-allowed transition), and phosphorescence (light emission slightly delayed after initial absorption of radiation, usually referring to a spin-forbidden transition).

As used herein, the term “DPA” means pyridine-2,6-dicarboxylic acid or dipicolinic acid.

As defined by IUPAC (International Union of Pure and Applied Chemistry), the term “lanthanide series” includes the fifteen metallic chemical elements with atomic numbers 57 through 71, from lanthanum through lutetium. These fifteen lanthanide elements, along with the chemically similar elements scandium and yttrium, are collectively known as the “rare earth” elements. “Ln” is used herein to represent any rare earth metal.

As used herein, the term “PMMA” means poly(methyl methacrylate).

As used herein, the term “nBuLi” means n-butyl lithium.

As used herein, the term “THF” means tetrahydrofuran.

As used herein, the term “aliphatic” includes alkyl, alkenyl and alkynyl. An aliphatic group may be substituted or unsubstituted. It may be straight chain, branched chain or cyclic.

As used herein, the term “aryl” includes heteroaryl and may be substituted or unsubstituted.

As used herein, the terms “ortho”, “meta” and “para” refer to an arene substitution pattern and are part of IUPAC nomenclature that pinpoints the position of substituents in relation to each other on an aromatic ring. Specifically, “ortho” refers to two substituents on an aromatic ring occupying adjacent positions. “Para” refers two substituents occupying positions on an aromatic ring separated by two ring atoms. “Meta” refers to an arene substitution pattern in which two substituents occupy positions on an aromatic ring separated by one ring atom.

As used herein, the term “unsubstituted” refers to any open valence of an atom being occupied by hydrogen. Also, if an occupant of an open valence position on an atom is not specified, then it is hydrogen.

As used herein, the term “substituted” refers to a structure having one or more substituents.

As used herein, the term “ligand” means a moiety that is capable of binding to a metal ion (e.g., an organic molecule that donates any necessary electrons to form one or more coordinate covalent bonds with a metal ion).

As used herein, the term “Lₙₒₙ₋ₑₘᵢₛₛᵢᵥₑ” means a ligand that when bound to a rare earth metal ion, it does not enhance the luminescence of that rare earth metal ion. Examples of such non-participating spectator ligands include H₂O, alcohol, trioctylphosphine oxide (“TOPO”), or chelate ligands, such as for example, phenanthroline.

As used herein, the term “chelate ligand” is a type of ligand having more than one site that binds to a metal ion (bi- or multi-dentate).

As used herein, the term “organic” refers to hydrocarbon-based compounds although such compounds may contain any number of other elements (e.g., nitrogen, oxygen, halogens, phosphorus, silicon, and sulfur).

As used herein, the term “sterically encumbered” or “sterically hindered” refers to space around an atom or moiety being substantially blocked by large atomic neighbours. In some cases, steric hindrance can limit rotation around certain bonds. Steric hindrance or steric encumberance can be a useful tool to change reactivity of a molecule by stopping unwanted side-reactions (steric protection).

As used herein, the term “heteroatom” means a non-hydrogen, non-carbon atom and includes, for example, N, S, O, and P.

As used herein, the term “Bz” means benzoate.

As used herein, the term “mesityl” or “Mes” means 2,4,6-trimethylphenyl.

As used herein, the term “TBAF” means tetrabutylammonium fluoride.

As used herein, the term “TEACN” means tetraethylammonium cyanide.

As used herein and in the field of the invention, the symbol “ε” represents molar absorption coefficient (also known as molar extinction coefficient and molar absorptivity), which is a measurement of how strongly a chemical species absorbs light at a given wavelength.

As used herein and in the field of the invention, the symbol “λ” represents wavelength, which is spatial period of a wave or the distance over which a wave's shape repeats.

As used herein and in the field of the invention, the symbol “τ” represents emission lifetime, which refers to average time a molecule stays in its excited state before emitting a photon.

As used herein and in the field of the invention, the symbol “Φ” represents quantum yield, which is a characteristic of an emissive species and indicates efficiency with which a subject converts absorbed excitation energy into radiative relaxation back to ground state.

As used herein, the term “enhancement” means augmentation or increase of a signal.

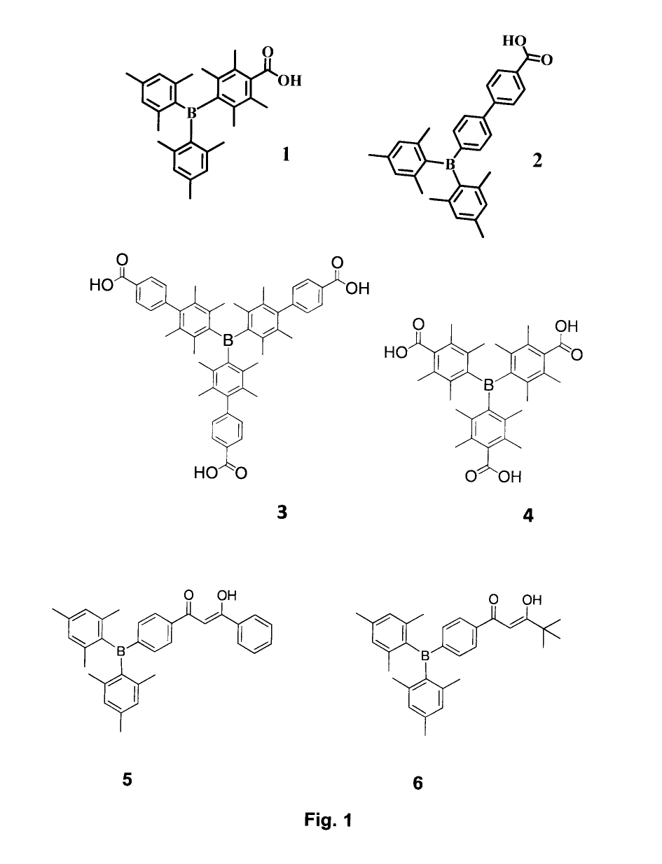

As used herein, the terms 1, 2, 3, 4, 5 and 6 refer to organoboron ligands whose structural formulae are shown in FIG. 1 and whose syntheses are described in the Working Examples.

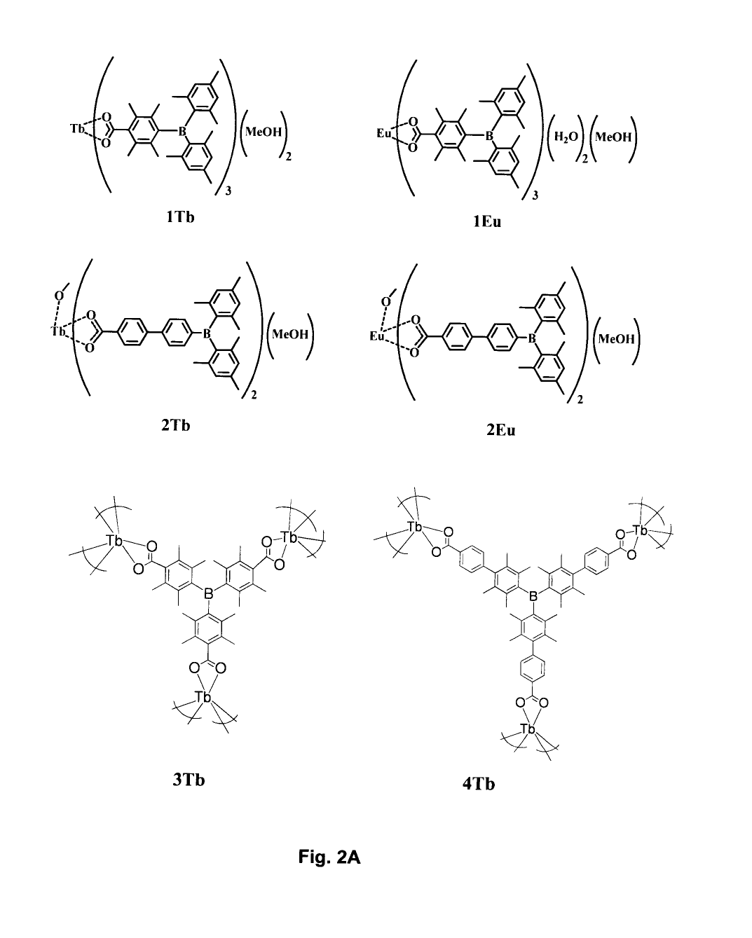

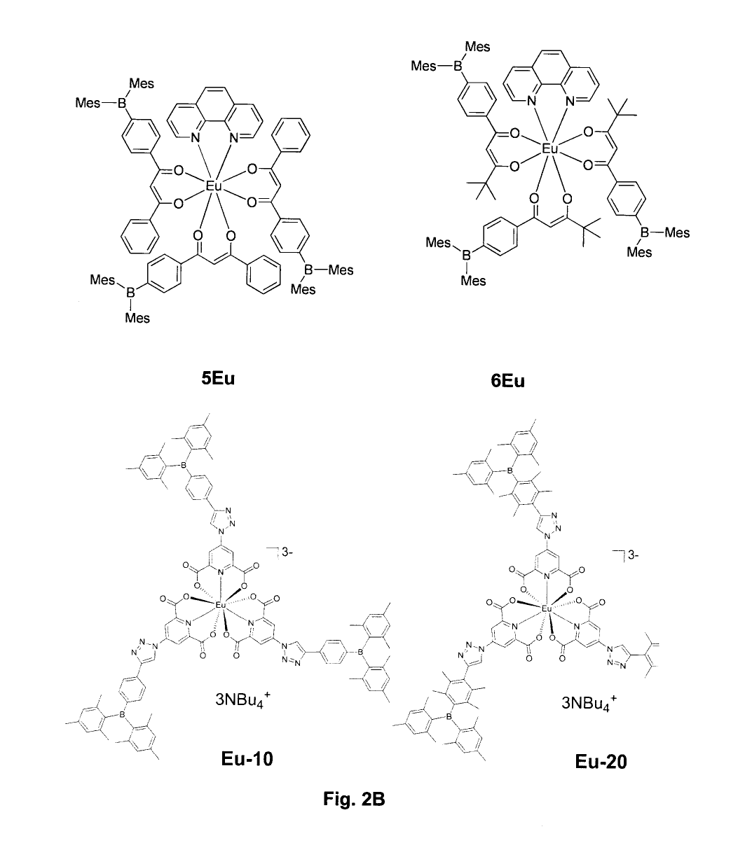

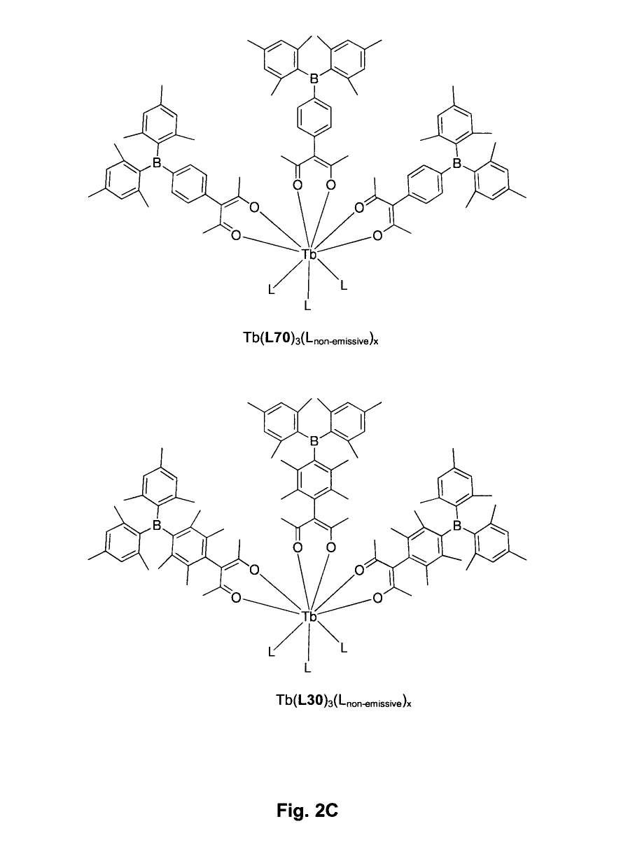

As used herein, the terms 1Tb, 2Tb, 3Tb, 4Tb, 1Eu, 2Eu, 5Eu, and 6Eu refer to rare earth metal ion complexes wherein the ligands are the moieties 1, 2, 3, 4, 5, or 6 as indicated, and the metal species are Tb(III) or Eu(III), also as indicated. Structural formulae for particular embodiments of such complexes are shown in FIG. 2 and synthetic schemes are described in the Working Examples.

### DESCRIPTION

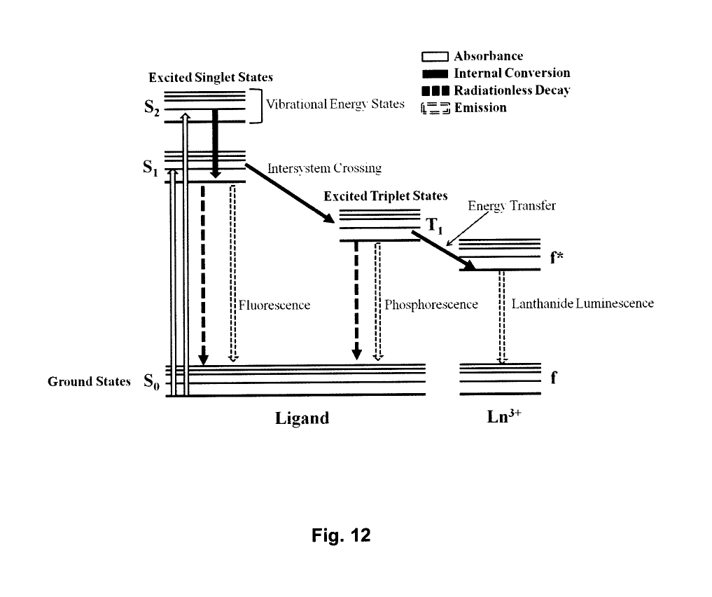

As described in Chem. Rev. 2009, 109(9) 4283-4374, light emission by rare earth metal ions is generally described as “luminescence” rather than the terms “fluorescence” or “phosphorescence”. This terminology is used because the terms fluorescence and phosphorescence were coined to describe light emission by organic molecules. Accordingly, those terms can incorporate information about emission mechanism, namely, fluorescence being singlet to singlet emission (i.e., a spin-allowed transition) and phosphorescence being triplet to singlet emission (i.e., a spin-forbidden transition). Such incorporation, strictly taken, would make these terms not suit the rare earth ion situation, since in the case of lanthanide series metal ions, emission is due to transitions inside the 4f shell. FIG. 12 depicts energy levels in organoboron ligands and in rare earth metal ions and shows the emission pathways from such complexes.

Rare earth metal ion light emission (i.e., luminescence) can be enhanced by bonding to a ligand that has triplet energy states that are close to and above the level of the metal ion's first excited state. Enhancement of emission of rare earth ions can be achieved through an absorption-energy transfer-emission mechanism where a ligand or a chelating ligand acts like an antenna to harvest light and subsequently transfer its energy to a rare earth ion, thus enhancing emission (see schematic below depicting how boron activates rare earth metal ion (represented by Ln) luminescence) (see Adv. Inorg. Chem.; Elsevier: San Diego, 2011; Collect. Vol. No. 63, 10).

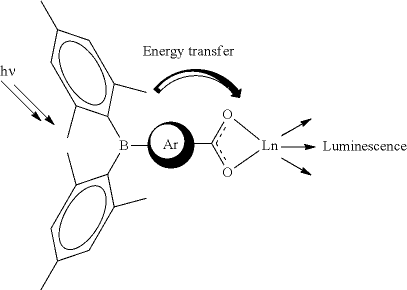

Advantageously, rare earth metal ion emission is much less prone to oxygen quenching than is, for example, phosphorescence of transition metal compounds. This property makes enhancement of rare earth emission viable for use as sensors under ambient conditions. Consequently, luminescent rare earth compounds have found use in fields such as electroluminescent devices (e.g. OLED devices (organic light emitting diode), sensors, and cellular imaging.

Triarylboron moieties such as BMes₂Ar (Mes=mesityl, Ar=aryl) enhance fluorescence and phosphorescence of organic molecules and certain transition metal complexes (Chem. Commun., 2011, 47, 3837). As described herein, organoboron ligands have been reacted to form rare earth metal complexes. Surprisingly, these ligands enhance the metal ion's luminescence. Importantly, this luminescence enhancement, obtained from the rare earth metal ion's emission, can be turned off selectively by the presence of fluoride, cyanide or a biological marker. Boron's low-lying p_{π} orbital enables use of triarylboron compounds as highly selective sensors for CN⁻ and F⁻ (Chem. Rev., 2010, 110, 3958) since these anions attack the boron. Sensors of CN—, F— or biological markers work by determining, upon exposing the complex to UV light, whether luminescence is produced at the ligand's or the metal's emission wavelength. If it is produced at the wavelength of the ligand's fluorescence, that indicates the presence of fluoride, cyanide or a biological marker since these anions are bonding to boron and interfering with energy transfer to the metal ion from the boron. If it is produced at the wavelength of the metal ion's emission, that indicates that enhancement of the metal ion's emission by the organoboron ligand is occurring so there is an absence of fluoride, cyanide or a biological marker. In the presence of such anions (i.e., fluoride and cyanide) the boron undergoes attack and when bonded to such an anion and the boron is unable to transfer energy to the metal ion. In the case of biological markers, the biological markers do not attack the boron but rather attack the metal ion and replace the triarylboron ligand in the coordination sphere of the metal ion thereby turning off the enhanced emission. Therefore in the presence of fluoride, cyanide or biological marker, the enhancement of the metal ion's emission stops. If luminescence is detected in the presence of these anions, it is at a different wavelength since its source is merely the ligand's fluorescence and not the metal ion's emission (or only very weakly as it is no longer enhanced). See the schematic below which represents how rare earth metal ion luminescence can be changed to fluorescence from the boron chromophore by presence of fluoride (or cyanide) (see Chem. Rev., 2010, 110, 3958).

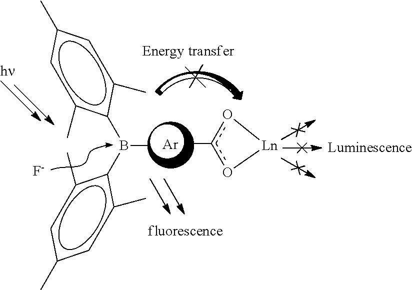

Triarylboron complexes of rare earth metal ions are capable of acting as a molecular switch, wherein in the absence of fluoride or cyanide, shining UV light on the complex produces enhanced luminescence of the colour of the rare earth metal ion's emission (e.g., red), and in the presence of fluoride or cyanide shining UV light on the complex produces luminescence in the colour of the ligand's fluorescence (e.g., blue). By following the red colour wavelength, it is possible to see light emission diminish such that the light emission is turned off. By following the blue wavelength, it is possible to see the light emission turn on.

During investigations described herein, new rare earth metal-based materials have been synthesized and their properties have been investigated and are reported herein. Representative examples of triarylboron bound Tb(III) and Eu(III) compounds indicate that enhancement of luminescence was achieved. The triarylboron group has been found to be highly effective in activating rare earth metal ion emissions. Studies reported herein show that such triarylboron bound-rare earth complexes are promising as luminescent sensors/probes for CN⁻, F⁻ as well as for biological markers.

Organoboron compounds have been of interest to the inventors for some time (see Wang et al. U.S. Patent Application Publication No. US2006-0036114A1). Surprisingly, organoboron ligands have been found to be a particularly good choice for binding to rare earth metal ions and forming complexes since these ligands enhance the metal ions' luminescence. In such a complex, the role of boron is to provide triplet energy levels close to and above the level of the first excited state of the rare earth metal. The role of the organic part of the organoboron ligand is two-fold.

First, it includes a ligand-portion that has sufficient electrons to donate to form one or more covalent bonds with a rare earth metal ion. In some embodiments, the ligand is a chelate and so it has two or more binding sites available to bond to a metal ion. Although chelation is desirable for stability, it is not necessary to form a complex that enhances luminescence.

Second, it includes substituents near the boron to provide steric crowding of the boron atom. Thus the organic portion of the organoboron ligand provides stability by protecting the boron atom from attack by water, hydroxide or the like, by sterically encumbering the boron atom. A general structure of ligand that is suitable for binding to rare earth metals and enhancing luminescence is provided below.

In an embodiment, the ligand is represented by a compound of formula (I)

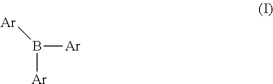

where B is boron; and

Ar is an aryl moiety that is aromatic or heteroaromatic, substituted or unsubstituted and is a 5 or 6-membered aromatic ring, and Ar is optionally two aromatic rings or a fused ring system;

wherein the B is sterically encumbered by the presence of same or different non-hydrogen substituents located ortho to the boron, wherein if the substituents are only C₁, then at least four of the ortho positions are C₁, and if the substituents are C_{2-or-higher}, then at least two of the ortho positions are C_{2-or-higher}, and wherein at least one Ar comprises a moiety that can bind to a metal ion.

In an embodiment, the ligand is represented by a compound of formula (II)

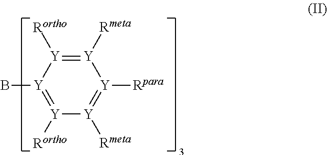

where B is boron, Y is C or a heteroatom, R^{meta} and R^{para} are H or C₁-C₆ aliphatic and may be further substituted by carbon, oxygen, nitrogen, sulfur, aryl, or combinations thereof, at least one R^{ortho}, R^{meta} and R^{para} comprise a moiety capable of bonding to a rare earth metal ion, R^{ortho} is H or C₁-C₄ aliphatic, wherein B is sterically encumbered such that at least four of the six R^{ortho}'s are non-hydrogen when R^{ortho} is H or C₁, and at least two of the six R^{ortho}'s are non-hydrogen when R^{ortho} is H or C₂₋₄, wherein the ligand comprises a moiety that has electrons to form a bond with a metal ion.

In regard to moieties that can bind to a metal ion, such moieties typically have lone pairs of electrons to donate to form metal-ligand bonds, so such moieties often include oxygen and nitrogen. Examples of ligand moieties that bind to metals include, for example, arylcarboxy, pyridine, acetylacetonato, and amide. In certain embodiments, the moiety that has electrons to form a bond with a metal ion is carboxy.

Aryl moieties of structures (I) and (II) are aromatic but can be heteroaryl or hydrocarbons. Heteroaryls include, for example, thiophene, furan, pyridine. In addition to the above general structures (I) and (II), examples of specific triarylboron ligands that are suitable for enhancing rare earth metal ions' luminescence are shown in Table 3.

Sterically encumbered boron's include those that have non-hydrogen substituents located ortho to the boron. Since methyl is relatively small and provides less steric bulk, when methyl (C₁) is present in an ortho position, four of the six ortho substituents shall be methyl, while the other two substituents may be hydrogen. If the protecting substituents are ethyl (C₂) or higher, then only two of the six ortho substituents shall be non-hydrogen, while the other four may be hydrogen. The two ortho positions may be on the same aryl ring, or different aryl rings. In short, the boron which is bound to three aryl moieties has six substituent positions on the aryl moieties that are ortho to the boron, and the boron is protected when it is sterically encumbered by substituents at two or more of the six ortho positions, wherein (i) at least two of the six ortho positions are C₂ or higher, or (ii) at least four of the six ortho positions are C₁, and optionally all six of the ortho positions are non-hydrogen.

A portion of the ligand is able to bind to a rare earth metal ion. Example of moieties that are capable of binding to metal ions include pyridyl, bipyridyl, indolyl, imidazolyl, naphthyl, amine, amide, carboxy, acetylacetonato, and their derivatives (e.g., di-2-pyridylamine, 7-azaindole). An advantage of the carboxy binding moiety is that it has two binding sites which offer a chelation effect. The chelation effect assists with stabilizing the complex.

Examples of ligands suitable for binding rare earth metal ions and for enhancing luminescence thereof are shown in Table 3. Several BMes₂-arylcarboxyl ligands have been prepared and tested as representative examples of effective ligands to enhance rare earth metal ions' luminescence. Structural formulae for representative ligands 1, 2, 3, 4, 5 and 6 appear in FIG. 1. Structural formula for representative ligands L10, L20, L30, L40, L50, L60, L70, and L80 appear in the Working Examples. Synthetic details for appear in the Working Examples. As shown in FIG. 1, these ligands have a boron center with three aryl moieties connected to the boron, two of the moieties bound to the boron are mesityl moieties. That is, phenyl rings with three methyl groups in the ortho and para positions. These methyls are representative examples of small aliphatic groups that protect the boron from attack by water, hydroxide, etc. through steric hindrance (i.e. crowding) of the boron atom. Mesityl is a convenient choice, although 1,6-dimethylphenyl would also be appropriate since it would also have two methyl groups in the ortho positions to the boron to sterically encumber and therefore protect the boron. The third aryl moiety bound to the boron is an aryl moiety substituted with a chelating moiety. In the case of ligands 1, 2, 3 and 4, a representative chelating moiety of carboxylate was used.

In the case of ligands 5, 6, L30, L60, and L70, derivatized acetylacetonato ligands were used as chelating moieties. A general formula for such ligands is Ln(Bacac)₃(Lₙₒₙ₋ₑₘᵢₛₛᵢᵥₑ)ₓ, where Bacac is a boryl functionalized diketone ligand, Lₙₒₙ₋ₑₘᵢₛₛᵢᵥₑ is the same or different and is may be a chelate ligand, such as for example, phenanthroline, or H₂O, alcohol, or TOPO, and x is a number between 1 and 6. Ligands 5, 6, L30, L60, and L70 were prepared and characterized as representative examples of Ln(Bacac)₃(L)ₓ complexes.

Ligands 1, 2, 3, 4, 5, 6, L10, L20, L30, L40, L50, L60, L70, and L80 were reacted with rare earth metal ions to form complexes. Efforts to grow crystals of the resultant complexes were unsuccessful in part due to the limited solubility of the complexes. As a result, the structural formulae of the metal complexes as presented herein are based on mass spectrometry (MS), nuclear magnetic resonance (NMR) and other characterization data. Accordingly, it is possible that other structures may form such as oligomers, or structures where two metal ions are bridged by a ligand. Ligands may be bound as a chelate, or may be bound at a single attachment point.

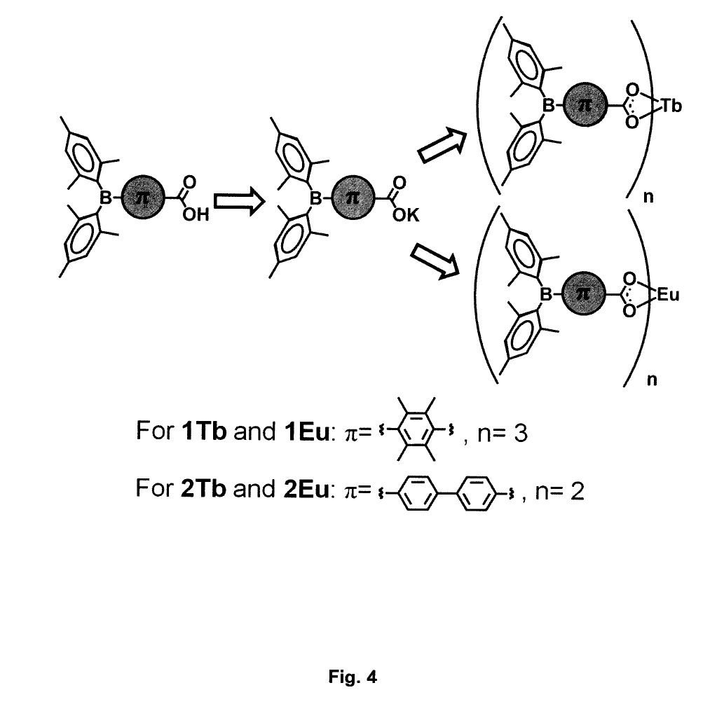

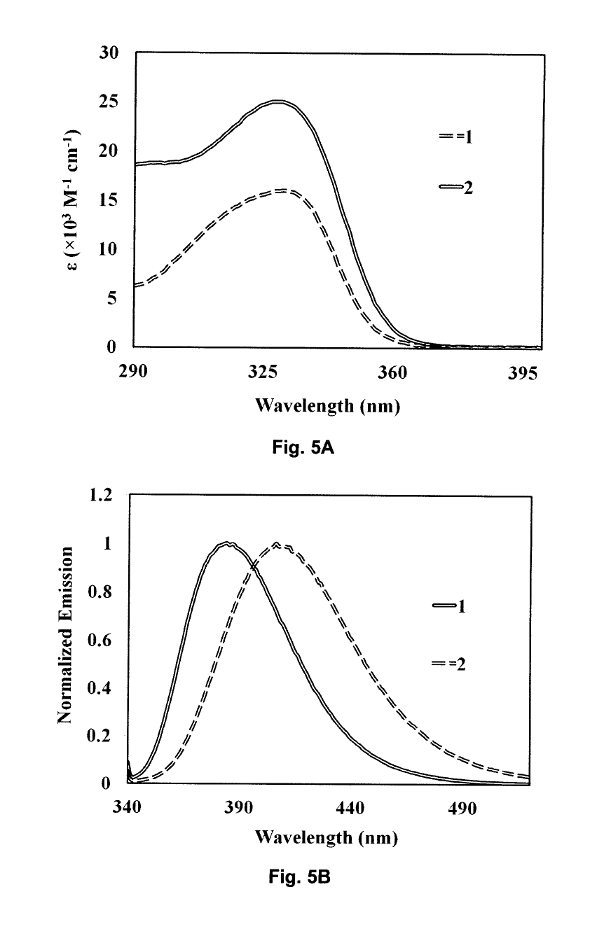

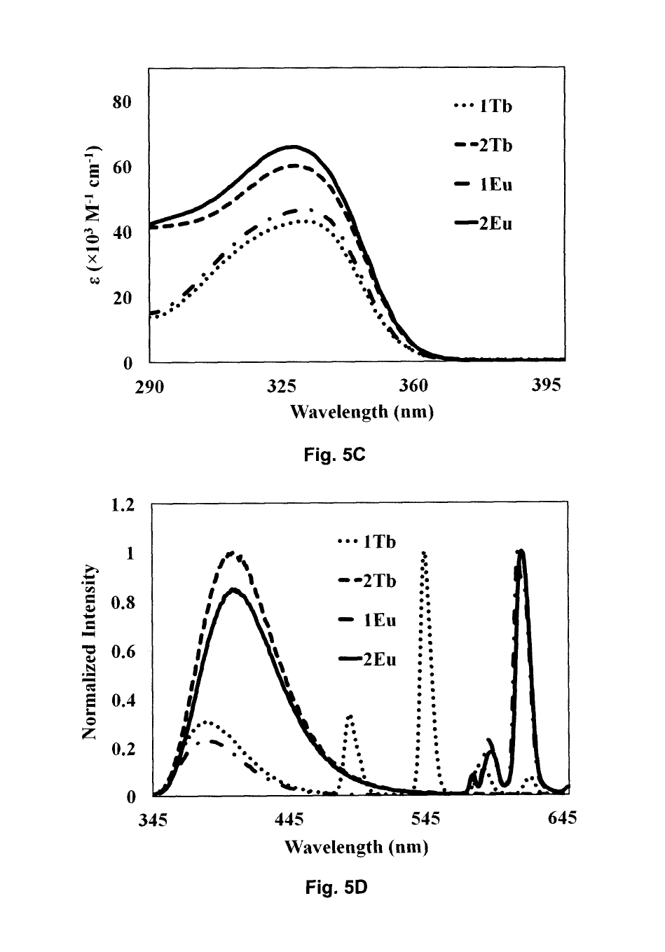

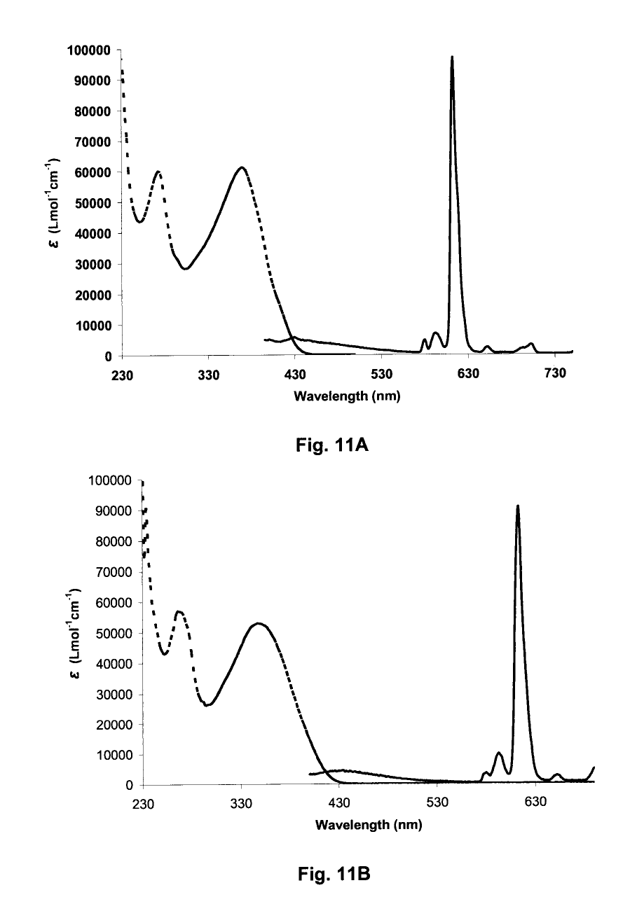

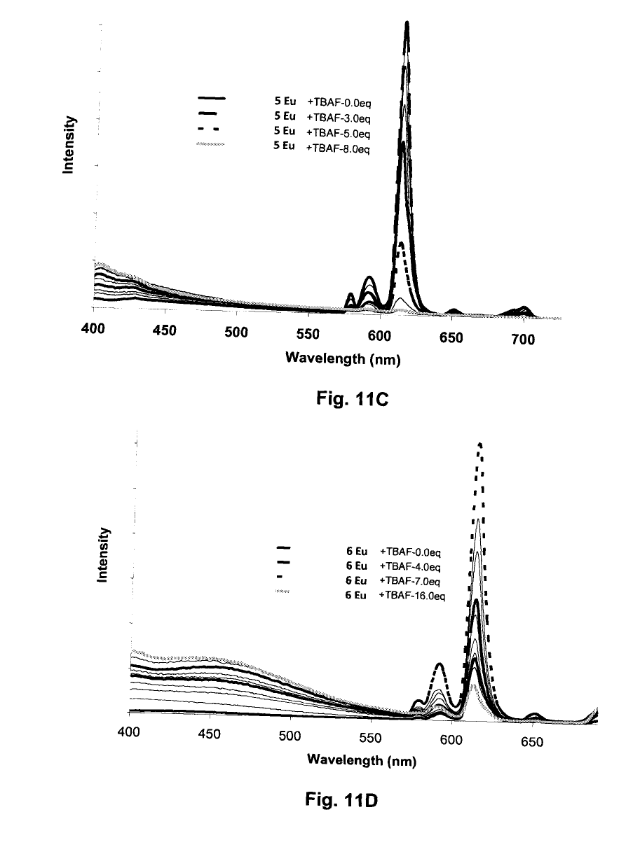

These organoboron rare earth metal complexes exhibited enhanced luminescence when exposed to UV light. Under visible light, no luminescence was observed. These types of complexes are excellent candidates for invisible dyes and/or invisible inks that could not be seen under visible-light conditions, but would luminese in bright attractive colours when exposed to UV light. Thus, such ink would be invisible to the eye under (visible) lighted conditions, and readily apparent under UV light. Hence documents printed with such invisible inks would appear as blank pages until exposed to UV light, when coloured images would appear. Such inks or dyes are suitable for anti-theft markings, anti-counterfeit marking, or even art and advertising for a special effect under UV light conditions. Such invisible inks may be incorporated into a resin or polymer matrix. Tests have been conducted to characterize this luminescence using two rare earth metal ions, Tb(III) and Eu(III), as representative examples of rare earth metal ions and results are presented in the FIGS. 1-11 and Tables 1 and 2 found herein. These ligands were chosen because of their distinct triplet energy for selective activation of rare earth metal ion emission. Tb(III) and Eu(III) compounds of 1, 2, 3, 4, 5, and 6 were obtained as colorless solids by the reaction of the potassium salts of 1 and 2 with Tb(NO₃)₃.5H₂O and Eu(NO₃)₃.6H₂O, respectively (see Working Examples for details). Accordingly, four complexes have been made and tested: ligand 1 with Tb(III), known herein as “1Tb”; ligand 1 with Eu(III), known herein as “1Eu”; ligand 2 with Tb(III), known herein as “2Tb”; and ligand 2 with Eu(III), known herein as “2Eu”. Structural formulae for complexes 1Tb, 1Eu, 2Tb and 2Eu, 3Tb, 4Tb, 5Eu, 6Eu are shown in FIG. 2. The appearance of these four complexes when doped in PMMA (10 wt %) at room temperature under ambient light, was four apparently identical colourless and quite unremarkable translucence gels. However, under 365 nm irradiation they were vibrant with colour and were each a different brilliantly coloured translucent gels. 1Tb appeared bright new-spring-plant green, 2Tb was a vivid medium-hue blue, 1Eu appeared as a rosy pink, and 2Eu was red. Complexes 3Tb and 4Tb emitted a bright green color while complexes 5Eu and 6Eu emitted a red color. These complexes showed the same bright colours when in THF solutions under irradiation at 365 nm and their UV-vis and emission spectra are shown in FIG. 5.

Elemental and mass spectrometry (MS) analyses established that for ligand 1, the complex has the general formula of Ln(1)₃(H₂O)ₓ(MeOH)_{y}, where x=0 and y=2 for 1Tb and x=2 and y=1 for 1Eu. Similar analyses for ligand 2 established that the complex has the general formula of Ln(2)₂(OMe)(MeOH) for 2Tb and 2Eu. Efforts to obtain single crystals for the complexes were unsuccessful. Based on MS data, the rare earth complexes are most likely oligomeric in solution and solid state via bridging carboxyllate or methoxy ligands, which are commonly observed for rare earth metal compounds. Ligands 1 and 2 had a large effect on luminescence of Tb(III) and Eu(III), as shown by the spectra in FIG. 5.

Both free ligands display weak blue luminescence in the solid state and in solution (λₘₐₓ=384 nm for 1 and 406 nm for 2) with quantum yields of 0.05 and 0.14 respectively in CH₂Cl₂. Complexes 1Tb, 2Tb, 1Eu and 2Eu display green, blue, red and pink luminescence, respectively, both in solution and in solid state. Complex 1Tb exhibited exceptionally bright luminescence with characteristic Tb(III) emission at λₑₘ₌489 nm, 545 nm, 585 nm and 615 nm. The ligands' luminescence bands are also evident in all compounds. In the solid state, ligand 1's contribution to the total emission of 1Tb becomes very small, indicating very effective energy transfer from the ligand to the Tb(III) metal center. Quantum efficiency for 1Tb in the solid state was found to be a very impressive 0.70 for total emission and 0.56 for Tb(III) emission bands (80% of the total emission). In contrast, complex 2Tb did not display any Tb(III) emission bands in solution and very weak Tb(III) bands in the solid state (<10% of the total emission). These observations support that ligand 1 is highly effective in activating Tb(III) emission while ligand 2 is less effective.

For the 1Eu and 2Eu complexes, characteristic Eu(III) emission bands were observed. These emission bands have moderate quantum efficiencies (0.04 for 1Eu, 29% of the total emission; and 0.10 for 2Eu, 21% of the total emission), indicating that ligands 1 and 2 are capable of activating Eu(III) emission, although less efficiently, compared to 1Tb. The ligand's emission band contributes significantly in both Eu(III) compounds. Because of the large contribution of ligand 2's luminescence, compound 2Eu has pink luminescence while 1Eu, with much less ligand's emission contribution, has the characteristic red emission color of Eu(III).

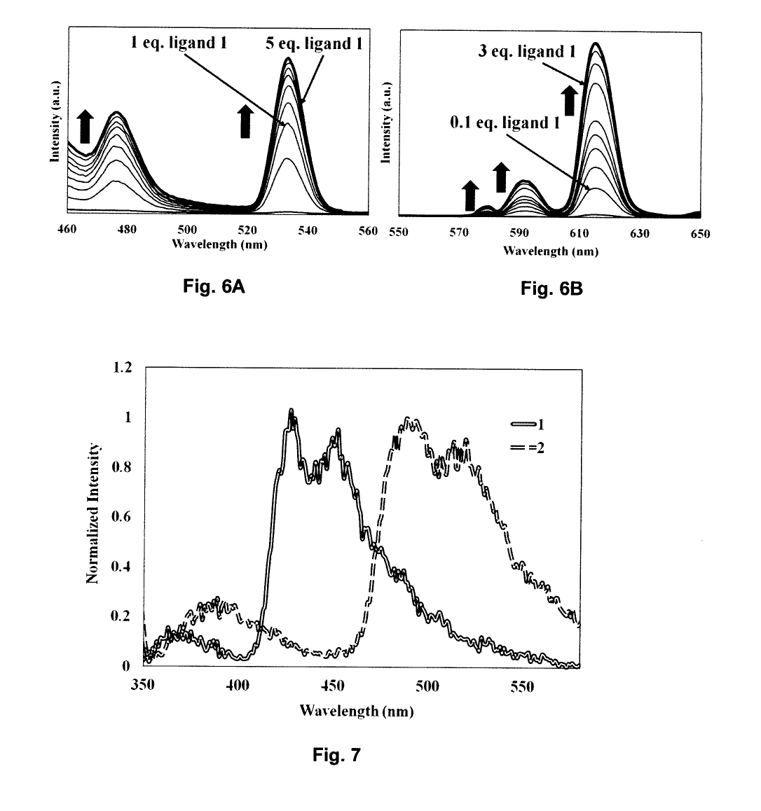

To examine the role of BMes₂ in ligands 1 and 2, benzoate (“Bz”) was used as a comparative ligand. Bz is similar to ligands 1 and 2 if their BMes₂ terminus were removed. Since the key difference between ligands 1 and 2 and benzoate is the BMes₂ group, titration experiments were conducted of Tb(Bz)₃ and Eu(Bz)₃ by ligands 1 and 2, respectively. As shown in FIG. 6, the addition of ligand 1 to the solution of Tb(Bz)₃ or Eu(Bz)₃ led to a drastic intensity increase of the Ln(III) emission bands. An exchange of ligand 1 in place of benzoate clearly enhanced the emission of the rare earth metal ions. Similar results were obtained for ligand 2 with Eu(Bz)₃. These experiments established that a sterically protected diarylboron group is critical in activating Tb(III) or Eu(III) emission. The fact that ligand 1 can activate both Tb(III) and Eu(III) emission while ligand 2 can only activate Eu(III) emission may be explained by the triplet energy difference of the two ligands. It is known that in order to activate rare earth ion emission, a ligand's triplet energy should be close to and above that of the emissive state of the rare earth ion. To determine the triplet excited energy level of ligands 1 and 2, phosphorescence spectra at 77 K were recorded in tetrahydrofuran (see FIG. 7) and the T₁ triplet energy level was calculated to be 24,398 cm⁻¹ and 21,563 cm⁻¹ respectively, which are above the lowest excited resonance levels (or the emissive states) ⁵D₄ of Tb(III) (20,500 cm⁻¹) and ⁵D₀ of Eu(III) (17,250 cm⁻¹). Ineffective enhancement of the Tb(III) ion with ligand 2 may be attributed to the T₁ level of the ligand being too close to the lanthanide series ⁵D₄ resonance level (Δν=1,063 cm⁻¹) resulting in an inefficient energy transfer. Relatively low Eu(III) emission quantum efficiencies of 1Eu and 2Eu may be caused by a very large energy difference of the ligand's triplet state and ⁵D₀ that is also known to result in low emission efficiency due to non-radiative deactivation of the emitting state.

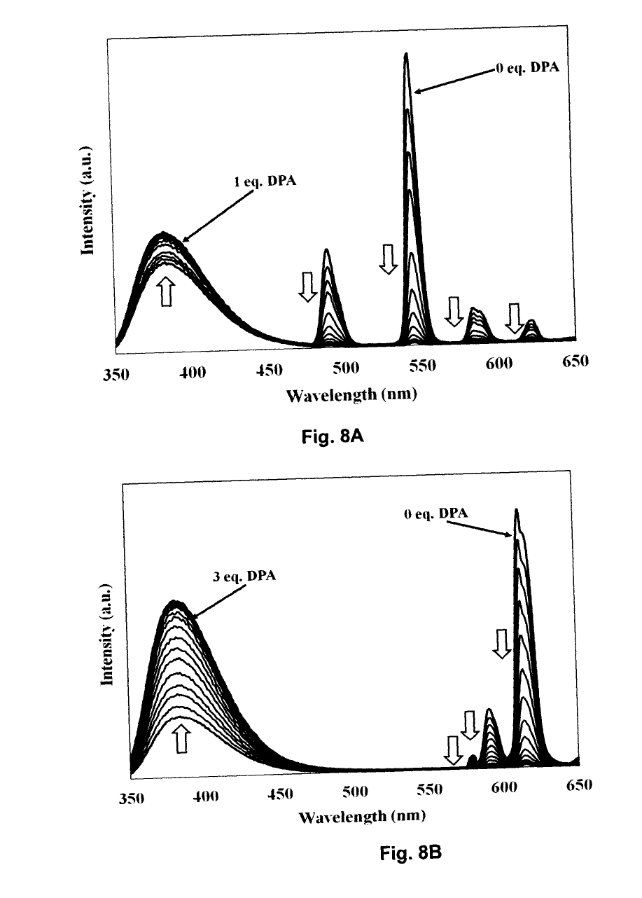

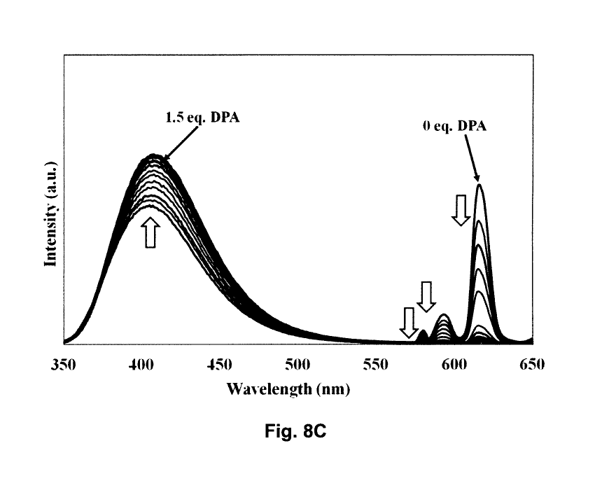

Organoboron rare earth metal complexes as described herein are useful as detectors for presence or absence of fluoride, cyanide, and DPA. As shown in the Figures, solution titration tests for all three analytes (fluoride, cyanide and DPA) showed distinct spectral and color change upon contact with the potential luminescent sensors at very low concentrations of below 0.1 ppm in organic solvents. These results indicate that a change in a complexes' luminescence can be used for detecting fluoride, cyanide and biological markers of pathogens such as anthrax (see FIGS. 8-10). Also, lack of change in such a complexes' luminescence can be used to detect an absence of fluoride, cyanide and biological markers of pathogens such as anthrax.

To test if such complexes can be used for practical sensing of fluoride, 1Tb and 1Eu were loaded onto filter papers. Such prepared filter papers have a weak response to aqueous solutions of F⁻. However, they did show distinct response to tetrabutylammonium fluoride (“TBAF”), NBu₄F, in MeOH (1Tb and 1Eu are insoluble in MeOH), changing emission color to blue, with a visual detection limit of 50-100 ppm. Similarly prepared Tb(Bz)₃ or Eu(Bz)₃ filter papers did not show any emission color change toward F⁻. The 1Tb and 1Eu filter papers also respond to tetraethylammonium cyanide (“TEACN”), NEt₄CN, with a less distinct color change, compared to TBAF. Blank MeOH was used as a control.

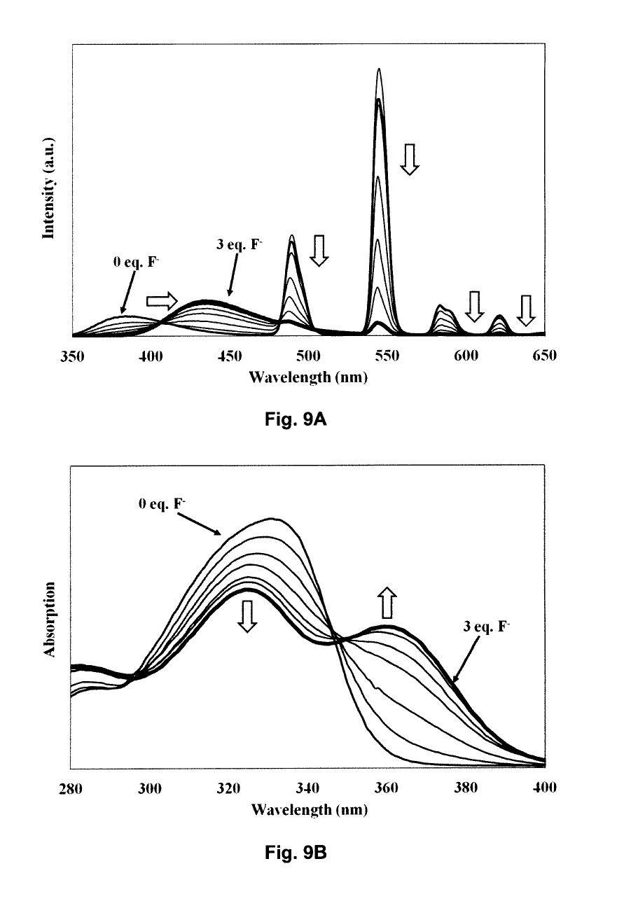

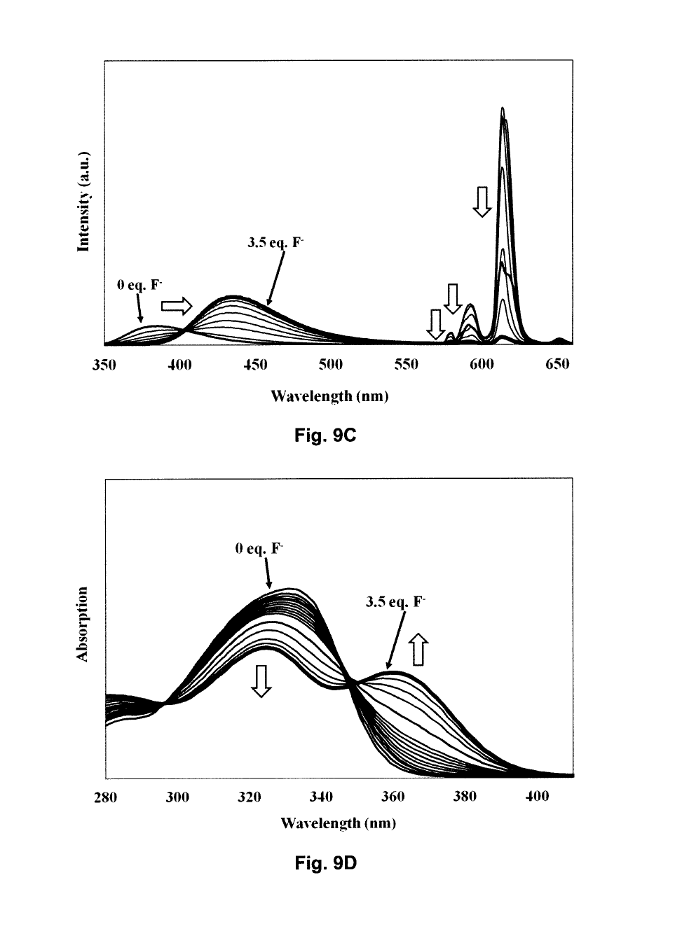

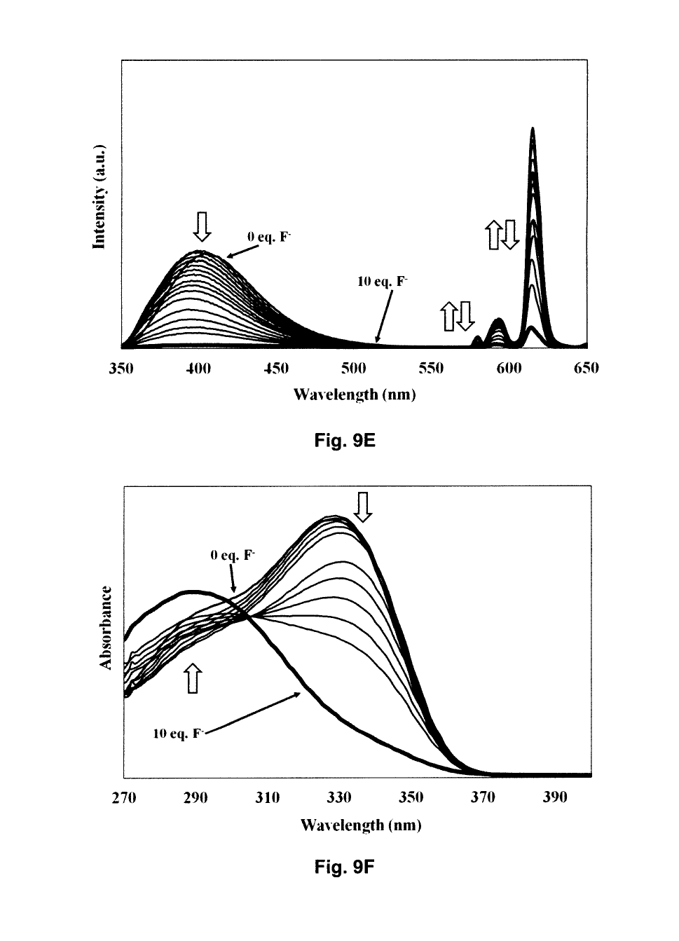

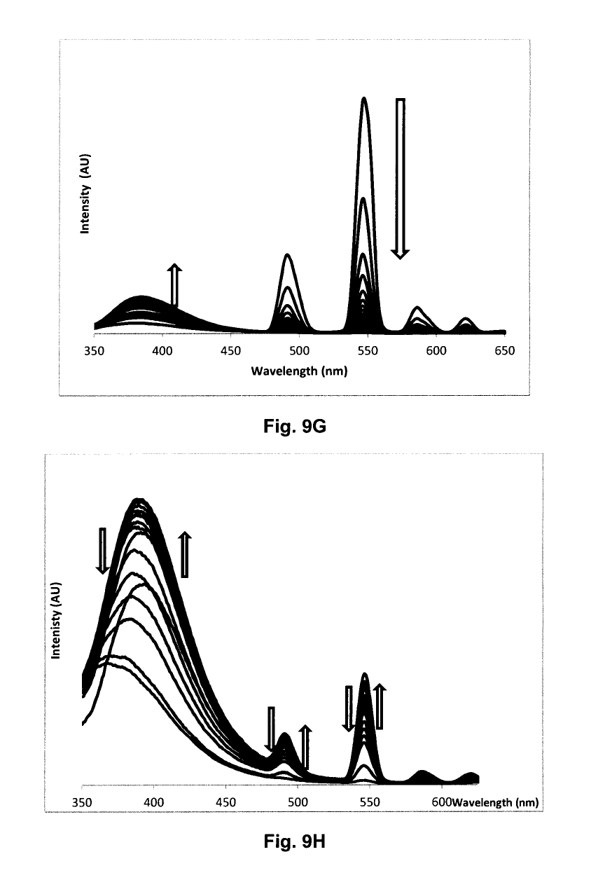

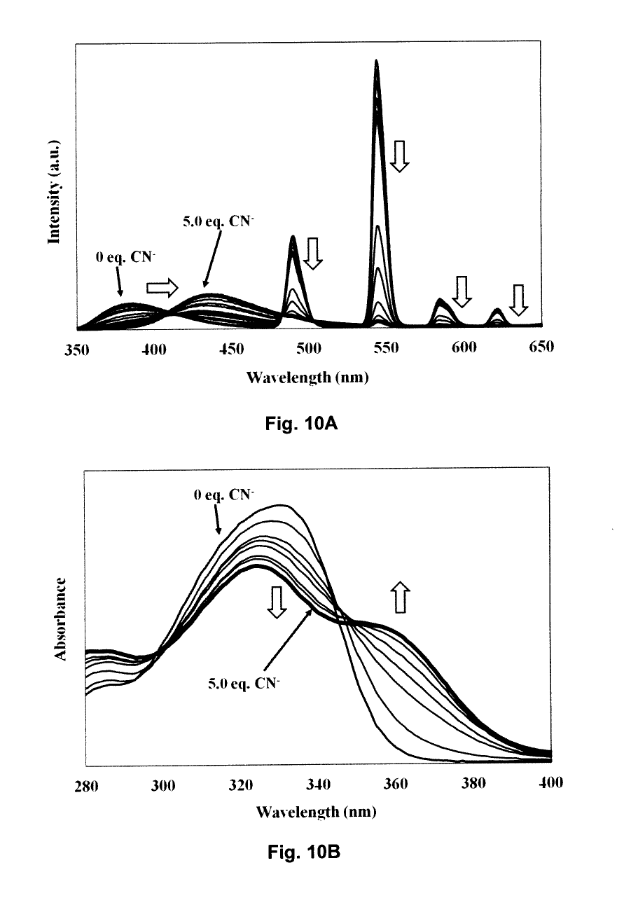

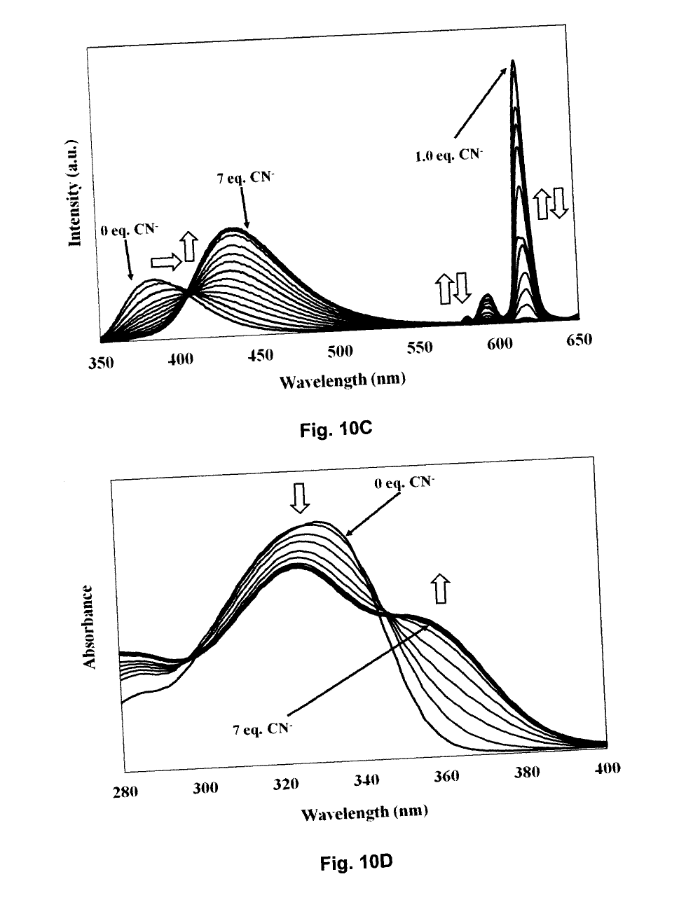

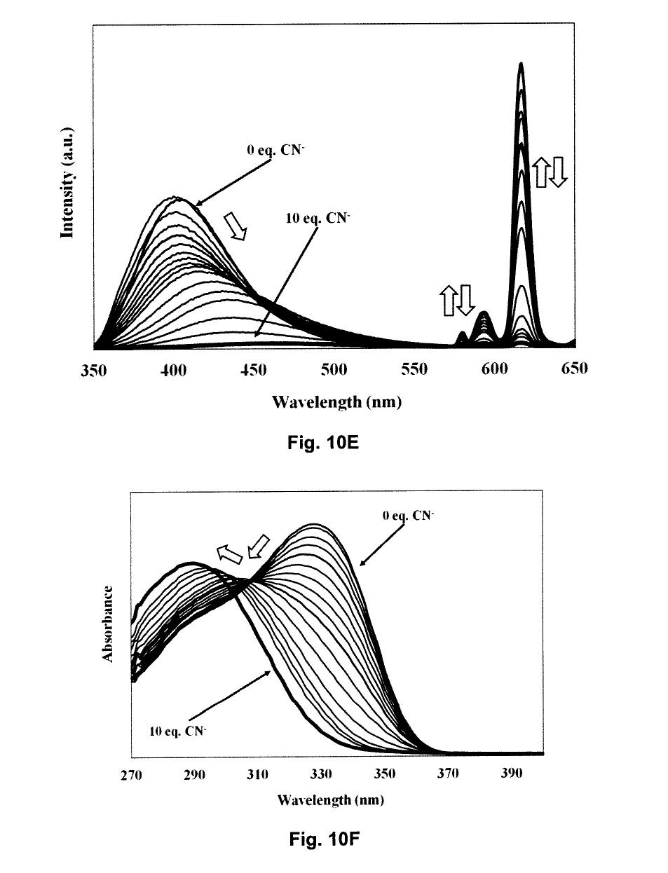

To further probe the impact of BMes₂ on the rare earth metal ion emission and the possible use of the rare earth complexes in detecting anions such as fluoride and cyanide, absorption and luminescence spectral change of complexes 1Tb, 1Eu and 2Eu were studied in response to the addition of TBAF and TEACN in THF (see FIGS. 9 and 10). For 1Tb, addition of TBAF or TEACN caused a general decrease of the Tb(III) emission bands and a red shift of the ligand's luminescence band from ˜385 nm to 430 nm, leading to the emission color change from green to blue, as shown in FIGS. 9 and 10. Because the ligand's luminescence band change and the absorption spectral change of 1Tb with the addition of <3.0 eq. anions resemble those of the free ligand 1 containing ligand 1, the quenching of the Tb(III) emission bands can be attributed to the binding of the anions to the boron atom, that decreases the first excited state energy of the ligand, thus lowering of the triplet energy, leading to the diminished emission intensity of the Tb(III) ion. The decrease of the first excited energy of ligand 1 upon the addition of F⁻ and CN⁻ to the boron center is caused by the low energy charge transfer transition of the BMes₂X group (X=F⁻ or CN⁻) to the carboxylate, in agreement with the behaviour of the free ligand. A control experiment with 1Tb being titrated by TBACl showed that the Tb(III) emission did not display any appreciable quenching. This result further supports that the color and spectral change of 1Tb upon the addition of ˜3 eq. F⁻ or CN⁻ is caused by selective binding of the F⁻ or CN⁻ anions to the B center.

For 1Eu, the addition of F⁻ or CN⁻ causes the luminescence of the solution to undergo multi-stage color change, a consequence of the combined change of the ligand-based luminescence band and the Eu(III) emission bands. It is noteworthy that the addition of anions to the 1Eu causes first a great increase of the Eu(III) emission peaks, and only after the addition of more than 2 eq. of the anion the Eu(III) peaks experience intensity decrease. Furthermore, the ligand's luminescence band experiences a red shift in the same manner as that observed in 1Tb. The initial intensity gain with the addition of ˜2 eq. anions may thus be attributed to the lowering of the triplet state of the ligand after anion binding to the B atom, making the ligand more effective in Eu(III) emission activation. Subsequent quenching can be attributed to the replacement of carboxyllate ligand by the anion. These experiments confirmed that the boryl group has indeed a strong impact on emission of the metal ions, which may in turn be used for anion sensing/detection by monitoring the emission bands.

Interestingly, ligand 2 was found to be ineffective in enhancing Tb(III) luminescence. Complex 2Tb did not demonstrate any Tb(III) emission bands. As a result, 2Tb was not tested as a candidate for detection of cyanide or fluoride. Complexes 3Tb, 4Tb, 5Eu, 6Eu, Tb(L30)₃(H₂0)ₓ, and Tb(L70)₃(H₂O)ₓ all showed similar responses to fluoride ions as were seen for complexes 1Tb, 1Eu and 2Eu (see FIGS. 8A-D and 9A-H).

Fluoride titration spectra are shown in FIGS. 9A-H. Interestingly, as concentration of F⁻ increased, the complex's emission pattern changed. For example in FIG. 9H, a peak due to ligand emission, at around 395 nm, initially increased in intensity due to F⁻ adding to B as concentration of F⁻ increased. Eventually, the concentration of F⁻ was sufficient to have F⁻ adding directly to Tb. Such metal addition leads to a decrease in the intensity of the boryl ligand emission peak this peak is now emission of the unbound fluoro-substituted boryl ligand. Other examples of the changes include metal emission peaks around 490 and 545 nm, wherein the intensity initially increased with increasing [F⁻], but eventually decreased as the enhancement terminated with replacement of the boryl ligand on the metal with F⁻.

These studies indicate that organoboron bound-rare earth metal ions are excellent candidates for use in detection and or quantitation of fluoride and cyanide. In one embodiment, detection of this sort could be done using paper impregnanted with such complexes. Such detection could be done by contacting a portion of such impregnated paper to a test solution that potentially includes fluoride and/or iodide, and then shining UV light on the paper to see if the portion that was contacted with the test solution luminesces at a different wavelength (i.e., different colour apparent to the human eye) than the non-contacted impregnated paper. This is similar to using “pH paper” to test the pH of a solution. Although it is not possible to determine which of F⁻ and CN⁻ is causing an observed change in emission, several tests are available that are cyanide specific. If one or the other of cyanide and fluoride is known to be absent from a test solution, then detection would be quick for presence of the other. For example, drinking water has sometimes undergone fluorination but it would be unlikely to comprise cyanide. Other items that are frequently tested for fluoride include: tap water, blood, urine, toothpaste, bottled water, food products, water purifier product, effluent of industrial process, and bodily fluids.

Studies were conducted that indicated that complexes of triarylboron bound-rare earth metal ions described herein are useful for detection of pathogens. It is desirable to be able to detect biological markers of infectious agents at very low concentrations. For safety reasons, only model compounds are used for research into detection of such biological markers. For example, DPA (pyridine-2,6-dicarboxylic acid) is used in studies described herein as a model of bacillus anthraxus (anthrax spore) (see Angew. Chem. Int. Ed. 2010, 49, 5938-5941). DPA is a good choice as such a model compound since compounds that bind to DPA are known to bind to an anthrax spore.

Titration studies were conducted and results are shown graphically in FIG. 8. Specifically, complexes 1Tb, 1Eu, and 2Eu were found to be effective detectors of DPA. As the concentration of DPA increased, it quenched the boron/Ln emission. Again, since ligand 2 was found to be ineffective in enhancing Tb(III) luminescence. Complex 2Tb did not demonstrate any Tb(III) emission bands. As a result, 2Tb was not tested as a candidate for detection of DPA.

Hence, results show that such complexes of triarylboron and rare earth metal ions could be used as detectors of such biological markers as an anthrax spore.

Results noted throughout the experiment lead to observation that the rare earth complexes studied herein are stable and retained luminescence up to 250° C. Higher temperatures appeared to cause decomposition of 1Tb as discoloration was observed both under ambient light and under 365 nm irradiation.

The following working examples further illustrate the present invention and are not intended to be limiting in any respect. All documents referred to herein are incorporated by reference in their entirety.

### WORKING EXAMPLES

Ligand synthetic procedures were performed under N₂ using standard Schlenck line techniques. Complex synthesitic procedures were performed under air at room temperature. Starting materials were purchased from Aldrich Chemical Co. (Oakville, ON, Canada) and were utilized without further purification. Solvents were acquired from Fisher Scientific Co. (Toronto, ON, Canada) and purified using the solvent purification system (Innovation Technologies Co.) (Amesbury, Mass., USA). Column chromatography was carried out on silica. Deuterated solvents CDCl₃ and MeOD were purchased from Cambridge Isotopes (St Leonard, Quebec, Canada) and used as acquired without additional purification or drying. NMR spectra were acquired on a Bruker Advance 400 MHz Spectrometer (Bruker, EastMilton, ON, Canada). All samples were measured at around 5 mg, with a deuterated solution sample height of about 5 cm. UV-Vis data was recorded on a Varian Cary 50 Bio spectrometer (available from Agilent Technologies, Mississauga, ON, Canada). Emission spectra were acquired using a PTI Time Master Pro spectrometer (London, ON, Canada). Solid-state emission data was detected using a PTI LabSphere (London, ON, Canada) integration sphere simultaneously with the luminescence spectrometer. Elemental analyses were performed at the Elemental Analysis Laboratory at the University of Montreal, Montreal, Quebec, Canada. IR Spectra were acquired using the diffuse reflectance infrared Fourier transform (DRIFT) method on a Varian 640 FTIR spectrometer (Agilent Technologies).

### Example 1

### Synthesis of Ligands

### Example 1A

### Synthesis of Ligand 1: 4-(dimesitylboryl)-2,3,5,6-tetramethylbenzoic acid

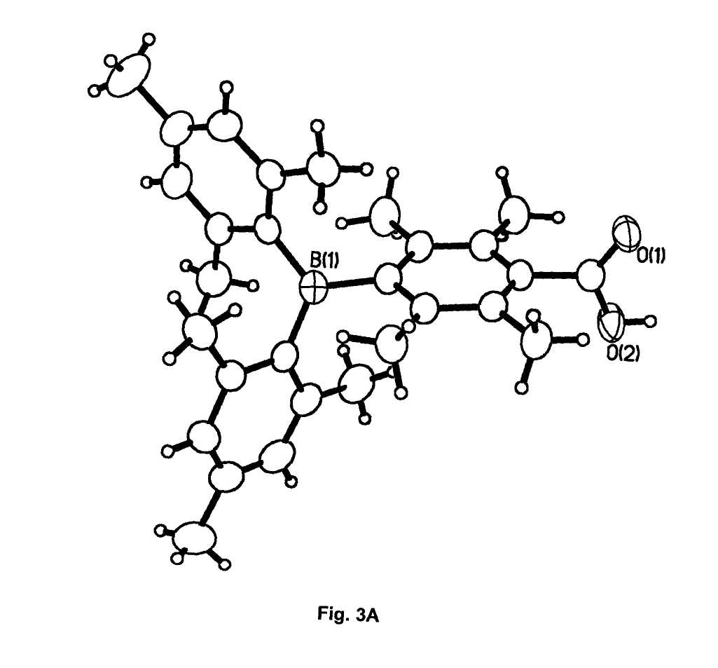

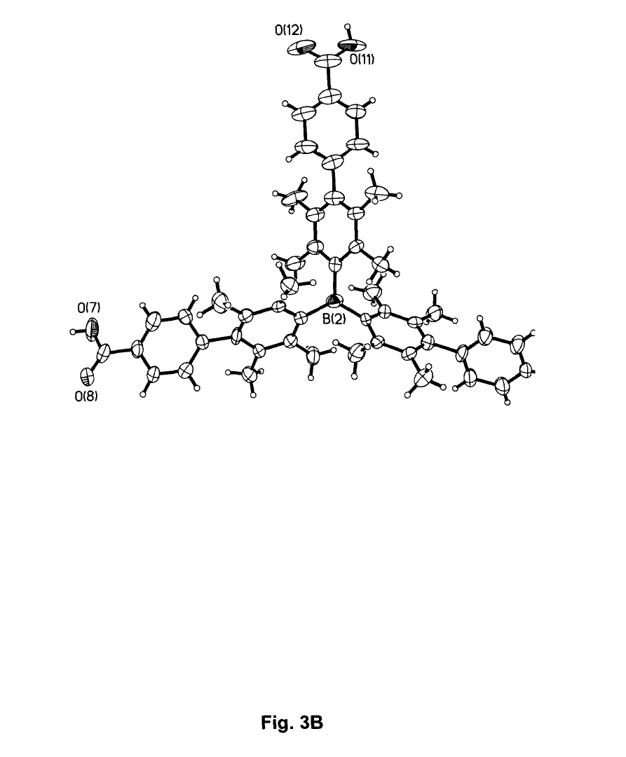

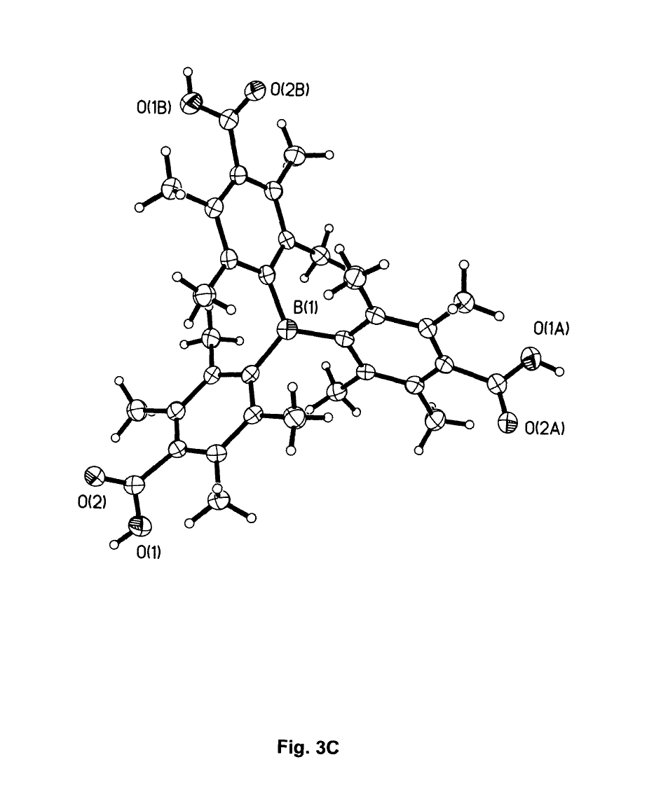

Scheme S1 below provides a summary of this synthetic procedure. The intermediate (4-bromo-2,3,5,6-tetramethylphenyl)dimesitylborane was synthesized as previously reported (see Org. Lett. 2000, 2(26), 4129) by lithiating 1.2 g (4.1 mmol) of precursor 1,4-dibromo-2,3,5,6-tetramethylbenzene (see Angew. Chem. Int. Ed. 2008, 47, 4538) at 195 K with n-BuLi (4.8 mmol) in dry nitrogenated THF and subsequently reacting it with dimesitylboron fluoride (1.1 g, 4.1 mmol) by using air and water sensitive schlenck line methods. The reaction was stirred overnight, worked up using water and CH₂Cl₂ and the product was purified using column chromatography and eluted with hexanes. The final product was created by stirring (4-bromo-2,3,5,6-tetramethylphenyl)dimesitylborane (1.50 g, 3.26 mmol) in dry degassed THF at 195 K under air and water sensitive schlenck line conditions and adding n-BuLi (3.6 mmol) drop wise to the reaction flask. The mixture was stirred at 195 K for 60 min after which CO₂ gas was bubbled into the reaction for an additional hour. Aqueous 1 M HCl solution was added to the reaction mixture to acidify the compound and the mixture was subsequently worked up using CHCl₃ and water. Column chromatography was used to purify the components of the reaction with the final product (1) being eluted with (5:95) MeOH: CH₂Cl₂ as a white solid in 67% yield. ¹H NMR (400 MHz, 2% CD₃OD in CDCl₃): δ6.66 (4H, s), 2.14 (12H, d, J=40 Hz), 1.92 (6H, s), 1.88 (12H, s) ppm; ¹³C NMR (100 MHz, CDCl₃): δ 175.4, 143.1, 139.9, 139.7, 138.5, 134.8, 133.5, 128.0, 127.8, 22.0, 20.2, 18.7, 16.0 ppm; ¹¹B NMR (400 MHz, 2% CD₃OD in CDCl₃): δ77.95 ppm; IR (cm⁻¹): _{asy}(CO₂⁻)1696, _{sy}(CO₂⁻)1416; LRMS, m/z: [M⁺]=426.27; [M⁺-mesityl]=306.15. Anal Calcd for C₂₉H₃₅BO₂: C, 81.69; H, 8.27. Found: C, 81.17; H, 8.33. See X-ray crystal structure in FIG. 3A. See FIGS. 5A&B for UV-vis and emission spectra of 1.

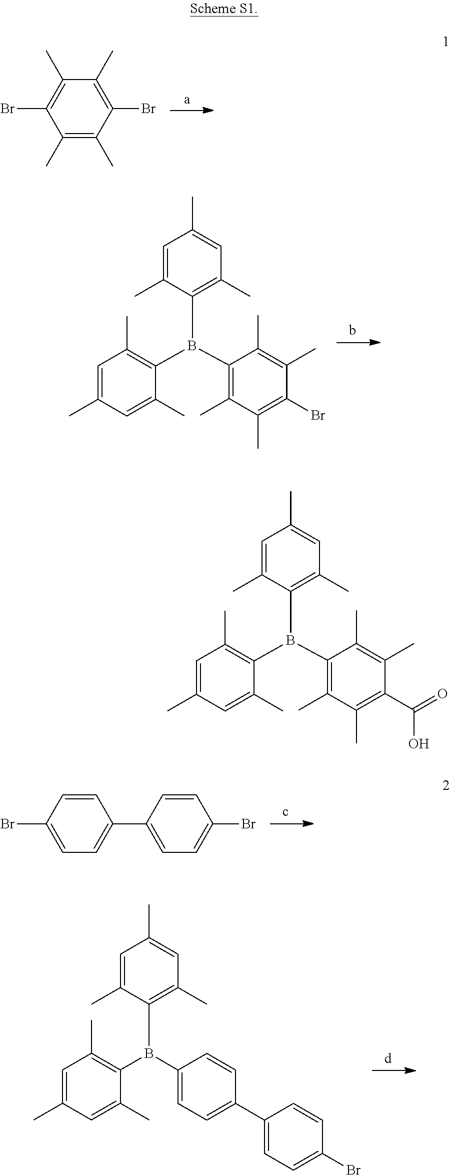 [SMILES: Cc1c(C)c(Br)c(C)c(C)c1Br ; Cc1cc(C)c(B(c2c(C)cc(C)cc2C)c2c(C)c(C)c(Br)c(C)c2C)c(C)c1 ; Cc1cc(C)c(B(c2c(C)cc(C)cc2C)c2c(C)c(C)c(C(=O)O)c(C)c2C)c(C)c1 ; Brc1ccc(-c2ccc(Br)cc2)cc1 ; Cc1cc(C)c(B(c2ccc(-c3ccc(Br)cc3)cc2)c2c(C)cc(C)cc2C)c(C)c1]

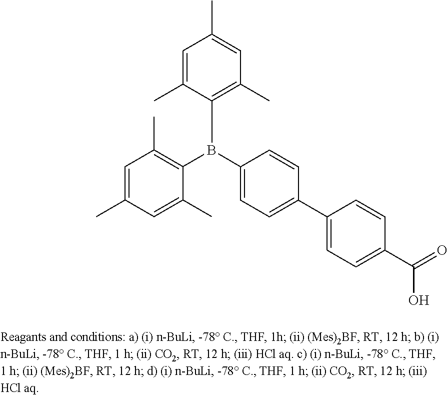 [SMILES: Cc1cc(C)c(B(c2ccc(-c3ccc(C(=O)O)cc3)cc2)c2c(C)cc(C)cc2C)c(C)c1]

### Example 1B

### Synthesis of Ligand 2: 4′-(dimesitylboryl)biphenyl-4-carboxylic acid

Scheme S1 above provides a summary of this synthetic procedure. Compound 2 was synthesized, using a previously reported method (see Inorg. Chem. 2012, 51, 778), by dissolving (4′-bromobiphenyl-4-yl)dimesitylborane (1.1 g, 2.3 mmol) in dry and degassed THF and cooled to 195 K under N₂. Once cooled, n-BuLi (2.5 mmol in hexane) was slowly added dropwise to the flask and the mixture was left to stir for 60 min. CO₂ gas was bubbled into the reaction flask for an additional hour followed by the addition of 1 M aqueous HCl to acidify the mixture. The reaction was worked up using water and CHCl₃ and purified using column chromatography with (0.5:99.5) MeOH: CH₂Cl₂ as the eluent. Final product (2) was a white powder in 54% yield. See FIGS. 5A&B for UV-vis and emission spectra of 2.

### Example 1C

### Synthesis of the Potassium Salts of 1 and 2 (1-OK & 2-OK)

4-(dimesitylboryl)-2,3,5,6-tetramethylbenzoic acid and 4′-(dimesitylboryl)biphenyl-4-carboxylic acid were modified into their respective potassium salts by individually dissolving the compounds in dry THF at 273 K under nitrogen and stirring them for 10 min under schlenck line conditions. One molar equivalent amount of potassium t-butoxide was added then to the reaction flask and the reaction mixtures were left to stir at 273 K for 60 min. Solvent was removed by vacuum, and the corresponding potassium salts were produced in quantitative yields.

### Example 1D

### Two Step Synthesis of Ligand 3

### Step 1 for Ligand 3: Synthesis of Tris(2′,3′,5′,6′-tetramethylbiphenyl-4-methoxycarbonyl)borane

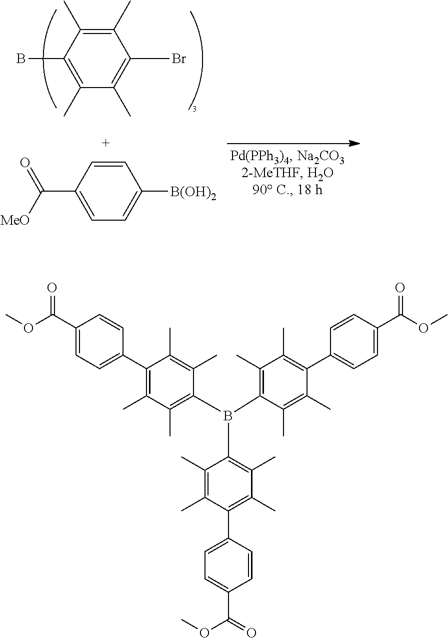

Tris-(4-bromoduryl)borane (1.0 g, 1.5 mmol), 4-methoxycarbonylphenylboronic acid (1.39 g, 7.7 mmol, 5 equiv.), and Pd(PPh₃)₄ (86 mg, 0.074 mmol, 5 mol %) were dissolved in 2-methyltetrahydrofuran (25 ml) and degassed. In a separate flask, an aqueous 1 M Na₂CO₃ solution (10 ml) was degassed. The solutions were combined and heated to 90° C. for 18 hours. The solution was cooled to rt, and ethylacetate (60 ml) was added. The reaction mixture was washed with water, the organic layer dried with MgSO₄, and solvent reduced under reduced pressure. The residue was subjected to column chromatography (SiO₂) using dichloromethane as the eluent to afford pure 6. 82% yield (1.05 g, 1.3 mmol). ¹H NMR (400 MHz, 298 K, CDCl₃): δ 8.08 (d, J=8.0 Hz, 6H), 7.21 (d, J=8.0 Hz, 6H), 3.94 (s, 9H), 2.06 (s, 18H), 1.82 (s, 18H); ¹³C NMR (100 MHz, 298 K, CDCl₃): δ 167.2, 149.1, 148.6, 142.2, 135.8, 130.8, 129.7, 129.6, 128.2, 52.1, 20.2, 17.9; HRMS calcd. for C₃₁H₃₁BO₂: 446.2423. Found: 446.2426. UV-Vis (CH₂Cl₂, 298K) λₘₐₓ=333 nm (ε=17150 M⁻¹ cm⁻).

### Step 2 for Ligand 3: Synthesis of Tris(2′,3′,5′,6′-tetramethylbiphenyl-4-carboxylic acid)borane

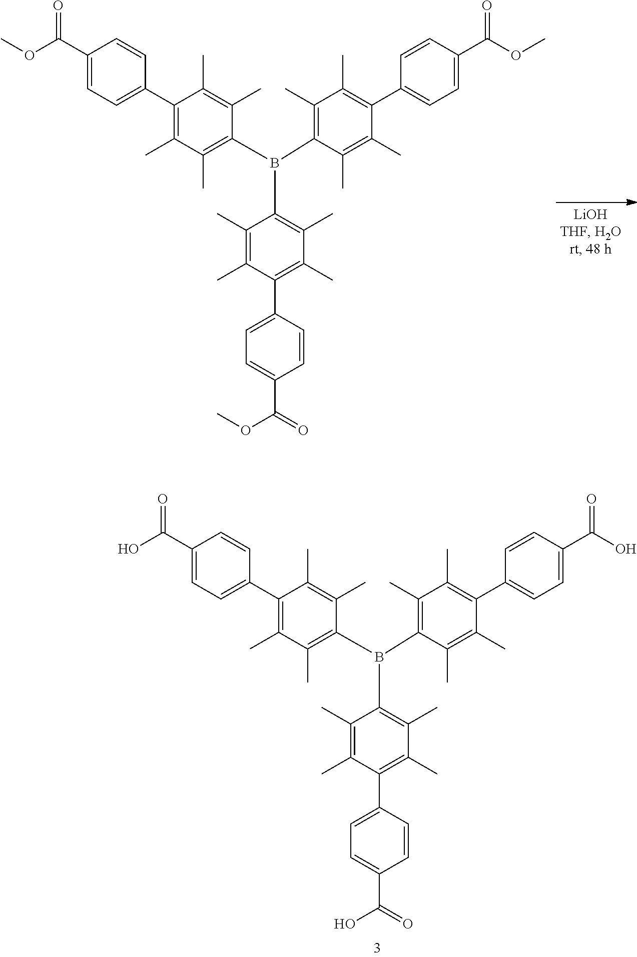

Tris-ester Tris(2′,3′,5′,6′-tetramethylbiphenyl-4-methoxycarbonyl)borane (0.5 g, 0.6 mmol) was dissolved in THF (20 ml) and 1M LiOH (20 ml) was added. The reaction was allowed to stir for 2 days at room temperature. The solution was acidified with 1M HCl and the mixture was extracted with chloroform (100 ml). If emulsion appeared, isopropanol (5% by volume of CHCl₃) was added and extraction was attempted again. The organic layer was dried with MgSO₄, filtered and solvent removed under reduced pressure. The residue was purified via column chromatography (SiO₂) using CH₂Cl₂/MeOH (95:5) as the eluent, 89% yield (0.42 g, 0.55 mmol). ¹H NMR (400 MHz, 298 K, CDCl₃): δ 13.13 (bs, 3H), 8.03 (d, J=8.0 Hz, 6H), 7.15 (d, J=8.0 Hz, 6H), 1.99 (s, 18H), 1.75 (s, 18H); ¹³C NMR (100 MHz, 298 K, CDCl₃): δ 169.0, 149.0, 148.6, 142.1, 135.7, 130.7, 129.7, 129.5, 128.2, 20.0, 17.6; HRMS calcd. for C₅₄H₅₇BO₆: 812.4257. Found: 812.4287. UV-Vis (CH₂Cl₂, 298K) λₘₐₓ=333 nm (ε=18410 M⁻¹ cm⁻¹). See X-ray crystal structure in FIG. 3B.

### Example 1E

### Synthesis of 4: Tris(duryl-4-carboxylic acid)borane

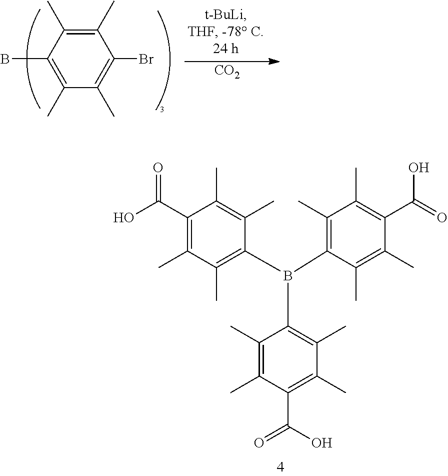

Precursor tris(4-bromo-2,3,5,6-tetramethylphenyl)borane (0.5 g, 0.77 mmol) was dissolved in anhydrous tetrahydrofuran (20 mL) at −78°. t-Butyllithium (4.53 mL, 5.03 mmol, 6 equivalents) was then carefully added to the sample over a period of 60 mins while stirring. To obtain the desired tris-carboxyllate, the mixture was then bubbled with carbon dioxide overnight and followed by acidification with 2M aqueous HCl in order to neutralize the reaction. The solution was extracted with chloroform, dried with MgSO₄ and vacuum filtered to obtain pure product (0.32 g, 0.58 mmol) in 64% yield. ¹H NMR (300 MHz, 298 K, CDCl₃, MeOH): δ10.47 (s, 3H), 2.0 (s, 18H), 1.79 (s, 18H) ¹³C NMR (100 MHz, 298 K, CDCl₃/MeOH): δ173.95, 149.43, 136.95, 136.18, 136.00, 133.00, 128.78, 19.58, 19.06, 16.95. HRMS calcd. for C₃₃H₃₉BO₆: 542.4702. Found: 542.4611. See X-ray crystal structure in FIG. 3C.

### Example 1F

### Two Step Synthesis of Ligand 5

### Step 1 for Ligand 5: Synthesis of Precursor 1-(4-(dimesitylboryl)phenyl)ethanone (“Compound A”)

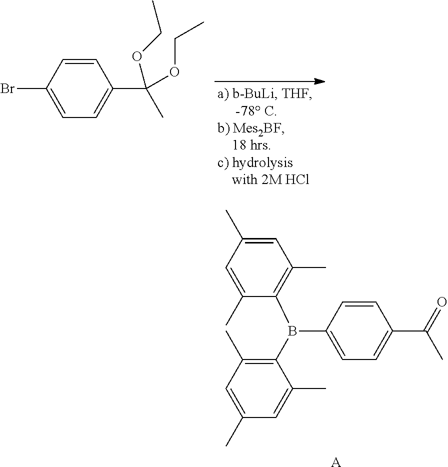

As noted in the above reaction scheme, 1-(4-(dimesitylboryl)phenyl)ethanone (“compound A”) was prepared under N₂, 4-bromoacetophenone diethylketal (3.05 g, 0.011 mol, 1 eq.) was dissolved in anhydrous THF (125 mL) and cooled to −78° C. 1.6 M n-BuLi (7.7 mL, 0.012 mol, 1.05 eq.) was added dropwise over 40 minutes and then allowed to stir for 60 min at −78° C. In one portion, solid dimesitylboron fluoride (3.0 g, 0.011 mol 1 eq.) was added to the reaction mixture at −78° C., and the reaction allowed to warmed to room temperature while stirring over night. The reaction was quenched with sat. NH₄Cl solution, excess THF removed under reduced pressure, and the residue extracted with diethylether and washed with distilled water. The organic layer was dried with MgSO₄, filtered, and concentrated under reduced pressure to afford a pale yellow solid. The residue was purified by column chromatography (5:1 hexanes/CH₂Cl₂) to afford a colorless oil that solidified upon standing (3.36 g, 9.1 mmol, 83% yield). ¹H NMR (400 MHz, 298 K, CDCl₃): δ7.91 (d, J=8.3 Hz, 2H), 7.59 (d, J=8.3 Hz, 2H), 6.84 (s, 4H), 2.63 (s, 3H), 2.32 (s, 6H), 1.98 (s, 12H); ¹³C NMR (100 MHz, 298 K, CDCl₃): δ 198.5, 141.4, 140.8, 139.2, 138.8, 135.7, 128.3, 127.6, 26.8, 23.4, 21.2; ¹¹B NMR (128 MHz, 298 K, CDCl₃): δ 78.7; Anal. Calcd for C₂₆H₂₉BO: C, 84.78; H, 7.94.

### Step 2 for Ligand 5: Synthesis of Ligand 5

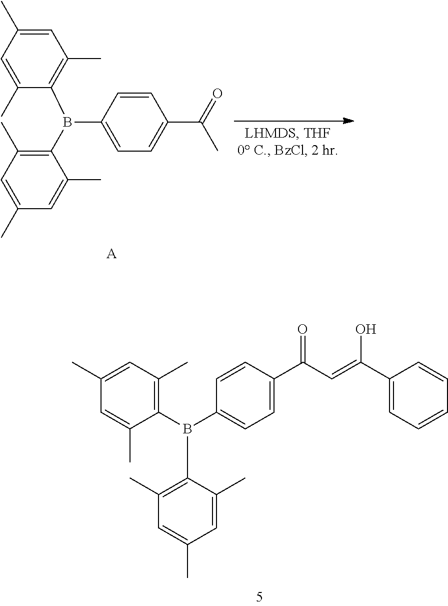

1-(4-(dimesitylboryl)phenyl)ethanone (A) (0.6 g, 1.6 mmol, 1 eq.) was dissolved in anhydrous THF (10 mL) and cooled to 0° C. Separately, Lithium hexamethyldisilylamide (LHMDS, 0.57 g, 3.4 mmol 2.1 eq.) was dissolved in anhydrous THF (15 mL) and then quickly added dropwise to the cooled THF solution of A. The reaction was allowed to stir for 20 min allowing enolate to quantitatively form. Benzoyl chloride (0.18 mL, 1.55 mmol, 0.95 eq.) was added dropwise to the reaction mixture (still cooled at 0° C.), the reaction allowed to stir for 1 h at 0° C., and then 1 h room temperature. The reaction mixture was diluted with diethylether, and sequentially washed with 1M HCl solution, water and brine. The organic layer was then dried with MgSO₄, filtered, and concentrated under reduced pressure. The crude product was purified by column chromatography (4:1 hexanes/CH₂Cl₂) to afford a pale yellow fluffy solid (0.67 g, 1.4 mmol, 87% yield). ¹H NMR (400 MHz, 298 K, CDCl₃): δ 16.87 (s, 1H), 8.02 (d, J=7.1 Hz, 2H), 7.95 (d, J=8.1 Hz, 2H), 7.64 (d, J=8.1 Hz, 2H), 7.57 (t, J=7.1 Hz, 1H), 7.50 (dd, J=7.1 Hz, 7.1 Hz), 6.97 (s, 1H), 6.86 (s, 4H), 2.34 (s, 6H), 2.03 (s, 12H); ¹³C NMR (100 MHz, 298 K, CDCl₃): δ 186.7, 184.8, 141.6, 140.9, 139.2 137.9, 136.1, 135.7, 132.6, 128.7, 128.4 (2C), 123.3, 126.5, 93.7, 23.5, 21.3; ¹¹B NMR (128 MHz, 298 K, CDCl₃): δ 83.5; Anal. Calcd for C₃₃H₃₃BO₂: C, 83.90; H, 7.04. Found: C, 83.70; H, 7.17.

### Example 1G

### Synthesis of 6

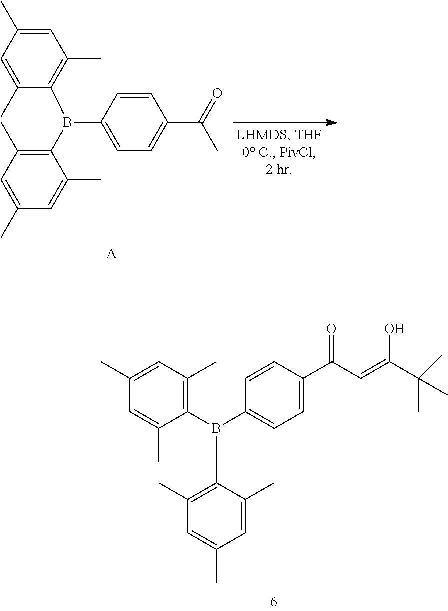

1-(4-(dimesitylboryl)phenyl)ethanone (A, as synthesized in Example 1F, step 1) (0.6 g, 1.6 mmol, 1 eq.) was dissolved in anhydrous THF (10 mL) and cooled to 0° C. Separately, Lithium hexamethyldisilylamide (LHMDS, 0.57 g, 3.4 mmol 2.1 eq.) was dissolved in anhydrous THF (15 mL) and then quickly added dropwise to the cooled THF solution of A. The reaction was allowed to stir for 20 min allowing enolate to quantitatively form. Pivaloyl chloride (0.185 g, 1.55 mmol, 0.95 eq.) was added dropwise to the reaction mixture (still cooled at 0° C.), the reaction allowed to stir for 1 h at 0° C., and then 1 h room temperature. The reaction mixture was diluted with diethylether, and sequentially washed with 1M HCl solution, water and brine. The organic layer was then dried with MgSO₄, filtered, and concentrated under reduced pressure. The crude product was purified by column chromatography (20:1 hexanes/CH₂Cl₂) to afford a pale white fluffy solid (0.53 g, 1.1 mmol, 68% yield). ¹H NMR (400 MHz, 298 K, CDCl₃): δ 16.35 (s, 1H), 7.83 (d, J=8.0 Hz, 2H), 7.57 (d, J=8.0 Hz, 2H), 6.83 (s, 4H), 6.34 (s, 1H), 2.31 (s, 6H), 1.98 (s, 12H), 1.25 (s, 9H); ¹³C NMR (100 MHz, 298 K, CDCl₃): δ 203.9, 183.4, 150.0, 141.4, 140.8, 139.1, 137.8, 135.9, 128.2, 126.2, 92.7, 40.1, 27.3, 23.4, 21.2; ¹¹B NMR (128 MHz, 298 K, CDCl₃): δ 82.1; Anal. Calcd for C₃₁H₃₇BO₂: C, 82.30; H, 8.24. Found: C, 81.46; H, 8.41.

### Example 1H

### Synthesis of p-BMes2-duryl-dpa (Ligand L20)

L20 was prepared according to the procedure shown in Scheme S4.

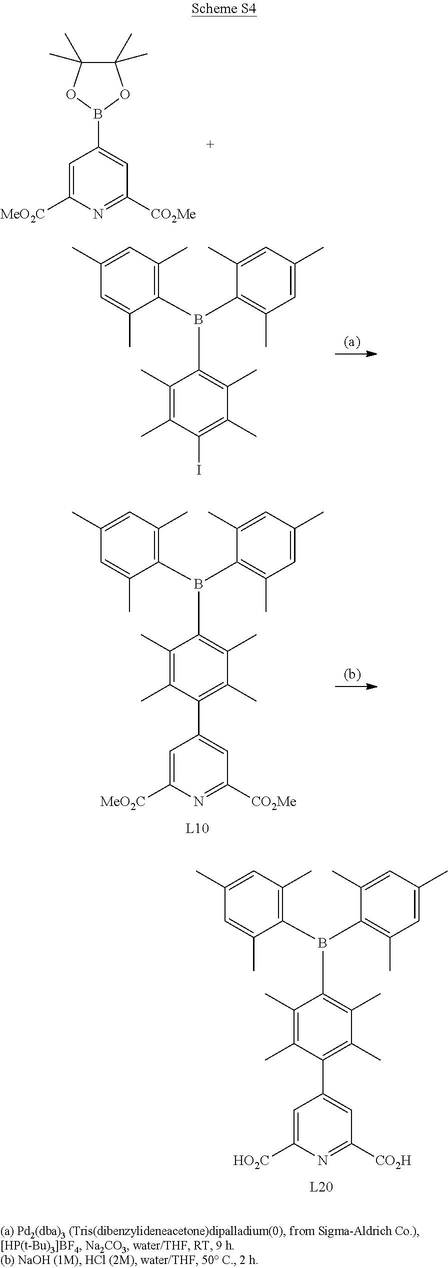

### Step 1 for Ligand L20: Synthesis of p-BMes₂-duryl-dpa ester (L10)

Dimethyl-4-(pinacolatoboronic ester)-2,6-dicarboxylate (A. D'Aleo, et al., Inorg. Chem. 2008, 47, 10269) (353 mg, 1.1 mmol, 1.1 eq.), (Iododuryl)dimesitylborane (S. Yamaguchi, et al., Org. Lett. 2000, 2, 4129) (508 mg, 1.0 mmol, 1.0 eq.), and catalyst Pd₂(dba)₃ (46 mg, 0.05 mmol, 0.05 eq.) with [HP(t-Bu)₃]BF₄ (29 mg, 0.1 mmol, 0.1 eq.) were added to 6 mL of THF at ambient temperature under nitrogen. An aqueous solution of Na₂CO₃ (530 mg, 5.0 mmol, 5.0 eq.) was then added to the THF solution under nitrogen. After stirring for 9 h at room temperature, the reaction mixture was extracted with dichloromethane, washed with water and dried over MgSO₄. The product was purified by column chromatography using ethyl acetate/hexane (1:3) as eluent. Yield: 150 mg (26%). ¹H NMR (300 MHz, CDCl₃, ppm): β=8.14 (s, 2H), 6.76 (s, 4H), 4.05 (s, 6H), 2.27 (s, 6H), 2.03 (s, 12H), 1.99 (s, 6H), 1.79 (s, 6H). ¹³C NMR (75 MHz, CDCl₃, ppm): δ=165.32, 154.68, 148.39, 144.31, 140.90, 140.65, 139.44, 138.33, 135.75, 130.05, 129.40, 128.92, 128.82, 53.21, 23.23, 22.83, 21.23, 20.14, 17.70. HRMS calcd: C₃₇H₄₂N₁O₄B₁ 575.3207. found 575.3226.

### Step 2 for Ligand L20: Synthesis of p-BMes2-duryl-dpa (L20)

To 7.5 mL of mixed solvents (THF/water, 1:2) was added L10 (150 mg, 0.26 mmol, 1.0 eq.) and 1.6 mL (6.0 eq.) of aqueous NaOH (1 M). Then, the reaction mixture was stirred at 50° C. for 2 hrs. After cooling to room temperature, HCl (2 M) was added dropwise until pH 5. A white precipitate was filtered and dried under vacuum. Yield: 122 mg (86%). ¹H NMR (300 MHz, DMSO, ppm): δ=7.88 (s, 2H), 6.79 (s, 4H), 2.24 (s, 6H), 1.98 (s, 12H), 1.93 (s, 6H), 1.76 (s, 6H). HRMS data for C₃₅H₃₇N₁B₁O₄ (M-H+), calcd: 546.2816. found: 546.2832.

### Example 1I

### Synthesis of meso-p-BMes₂-duryl-acetylacetone (L30)

Compound L30 was prepared according to the procedure shown in Scheme S5.

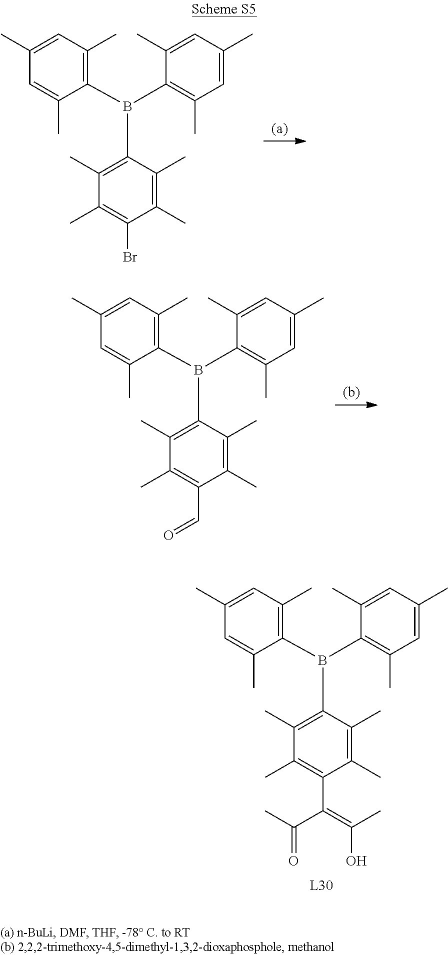

### Step 1 for Ligand L30: Synthesis of p-BMes₂-duryl aldehyde

(4-bromo-2,3,5,6-tetramethylphenyl)dimesitylborane (231 mg, 0.5 mmol, 1.0 eq.) was dissolved in 8 mL of THF and the mixture was cooled to −78° C. To the mixture was added n-BuLi (1.6 M, 0.32 mL, 0.5 mmol, 1.0 eq.) under N₂ atmosphere at −78° C. After stirring for 1 hr, dried DMF (0.08 mL, 1.0 mmol, 2.0 eq.) was added to the mixture. After cooling to room temperature, the mixture was stirred for 6 hr. HCl (2.0 N, 0.7 mL) was added dropwise and the mixture was stirred for 5 hr. After an addition of water, the mixture was extracted with diethyl ether and the combined hydrophobic extracts were dried over MgSO₄. A yellow solid was purified by column chromatography using petroleum ether/ethyl acetate (9:1) as eluent. Yield: 127 mg (62%). ¹H NMR (300 MHz, CDCl₃, ppm): δ=10.69 (s, 1H), 6.77 (s, 4H), 2.33 (s, 6H), 2.29 (s, 6H), 2.05 (s, 6H), 1.98 (s, 12H). ¹³C NMR (75 MHz, CDCl₃, ppm): δ=197.11, 141.11, 140.68, 139.73, 136.11, 135.29, 134.05, 128.96, 23.31, 22.76, 21.23, 19.99, 15.31. HRMS data for C₂₉H₃₅O₁B₁, calc: 410.2781. found: 410.2796.

### Step 2 for Ligand L30: Synthesis of meso-p-BMes₂-duryl-acetylacetone (L30)

A mixture of p-BMes₂-duryl aldehyde (450 mg, 1.1 mmol, 1.0 eq.) and 2,2,2-trimethoxy-4,5-dimethyl-1,3,2-dioxaphosphole (1.34 g, 6.6 mmol, 6.0 eq.) (available from Alfa Aesar Chemicals Co.) was stirred for 24 hrs at 60° C. Then, 6.0 mL of dried methanol is added and stirred for 4 hrs. The white precipitate was filtered and washed with methanol. Yield: 157 mg (30%). ¹H NMR (300 MHz, CDCl₃, ppm): δ=16.52 (s, 1H), 6.77 (s, 4H), 2.29 (s, 6H), 2.02 (m, 24H), 1.77 (s, 6H). ¹³C NMR (75 MHz, CDCl₃, ppm): δ=190.43, 144.43, 140.92, 140.60, 139.36, 136.01, 135.84, 133.06, 128.92, 128.81, 113.66, 23.26, 23.22, 22.70. 21.23, 20.42, 16.76. HRMS calcd: C₃₃H₄₁O2B₁ 480.3200. found 480.3219.

### Example 1J

### Synthesis of L40 and L50

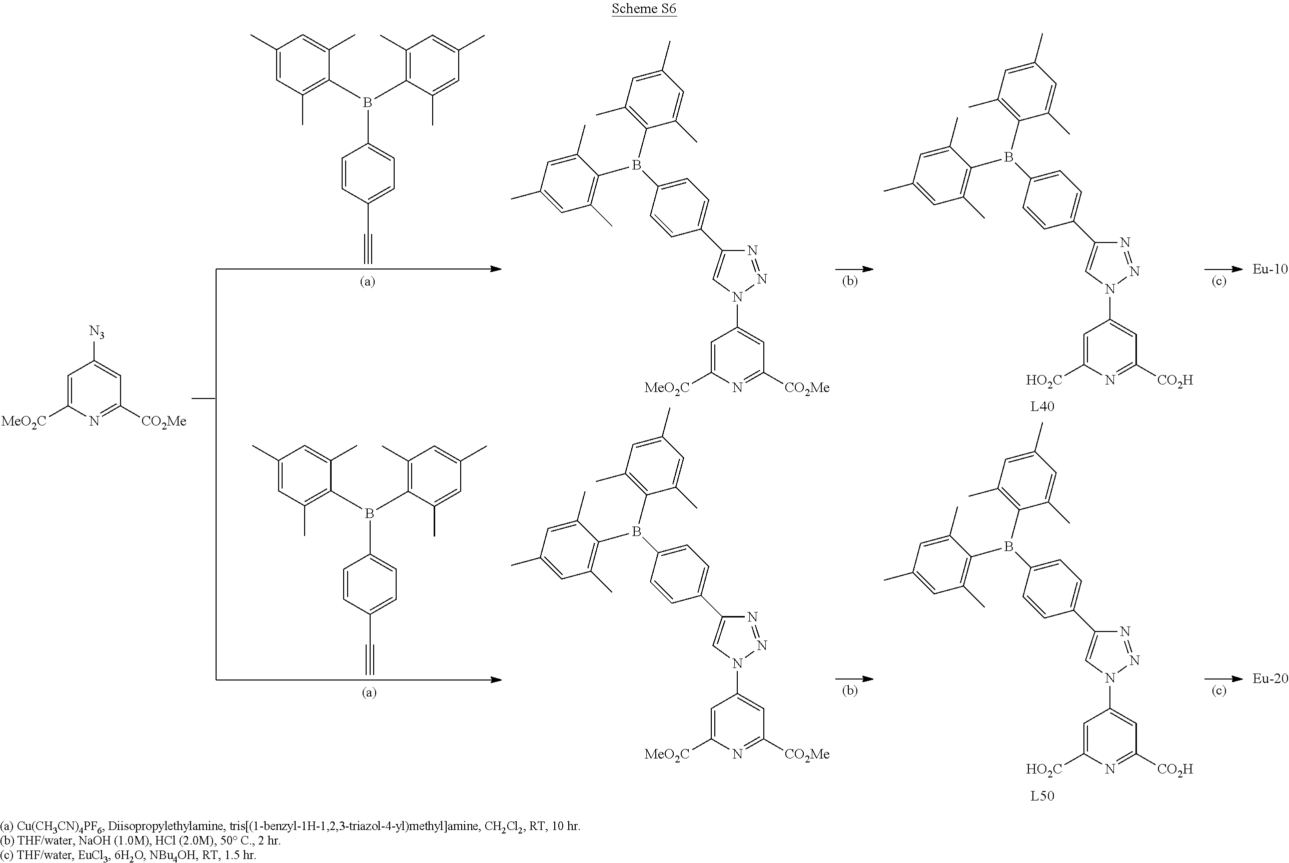

### Step 1 for Ligand L40: Synthesis of an Intermediate that Precedes L40 in Scheme S6

4-azidopyridine-2,6-dicarboxylate (202 mg, 0.86 mmol, 1.0 eq.) was dissolved in 15 mL of CH₂Cl₂ and (4-ethynylphenyl)dimesitylborane (330 mg, 0.94 mmol, 1.1 eq.) was added. Diisopropylethylamine (0.3 mL, 2.0 eq.), tris[(1-benzyl-1H-1,2,3-triazol-4-yl)methyl]amine (5 mg, 0.009 mmol, 0.01 eq.), and Cu(CH₃CN)₄PF₆ (3.2 mg, 0.009 mmol, 0.01 eq.) were added, sequentially. After stirring for 10 hr at room temperature (RT), the reaction mixture was washed with NH₄Cl (aq) and dried with MgSO₄. The product was purified by column chromatography using ethyl acetate as eluent. Yield: 353 mg (70%). ¹H NMR (500 MHz, CDCl₃, ppm): δ=8.81 (s, 2H), 8.56 (s, 1H), 7.93 (d, 8.0 Hz, 2H), 7.65 (d, 8.5 Hz, 2H), 6.86 (s, 4H), 4.09 (s, 6H), 2.34 (s, 6H), 2.05 (s, 12H). ¹³C NMR (125 MHz, CDCl₃, ppm): δ=164.19, 150.52, 149.47, 146.83, 145.20, 141.55, 140.86, 138.91, 137.04, 132.06, 128.28, 125.52, 117.46, 117.43, 53.65, 23.48, 21.25. HRMS calcd: C₃₅H₃₅N₄O₄B₁ 586.2751. found 586.2771.

### Step 1 for Ligand L50: Synthesis of the Intermediate that Precedes L50 in Scheme S6

The same procedure was used to synthesize compound 20. Reaction condition: 4-azidopyridine-2,6-dicarboxylate (182 mg, 0.77 mmol, 1.0 eq.), (4-ethynyl-2,3,5,6-tetramethylphenyl)dimesitylborane (345 mg, 0.85 mmol, 1.1 eq.), diisopropylethylamine (0.27 mL, 2.0 eq.), tris[(1-benzyl-1H-1,2,3-triazol-4-yl)methyl]amine (4 mg, 0.008 mmol, 0.01 eq.), and Cu(CH₃CN)₄PF₆ (3 mg, 0.008 mmol, 0.01 eq.). Yield: 272 mg (55%). ¹H NMR (500 MHz, CDCl₃, ppm): δ=8.84 (s, 2H), 8.24 (s, 1H), 6.76 (s, 4H), 4.07 (s, 6H), 2.27 (s, 6H), 2.05 (s, 6H), 2.02 (s, 6H), 1.99 (s, 6H), 1.95 (s, 6H). ¹³C NMR (125 MHz, CDCl₃, ppm): δ=164.20, 150.47, 149.81, 149.53, 145.43, 144.34, 140.91, 140.73, 139.41, 135.54, 133.15, 129.30, 128.87, 128.79, 120.26, 117.41, 53.56, 23.22, 22.89, 21.23, 20.24, 17.61. HRMS calcd: C₃₉H₄₃N₄O₄B₁ 642.3377. found 642.3405.

### Step 2 for Ligand L40: Synthesis of L40

To 10 mL of mixed solvent (THF/water, 1:2) was added the products of Step 1 of this Example (271 mg, 0.46 mmol, 1.0 eq.) and 2.7 mL (6.0 eq.) of aqueous NaOH (1.0M). Then, the reaction mixture was stirred at 50° C. for 2 hr. After cooling to room temperature, HCl (2.0M) was added dropwise until pH 5. A white precipitate was filtered and dried under vacuum. Yield: 257 mg (˜100%). ¹H NMR (300 MHz, DMSO, ppm): δ=9.88 (s, 1H), 8.67 (s, 2H), 8.05 (d, 8.1 Hz, 2H), 7.51 (d, 7.8 Hz, 2H), 6.86 (s, 4H), 2.28 (s, 6H), 1.97 (s, 12H). HRMS calcd: C₃₃H₃₀N₄O₄B₁ 557.2360 (M-H⁺). found 557.2371.

### Step 2 for Ligand L50: Synthesis of L50

The same procedure as described in Step 2 for Ligand L40 of this Example was used to synthesize L50. Reaction conditions: the product of step 2 of this Example (184 mg, 0.29 mmol, 1.0 eq.) and aqueous NaOH (1.0M) (1.7 mL, 6.0 eq.). Yield: 151 mg (85%). ¹H NMR (400 MHz, DMSO, ppm): δ=9.27 (s, 1H), 8.68 (s, 2H), 6.79 (s, 4H), 2.24 (s, 6H), 2.00 (s, 12H), 1.93 (s, 6H), 1.91 (s, 6H). HRMS calcd: C₃₇H₃₈N₄O₄B₁ 613.2986 (M-H⁺). found 613.2997.

### Example 1K

### Synthesis of BacBac (L60): L60 was Prepared According to Scheme S7

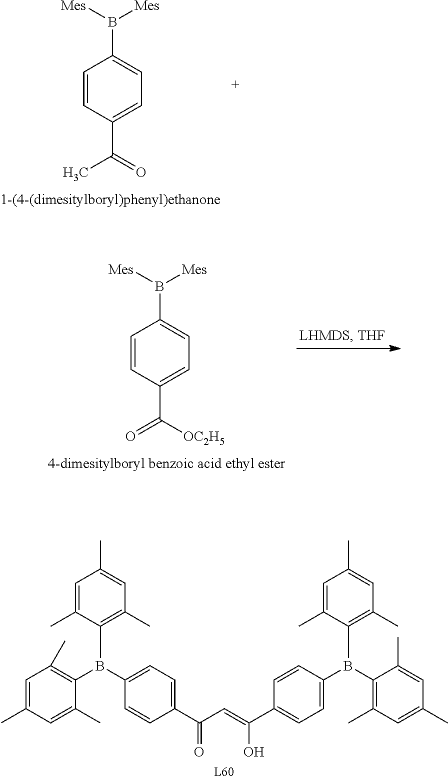

### Step 1 for Ligand L60: Preparation of 1-(4-(dimesitylboryl)phenyl)ethanone

See synthesis described at step 1 of Example 1F.

### Step 2 for Ligand L60: Preparation of 4-dimesitylboryl benzoic acid

1.00 g of 1-bromo-4-dimesitylborylphenyl (Jia, Wen-Li, et al., Chemistry—A European Journal, (2004) 10(4): 994-1006)(2.47 mmol, 1 eq.), under N₂, was dissolved in 30 mL anhydrous THF. It was then cooled to −78° C. and 1.6M n-BuLi (1.7 mL, 2.71 mmol, 1.1 eq) was added dropwise. The mixture was allowed to stir for one hour. After the hour was up, a CO₂ filled balloon was vented into the mixture and the mixture was allowed to warm slowly to RT overnight. In the morning, the reaction was quenched with 2M HCl and the product was separated into diethyl ether. The ether was washed with distilled water, dried with brine, MgSO₄, filtered, and the solvent was removed under reduced pressure. The solid was washed with hexanes and filtered to recover 0.65 g white solid (70% yield). ¹H NMR (300 MHz, 298 K, CDCl₃): δ 8.10 (d, J=7.4 Hz, 2H), 7.62 (d, J=7.4 Hz, 2H), 6.86 (s, 4H), 2.33 (s, 6H), 2.01 (s, 12H).

### Step 3 for Ligand L60: Preparation of 4-dimesitylboryl benzoic acid ethyl ester

310 mg of 4-dimesitylboryl benzoic acid (0.8 mmol, 1 eq) was dissolved in 75 mL absolute ethanol (1.28 mol, excess) and heated to reflux. Three drops of concentrated H₂SO₄ (cat.) was added and the mixture was refluxed overnight. The mixture was extracted into diethyl ether and washed twice with water. The hydrophobic extracts were dried with brine and MgSO₄, filtered and the diethyl ether was removed under reduced pressure. The resulting oil was purified by column chromatography (DCM) to yield 310 mg of 7 (93%). ¹H NMR (300 MHz, 298 K, CDCl₃): δ 8.05 (d, J=7.9 Hz, 2H), 7.62 (d, J=7.9 Hz, 2H), 6.86 (s, 4H), 4.41 (q, J=7.0 Hz, 2H) 2.33 (s, 6H), 2.03 (s, 12H) 1.41 (t, J=7.0 Hz 3H).

### Step 4 for Ligand L60: Preparation of Bacbac (L60)

310 mg of 4-dimesitylboryl benzoic acid ethyl ester (0.75 mmol, 1 eq), 265 mg of 1-(4-(dimesitylboryl)phenyl)ethanone (0.75 mmol, 1 eq), and 264 mg lithium hexamethyl disiliazide (LHMDS, 1.58 mmol, 2.1 eq) were added together into a dry Schlenk flask. The three solids were dissolved in 10 mL of distilled THF and stirred under N₂ for one hour. The mixture was then refluxed for three hours and allowed to stir at room temperature for 40 hours. The reaction mixture was quenched with NH₄Cl, extracted with diethyl ether and washed with water, and then dried over MgSO₄. The resultant slurry was filtered and diethyl ether was removed in vacuo. The crude product was purified by column chromatography (DCM), affording L60 (251 mg, 47% yield). ¹H NMR (300 MHz, 298 K, CDCl₃): δ 16.90 (s, 1H), 7.99 (d, J=8.1 Hz, 4H), 7.67 (d, J=8.1 Hz, 4H), 6.97 (s, 1H) 6.89 (s, 8H), 2.36 (s, 12H), 2.05 (s, 24H).

### Example 1L

### Synthesis of meso-p-BMes₂-phenyl-acetylacetone (L70)

Compound L70 was prepared according to the procedure shown in Scheme S8.

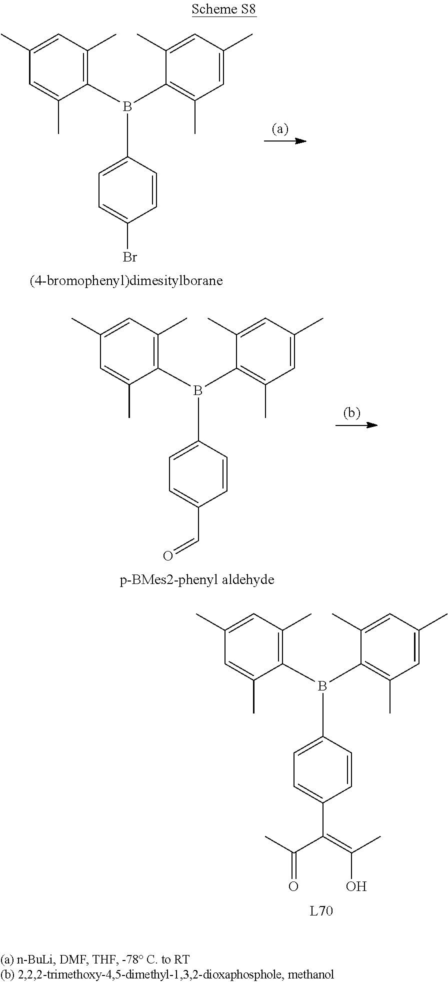

### Step 1. Synthesis of p-BMes₂-phenyl aldehyde

(4-bromophenyl)dimesitylborane (2.19 g, 5.4 mmol, 1.0 eq) was dissolved in 80 mL of THF and the mixture was cooled to −78° C. To the mixture was added n-BuLi (1.6 M, 3.4 mL, 5.4 mmol, 1.0 eq) under N₂ atmosphere at −78° C. After stirring for 1 hr, dried DMF (0.84 mL, 10.8 mmol, 2.0 eq) was added to the mixture. After cooling to room temperature, the mixture was stirred for 6 hr. After that, HCl (2.0 N, 7.5 mL) was added dropwise, and the mixture was stirred for 5 hr. After the addition of water, the mixture was extracted with diethyl ether. Hydrophobic extracts were dried over MgSO₄. The product was purified by column chromatography using petroleum ether/ethyl acetate (9:1) as eluent. Yield: 0.77 g (40%). ¹H NMR (300 MHz, CDCl₃, ppm): δ=10.10 (s, 1H), 7.87 (d, 7.8 Hz, 2H), 7.68 (d, 7.5 Hz, 2H), 6.87 (s, 4H), 2.35 (s, 6H), 2.01 (s, 12H). ¹³C NMR (75 MHz, CDCl₃, ppm): δ=192.70, 152.80, 141.42, 140.85, 139.43, 138.01, 135.96, 129.04, 128.41, 23.44, 21.26. HRMS, calcd for C₂₅H₂₇B₁O₁: 354.2155. found: 354.2147.

### Step 2. Synthesis of meso-p-BMes₂-phenyl-acetylacetone (L70)

A mixture of p-BMes₂-phenyl aldehyde (0.77 g, 2.2 mmol, 1.0 eq) and 2,2,2-trimethoxy-4,5-dimethyl-1,3,2-dioxaphosphole (2.27 g, 13.2 mmol, 6.0 eq.) (available from Alfa Aesar Chemical Co.) was stirred for 13 hrs at room temperature. Then, 4.0 mL of dried methanol was added and the resultant mixture was stirred for 5 hrs. The white precipitate was filtered and washed with methanol. Yield: 0.58 g (62%). ¹H NMR (300 MHz, CDCl₃, ppm): δ=16.68 (s, 1H), 7.55 (d, 7.8 Hz, 2H), 7.18 (d, 8.1 Hz, 2H), 6.86 (s, 4H), 2.34 (s, 6H), 2.04 (s, 12H), 1.93 (s, 6H). ¹³C NMR (75 MHz, CDCl₃, ppm): δ=190.65, 145.30, 141.66, 140.77, 140.54, 138.83, 136.58, 130.74, 128.26, 115.22, 24.12, 23.38, 21.24. HRMS, calcd for C₂₉H₃₃B₁O₂: 424.2574. found: 424.2588.

### Example 1M

### Synthesis of 4-dimesitylboryl benzoic acid (L80)

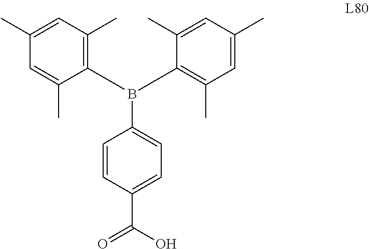

1.00 g of 1-bromo-4-dimesitylborylphenyl (2.47 mmol, 1 eq.), under N₂, was dissolved in 30 mL anhydrous THF. It was then cooled to −78° C. and 1.6M n-BuLi (1.7 mL, 2.71 mmol, 1.1 eq) was added dropwise. The mixture was allowed to stir for one hour. After the hour was up, a CO₂ filled balloon was vented into the mixture and the mixture was allowed to warm slowly to RT overnight. In the morning, the reaction was quenched with 2M HCl and the product was separated into diethyl ether. The ether was washed with distilled water, dried with brine, MgSO₄, filtered, and the solvent was removed under reduced pressure. The solid was washed with hexanes and filtered to produce 0.65 g of the product as a white solid (70% yield). ¹H NMR (300 MHz, 298 K, CDCl₃): δ 8.10 (d, J=7.4 Hz, 2H), 7.62 (d, J=7.4 Hz, 2H), 6.86 (s, 4H), 2.33 (s, 6H), 2.01 (s, 12H).

### Example 2

### Synthesis of Complexes

See FIG. 4 for a schematic regarding synthetic pathway for 1Tb, 1Eu, 2Tb and 2Eu. See Figures for UV-vis and emission spectra of specified complexes.

### Example 2A

### Synthesis of 1Tb

Scheme S2 below provides a summary of this synthetic procedure. To a solution of potassium 4-(dimesitylboryl)-2,3,5,6-tetramethylbenzoate (45 mg, 0.096 mmol) in 10 mL of THF, a mixture of Tb(NO3)₃.6H₂O (14 mg, 0.033 mmol) in 5 mL THF was added dropwise and left to stir at 298 K for 1 h. The product was rinsed with MeOH 4 times and was collected as a white solid in 78% yield. IR (cm⁻¹): _{asy}(CO₂⁻¹)1543, _{sy}(CO₂⁻)1419; LRMS-MALDI, M⁺ m/z (amu)=1435.12. Anal Calcd for C₈₇H₁₀₂B₃O₆Tb.2MeOH: C, 71.35; H, 7.33. Found: C, 71.24; H, 7.28. Anal Calcd for C₈₇H₁₀₂B₃O₆Tb (vacuum-pumped at 353 K): C, 72.81; H, 7.16. Found: C, 72.75; H, 7.11.

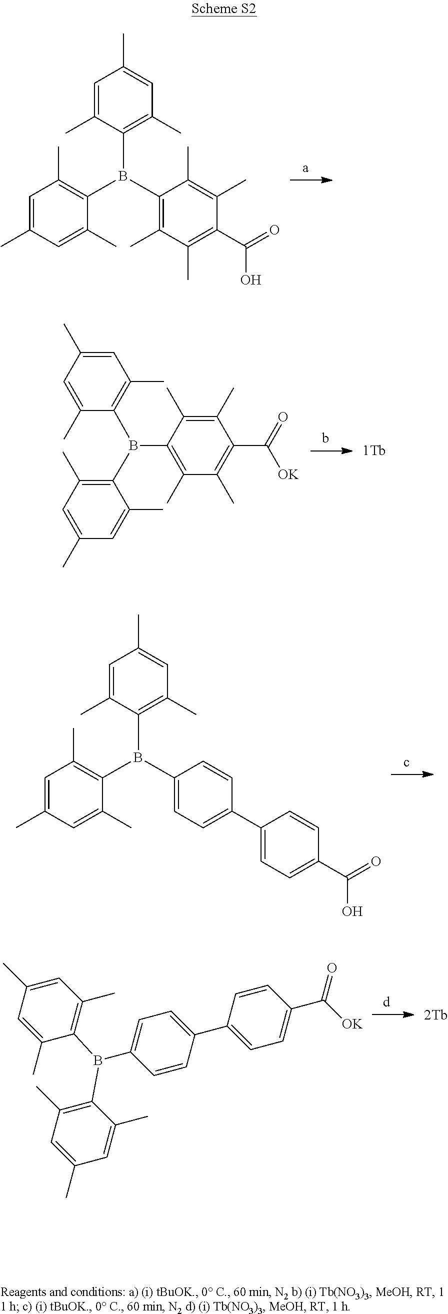

### Example 2B

### Synthesis of 2Tb

Scheme S2 above provides a summary of this synthetic procedure. This compound was prepared as a white solid using the same procedure as described for 1Tb except by using potassium 4′-(dimesitylboryl)biphenyl-4-carboxyllate (28 mg, 0.058 mmol) and Tb(NO3)₃.6H₂O (8.3 mg, 0.019 mmol). The product was rinsed with MeOH 4 times and was collected in 60% yield. IR (cm⁻¹): _{asy}(CO₂⁻) 1549, _{sy}(CO₂⁻) 1420; Anal Calcd for C₆₄H₆₆B₂O₄Tb.(MeO)(MeOH): C, 69.08; H, 6.07. Found: C, 68.15; H, 5.74.

### Example 2C

### Synthesis of 1Eu

Scheme S3 below provides a summary of this synthetic procedure. Potassium 4-(dimesitylboryl)-2,3,5,6-tetramethylbenzoate (45 mg, 0.096 mmol) was dissolved in 10 mL of THF and a solution of Eu(NO3)₃.6H₂O (14 mg, 0.033 mmol) in 5 mL THF was added dropwise and left to stir at 298 K for 1 h. The product was rinsed with MeOH 4 times and was collected as a white solid in 89% yield. IR (cm⁻¹): _{asy}(CO₂⁻) 1541, _{sy}(CO₂⁻) 1420; LRMS-MALDI, M⁺ m/z (amu)=1478.03. Anal Calcd for C₈₇H₁₀₂B₃O₆Eu.MeOH.2H₂O: C, 70.69; H, 7.35. Found: C, 69.24; H, 7.02.

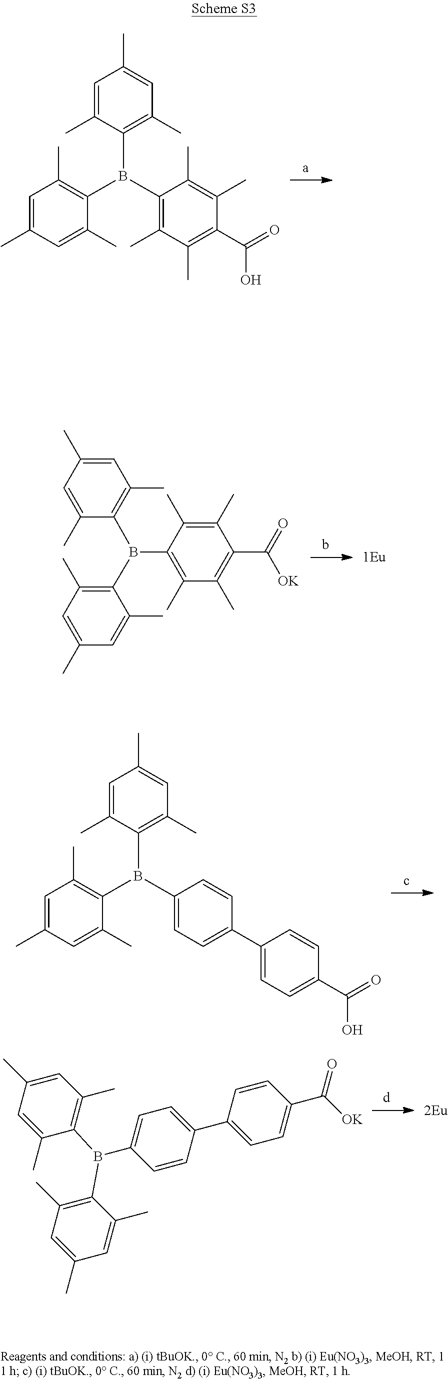

### Example 2D

### Synthesis of 2Eu

Scheme S3 above provides a summary of this synthetic procedure. This compound was prepared as a white solid using the same procedure as described for 1Eu except by using potassium 4′-(dimesitylboryl)biphenyl-4-carboxyllate (50 mg, 0.103 mmol) and Eu(NO₃)₃.6H₂O (15.3 mg, 0.034 mmol). The product was rinsed with MeOH 4 times and was collected in 84% yield. IR (cm⁻¹): _{asy}(CO₂⁻)1550, _{sy}(CO₂⁻)1420; LRMS-MALDI, M⁺ m/z (amu)=1078.98. Anal Calcd for C₆₄H₆₆B₂O₄Eu.(MeO)(MeOH): C, 69.51; H, 6.11. Found: C, 70.02; H, 5.99.

### Example 2E

### Synthesis of 3Tb

Tris(2′,3′,5′,6′-tetramethylbiphenyl-4-carboxylic acid)borane (3) (10 mg, 0.014 mmol) was dissolved in DMF (3 ml). Tb(NO₃)₃.6H₂O (1 equivalent) was separately dissolved DMF (3 ml). Each solution was filtered to remove any particulate and the solutions combined, loaded into a 20 mL sample vial and heated at 95° C. for 1 day. White powder precipitated from the bulk solution. The reaction mixture was transferred to a centrifuge tube and centrifuged for 5 min. The bulk solution was poured off, CH₂Cl₂ (5 mL) added and this centrifugal procedure was repeated with dichloromethane three times to ‘extract’ included DMF. Once the dichloromethane was poured off for the third time, the reaction vessel was placed under high vacuum to remove any included CH₂Cl₂. The white powder was then collected. 62% yield by mass.

### Example 2F

### Synthesis of 4Tb

Tris(2,3,5,6-tetramethyl-4-benzoic acid)borane (9 mg, 0.014 mmol) was dissolved in DMF (3 ml). Tb(NO₃)₃.6H₂O (1 equivalent) was separately dissolved DMF (3 ml). Each solution was filtered to remove any particulate and the solutions combined, loaded into a 20 mL sample vial and heated at 95° C. for 1 day. White powder precipitated from the bulk solution. The reaction mixture was transferred to a centrifuge tube and centrifuged for 5 min. The bulk solution was poured off, CH₂Cl₂ (5 mL) added and this centrifugal procedure was repeated three times to ‘extract’ included DMF. Once the dichloromethane was poured off for the third time, the reaction vessel was placed under high vacuum to remove any included CH₂Cl₂. The white powder was then collected. 71% yield by mass.

### Example 2G

### Synthesis of 5Eu

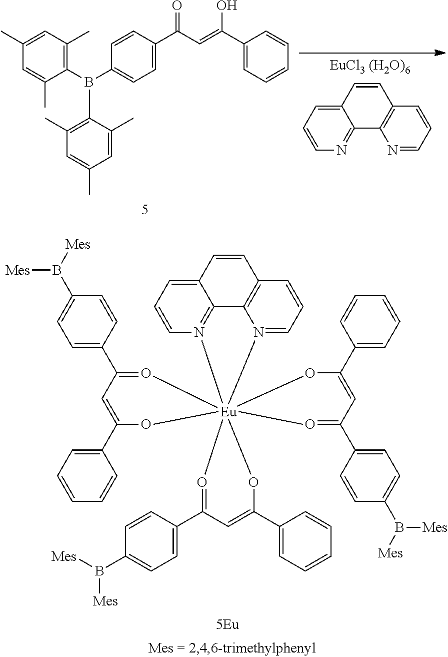

In a 20 mL sample vial, 5 (36 mg, 0.075 mmol, 3 eq.) and 1,10-Phenanthroline (4.4 mg, 0.025 mmol, 1 eq.) were suspended in EtOH (2 mL) and heated gently until the solids dissolved. NaOH (from a IM stock solution in H₂O, 3 eq.) was added, at which point the suspension dissolved and turned bright yellow. Europium(III)-chloride.6H₂O (9 mg, 0.025 mmol) was dissolved in EtOH, (1 mL) and this solution was added dropwise to the solution containing 5 and allowed to stir at room temperature for 10 minutes. A pale yellow precipitate forms very quickly. The reaction is then warmed to 60° C. and heated for 3 hours. The reaction is then cooled to 0° C. and stirred for 10 min, followed by a vacuum filtration to isolate the yellow solid. The solid is then rinsed with distilled water, and then ethanol. Yellow solid was dissolved in CH₂Cl₂, and precipitated from cold ethanol and filtered to isolate a yellow powder in 62% yield (27 mg, 0.015 mmol). Anal. Calcd for C₁₁₁H₁₀₄B₃EuN₂O₆: C, 76.34; H, 6.00; N, 1.60. Found: C, 75.11; H, 5.84; N, 1.41.

### Example 2H

### Synthesis of 6Eu

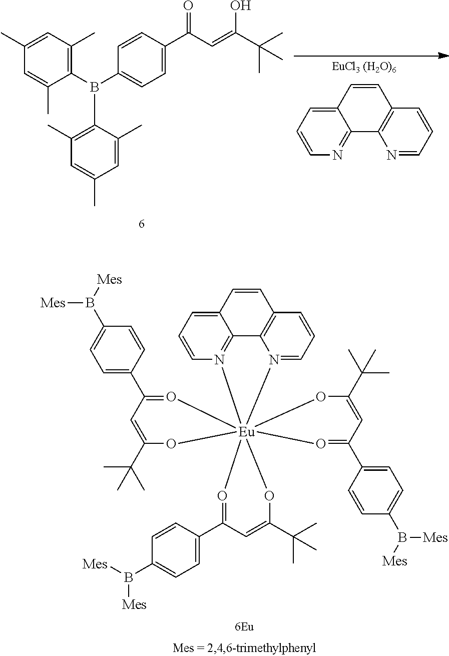

In a 20 mL sample vial, 6 (100 mg, 0.22 mmol, 3 eq.) and 1,10-Phenanthroline (13.3 mg, 0.073 mmol, 1 eq.) were suspended in EtOH (3 mL) and heated gently until the solids dissolved. NaOH (from a 1M stock solution in H₂O, 3 eq.) was added, at which point the suspension dissolved and turned bright yellow. Europium(III)-chloride.6H₂O (27 mg, 0.073 mmol) was dissolved in EtOH, (2 mL) and this solution was added dropwise to the solution containing 6 and allowed to stir at room temperature for 10 minutes. A pale yellow precipitate forms very quickly. The reaction is then warmed to 60° C. and heated for 3 hours. The reaction is then cooled to 0° C. and stirred for 10 min, followed by a vacuum filtration to isolate the yellow solid. The solid is then rinsed with distilled water, and then ethanol. Yellow solid was dissolved in CH₂Cl₂, and precipitated from cold ethanol and filtered to isolate a yellow powder in 71% yield (88 mg, 0.052 mmol).

### Example 2I

### Synthesis of [NBu₄]₃Tb(L20)₃

This compound is synthesized in the same manner as that used for Eu-10 and Eu-20 of Example 2K with the exceptions that the ligand used was L20 and EuCl₃.6H₂O was replaced by TbCl₃.6H₂O. [NBu₄]₃Tb(L20)₃ is a bright green emitter with λₑₘ=547 nm and Φ=˜0.50 in the solid state. [NBu₄]₃Eu(L20)₃ may be prepared in the same manner. The analogous Eu compound was prepared and was found to be non-emissive.

### Example 2J

### Synthesis of Tb(L30)₃(H₂O)ₓ

To a 20 mL vial, 100 mg (0.21 mmol) of molecule L30 was added. To the same vial, 81 mg (0.21 mmol) of trioctylphosphine oxide (“TOPO”) was added and both solids were suspended in 7 mL absolute ethanol and stirred rapidly. While gently heating, 0.21 mL of 1M NaOH was added dropwise. The solution became clear and yellow-tinted. To another vial, 30 mg of Tb(NO₃)₃.5H₂O (0.069 mmo) was added and dissolved in 5 mL of absolute ethanol. Once dissolved, it was added dropwise to the basic ligand solution and a white precipitate formed immediately. The mixture was stirred rapidly while heating for three hours. The solid was collected via centrifugation and washed three times with a 4:1 mixture of absolute ethanol and water and Tb(L30)₃ was isolated in 20% yield. This compound was soluble in tetrahyrdofuran and chloroform. A structural formulae of Tb(L30)₃(H₂O)ₓ is shown in FIG. 2C. Elemental analysis for Tb(L30)₃(H₂O)₈ (C₉₃H₁₀₆B₃O₁₄Tb): Calc. C, 67.40; H, 7.54. found: C, 67.04; H, 7.51. This compound displays a bright green emission with λₑₘ=545 nm and Φ=47% as a neat film. The emission spectra of Tb(L30)₃(H₂O)ₓ is shown in FIG. 8D.

### Example 2K

### Syntheses of Eu-10 and Eu-20

The two Eu(III) compounds that contain BMes₂-functionalized dpa ligands are prepared according to the procedures shown in Scheme S6 of Example 1J. Structural formulae for En-10 and Eu-20 are shown in FIG. 2B. Photophysical properties for En-10 and Eu-20 are provided in Table 4.

Synthesis of Eu-10: To a suspension of L40 (115 mg, 0.21 mmol, 3.0 eq.) in 20 mL of water was added tetrabutylammonium hydroxide (NBu₄OH, 1.0M in methanol) (0.42 mL, 6.0 eq.). After stirring for 5 min, EuCl₃.6H₂O (26 mg, 0.07 mmol, 1.0 eq.) was added and stirred for 1.5 hr at room temperature. The reaction mixture was extracted several times with CH₂Cl₂, washed with water, and dried with MgSO₄. Yield: 89 mg (50%). HRMS calcd: C₁₁₅H₁₂₃N₁₃O₁₂B₃Eu₁ 2063.8906 (M-2NBu₄⁺). found 2063.8936.

Synthesis of Eu-20: The same procedure was used to synthesize Eu-20 as that described for Eu-10. Reaction condition: L50 (185 mg, 0.3 mmol, 3.0 eq.), EuCl₃.6H₂O (37 mg, 0.1 mmol, 1.0 eq.), and tetrabutylammonium hydroxide (NBu₄OH, 1.0M in methanol) (0.6 mL, 6.0 eq.). Yield: 52 mg (52%). HRMS calcd: C₁₄₃H₁₈₃N₁₄O₁₂B₃Eu₁ 2474.3632 (M-NBu₄⁺). found 2474.3671.

### Example 2L

### Synthesis of Eu(III) and Tb(III) complexes of L60

Eu(III) and Tb(III) complexes of L60 were prepared in the same manner as that described herein for Tb(L30)₃. They were found to lack luminescence.

### Example 2M

### Synthesis of Tb(L70)₃(H₂O)ₓ

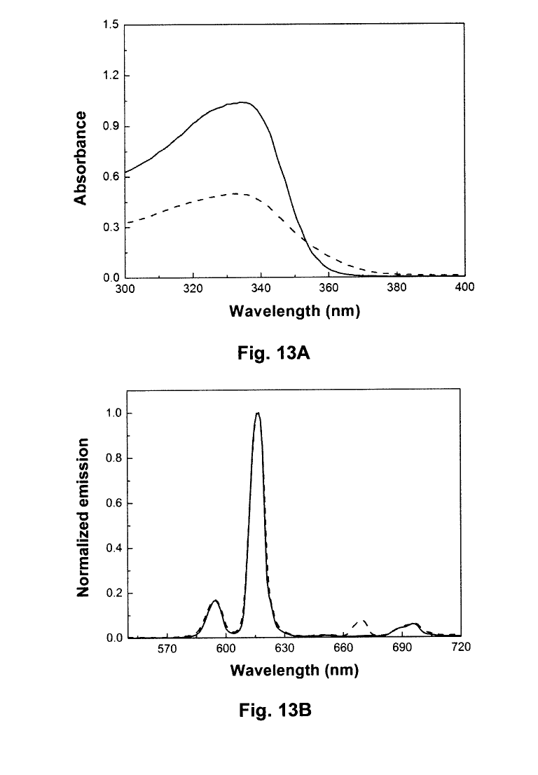

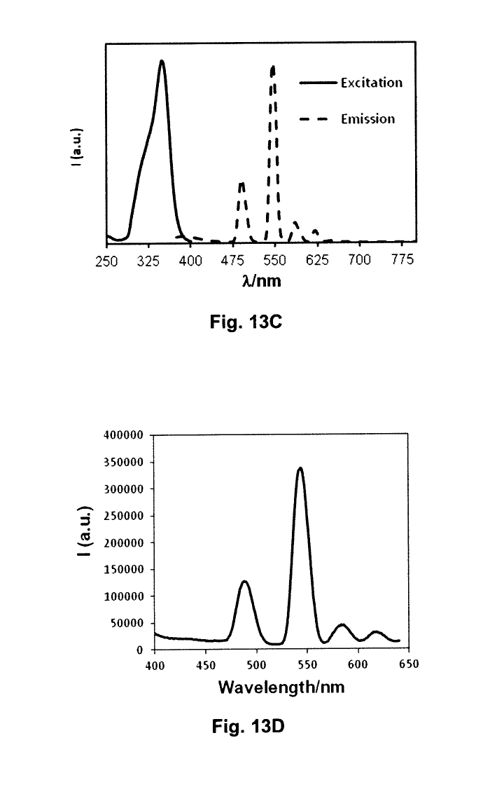

Into a 20 mL vial, 50 mg of L70 (0.118 mmol, 3 eq) was weighed. To this, 51 mg trioctyl phosphine oxide (0.129 mg, 3.3 eq) was added. The solids were suspended in 2.5 mL absolute ethanol. While rapidly stirring, 0.12 mL 1M NaOH (0.118 mmol, 3 eq) in absolute ethanol was added dropwise. The solid dissolved to yield a yellow liquid. In another vial, 17 mg Tb(NO₃)₃.5H₂O (0.039 mmol, 1 eq) was weighed, dissolved in 2 mL ethanol and added dropwise to the ligand containing vial, effecting a white precipitate. The reaction was warmed while stirring for 20 minutes and then stirred overnight. The reaction mixture was centrifuged and the precipitate was washed with 4:1 ethanol:H₂O, followed by centrifugation. 20 mg of the product was isolated (20% yield). Tb(L70)₃(H₂O), emits a green color with moderate intensity in the solid state (λₑₘ=545 nm and Φ=31%). The structural formulae of Tb(L70)₃(Lₙₒₙ₋ₑₘᵢₛₛᵢᵥₑ)ₓ appears in FIG. 2C. The emission spectrum of Tb(L70)₃(H₂O)ₓ as neat film is shown in FIG. 13C.

### Example 2N

### Synthesis of Eu(L70)₃(H₂O)ₓ

Into a 20 mL vial, 50 mg of L70 (0.118 mmol, 3 eq) was weighed. To this, 50 mg trioctyl phosphine oxide (0.129 mg, 3.3 eq) was added. The solids were suspended in 2.5 mL absolute ethanol. While rapidly stirring, 0.12 mL 1M NaOH (0.118 mmol, 3 eq) in absolute ethanol was added dropwise. The solid dissolved to yield a yellow liquid. In another vial, 17.4 mg Eu(NO₃)₃.6H₂O (0.039 mmol, 1 eq) was weighed, dissolved in 2 mL ethanol and added dropwise to the ligand containing vial, effecting a white precipitate. The reaction was warmed while stirring for 20 minutes and then stirred overnight. The reaction mixture was centrifuged and the precipitate was washed with 4:1 ethanol:H₂O, followed by centrifuge. 51 mg of product was isolated (50% yield). Eu(L70)₃(H₂O)ₓ is a weak red emitter with a very low quantum efficiency (<1%) in solution and the solid state.

### Example 2M

### Synthesis of a Lanthanide Complex of L80

Lanthanide complexes of L80 are made in the same manner as 1Tb or 2Tb.

It will be understood by those skilled in the art that this description is made with reference to certain preferred embodiments and that it is possible to make other embodiments employing the principles of the invention which fall within its spirit and scope as defined by the claims.

TABLE 1
Spectroscopic Data for Ligands and Complexes

| | | λₑₓ, | λₑₘ^{a}, | τ, | | |
|---|---|---|---|---|---|---|
| | | nm | nm | ms | | |
| | | THF, | THF, | THF, | | Φₛₛ^{c}, |
| Com- | UV-Vis, nm | 298 | 298 | 77 | Φ^{b}ₛₒₗ, | total em/ |
| pound | (ε, M⁻¹ cm⁻¹) | K | K | K | CH₂Cl₂ | Ln em |
| 1 | 330 (15,997) | | 384 | | 5 | — |
| 2 | 328 (25,031) | | 406 | | 14 | — |
| 1Tb | 331 (43,011) | 330 | 384, 489, | 1.22 | — | 0.70/0.56 |
| | | | 545, 585, | | | |
| | | | 615 | | | |
| 2Tb | 328 (60,086) | 335 | 406 | | — | 0.41/0.03 |
| 1Eu | 331 (46,512) | 345 | 384, 579, | 0.63 | — | 0.14/0.04 |
| | | | 590, 617 | | | |
| 2Eu | 328 (65,813) | 350 | 406, 579, | 0.54 | — | 0.48/0.10 |
| | | | 590, 617 | | | |

^{a}In THF at 1 × 10⁻⁵ M.
^{b} Relative to 9,10-diphenylanthracene = 0.95 in CH₂Cl₂.
^{c}Measured in the solid state in 10 wt % doped PMMA polymer films using an integration sphere.

TABLE 2
IR spectroscopic data for ligands and Ln complexes. Stretching
frequencies of C═O and CO₂⁻ vibrations in cm⁻¹.

| | | | Δ(υₛ (COO⁻)- |
|---|---|---|---|
| Compounds | υₛ (COO⁻) | υₐₛ (COO⁻) | υₐₛ (COO⁻)) |
| Tb(Bz)₃ | 1424 s | 1541 s | 117 |
| Eu(Bz)₃ | 1415 s | 1532 s | 117 |
| 1 | 1416 s | 1696 s | 280 |
| 2 | 1423 s | 1694 s | 271 |
| 1Tb | 1419 s | 1543 s | 124 |
| 2Tb | 1420 s | 1549 s | 129 |
| 1Eu | 1420 s | 1541 s | 121 |
| 2Eu | 1420 s | 1550 s | 130 |

TABLE 3
Examples of Ligands Suitable for Binding Rare Earth Metal Ions and Enhancing
Luminescence Thereof

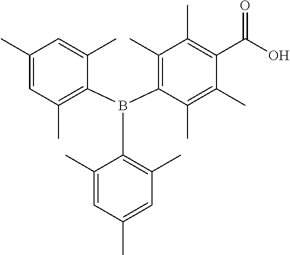 [SMILES: Cc1cc(C)c(B(c2c(C)cc(C)cc2C)c2c(C)c(C)c(C(=O)O)c(C)c2C)c(C)c1]

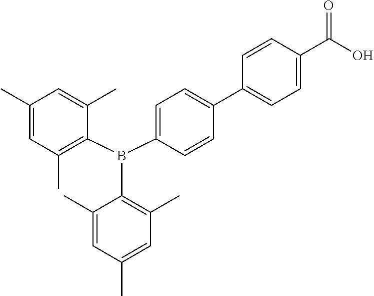 [SMILES: Cc1cc(C)c(B(c2ccc(-c3ccc(C(=O)O)cc3)cc2)c2c(C)cc(C)cc2C)c(C)c1]

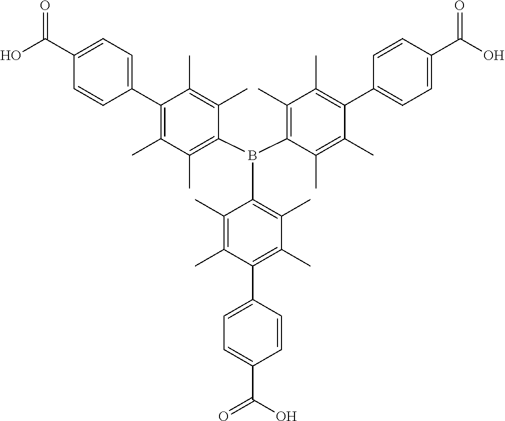 [SMILES: Cc1c(C)c(-c2ccc(C(=O)O)cc2)c(C)c(C)c1B(c1c(C)c(C)c(-c2ccc(C(=O)O)cc2)c(C)c1C)c1c(C)c(C)c(-c2ccc(C(=O)O)cc2)c(C)c1C]

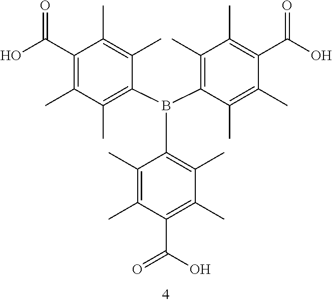 [SMILES: Cc1c(C)c(C(=O)O)c(C)c(C)c1B(c1c(C)c(C)c(C(=O)O)c(C)c1C)c1c(C)c(C)c(C(=O)O)c(C)c1C]

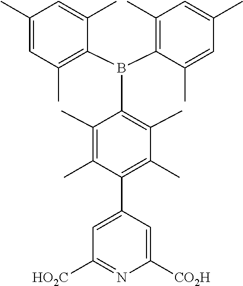

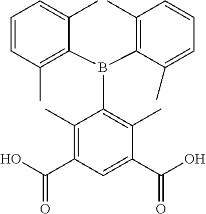 [SMILES: Cc1cccc(C)c1B(c1c(C)cccc1C)c1c(C)c(C(=O)O)cc(C(=O)O)c1C]

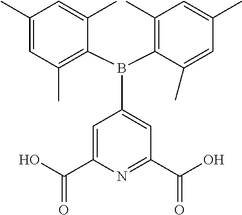

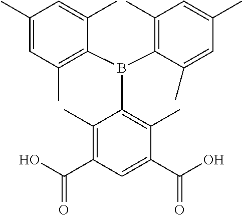

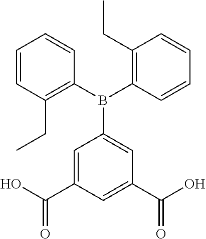 [SMILES: CCc1ccccc1B(c1cc(C(=O)O)cc(C(=O)O)c1)c1ccccc1CC]

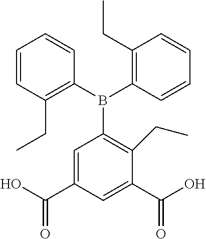 [SMILES: CCc1ccccc1B(c1ccccc1CC)c1cc(C(=O)O)cc(C(=O)O)c1CC]

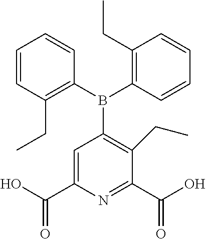 [SMILES: CCc1ccccc1B(c1ccccc1CC)c1cc(C(=O)O)nc(C(=O)O)c1CC]

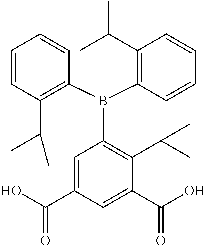 [SMILES: CC(C)c1ccccc1B(c1ccccc1C(C)C)c1cc(C(=O)O)cc(C(=O)O)c1C(C)C]

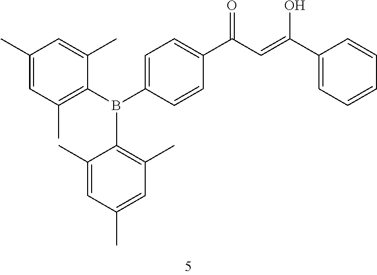 [SMILES: Cc1cc(C)c(B(c2ccc(C(=O)/C=C(\O)c3ccccc3)cc2)c2c(C)cc(C)cc2C)c(C)c1]

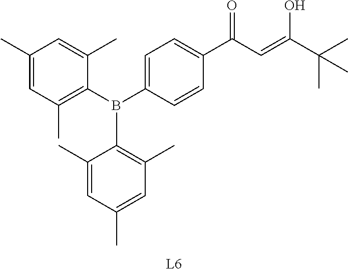 [SMILES: Cc1cc(C)c(B(c2ccc(C(=O)/C=C(\O)C(C)(C)C)cc2)c2c(C)cc(C)cc2C)c(C)c1]

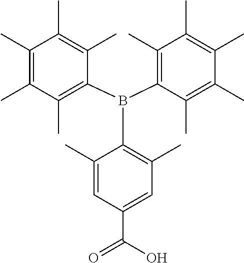

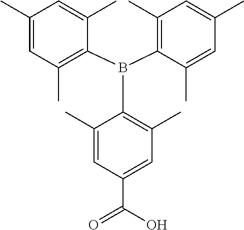

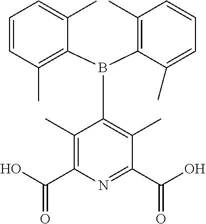 [SMILES: Cc1cccc(C)c1B(c1c(C)cccc1C)c1c(C)c(C(=O)O)nc(C(=O)O)c1C]

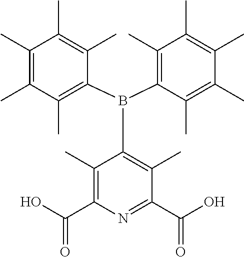

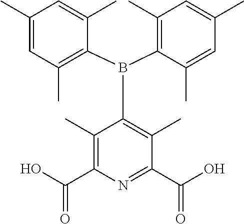

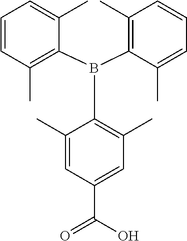 [SMILES: Cc1cccc(C)c1B(c1c(C)cccc1C)c1c(C)cc(C(=O)O)cc1C]

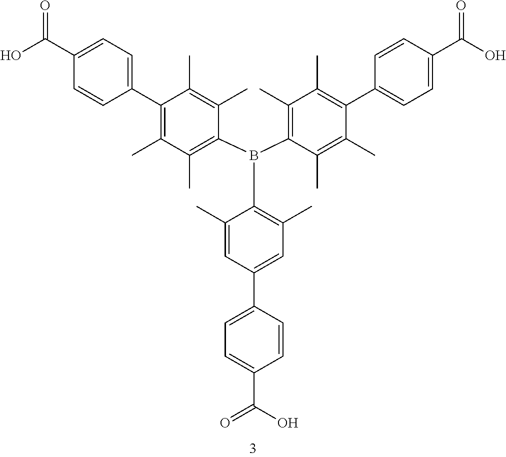 [SMILES: Cc1cc(-c2ccc(C(=O)O)cc2)cc(C)c1B(c1c(C)c(C)c(-c2ccc(C(=O)O)cc2)c(C)c1C)c1c(C)c(C)c(-c2ccc(C(=O)O)cc2)c(C)c1C]

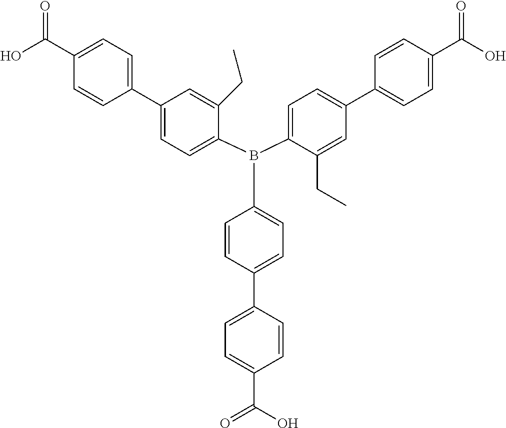 [SMILES: CCc1cc(-c2ccc(C(=O)O)cc2)ccc1B(c1ccc(-c2ccc(C(=O)O)cc2)cc1)c1ccc(-c2ccc(C(=O)O)cc2)cc1CC]

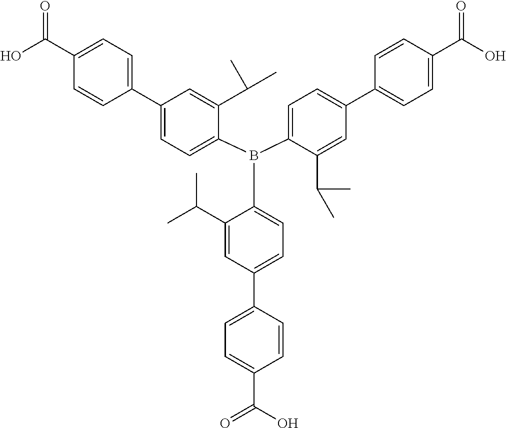 [SMILES: CC(C)c1cc(-c2ccc(C(=O)O)cc2)ccc1B(c1ccc(-c2ccc(C(=O)O)cc2)cc1C(C)C)c1ccc(-c2ccc(C(=O)O)cc2)cc1C(C)C]

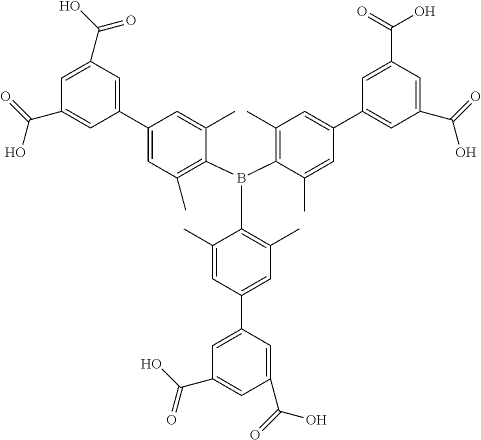 [SMILES: Cc1cc(-c2cc(C(=O)O)cc(C(=O)O)c2)cc(C)c1B(c1c(C)cc(-c2cc(C(=O)O)cc(C(=O)O)c2)cc1C)c1c(C)cc(-c2cc(C(=O)O)cc(C(=O)O)c2)cc1C]

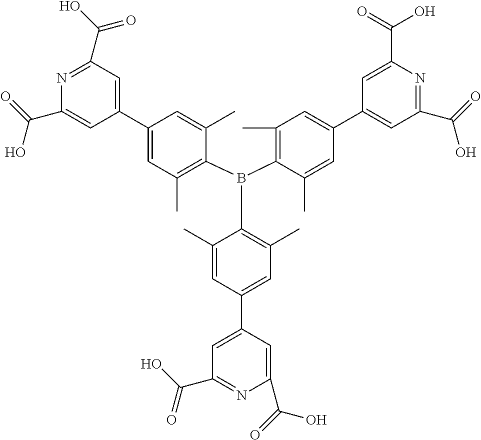 [SMILES: Cc1cc(-c2cc(C(=O)O)nc(C(=O)O)c2)cc(C)c1B(c1c(C)cc(-c2cc(C(=O)O)nc(C(=O)O)c2)cc1C)c1c(C)cc(-c2cc(C(=O)O)nc(C(=O)O)c2)cc1C]

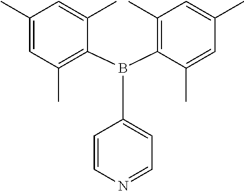

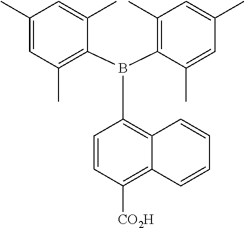

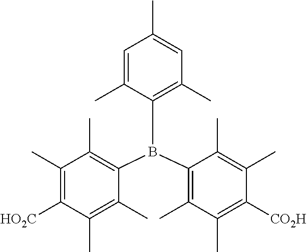 [SMILES: Cc1cc(C)c(B(c2c(C)c(C)c(C(=O)O)c(C)c2C)c2c(C)c(C)c(C(=O)O)c(C)c2C)c(C)c1]

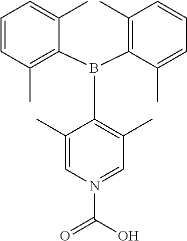

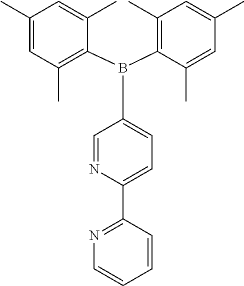

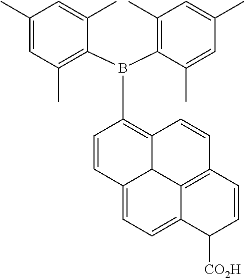

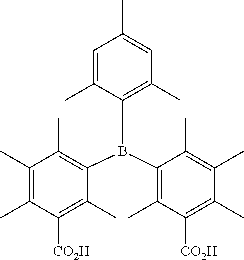

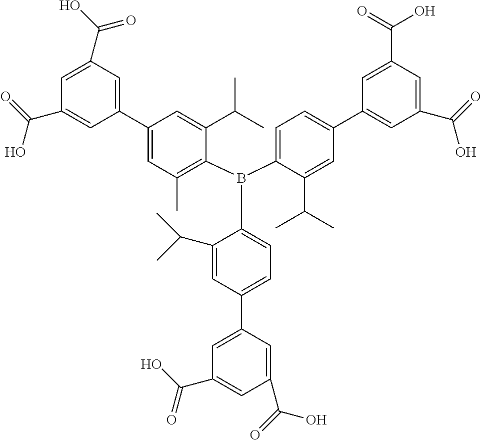 [SMILES: Cc1cc(-c2cc(C(=O)O)cc(C(=O)O)c2)cc(C(C)C)c1B(c1ccc(-c2cc(C(=O)O)cc(C(=O)O)c2)cc1C(C)C)c1ccc(-c2cc(C(=O)O)cc(C(=O)O)c2)cc1C(C)C]

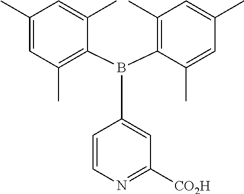

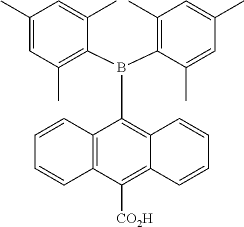

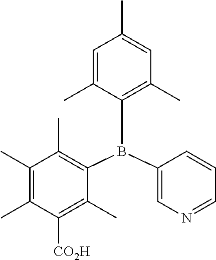 [SMILES: Cc1cc(C)c(B(c2cccnc2)c2c(C)c(C)c(C)c(C(=O)O)c2C)c(C)c1]

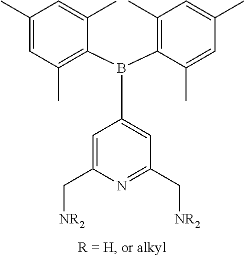

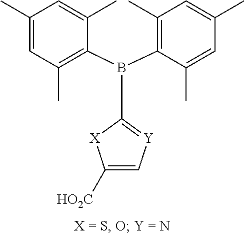

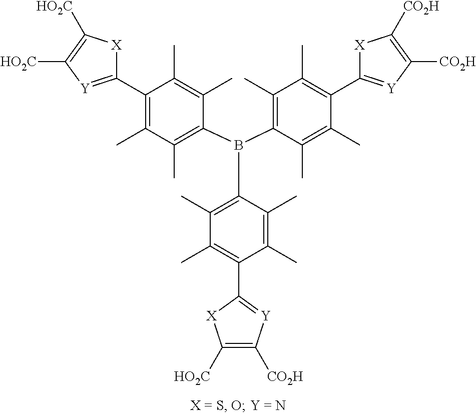

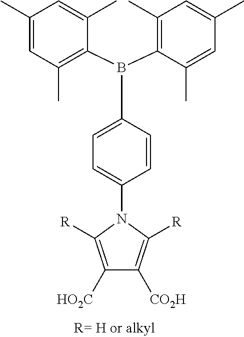

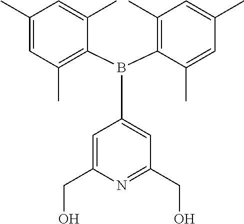

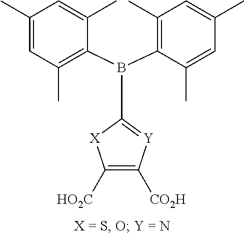

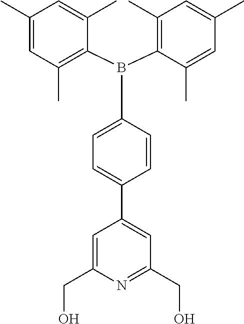

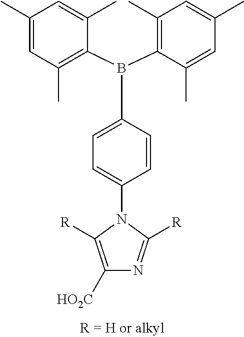

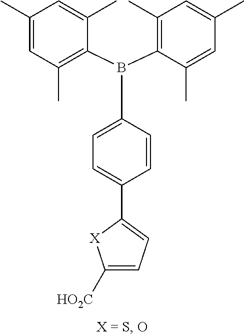

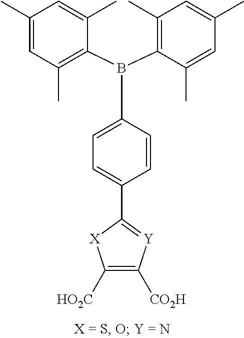

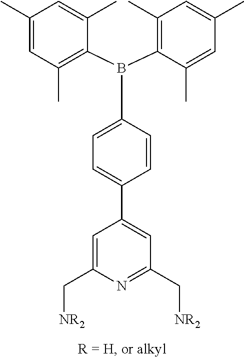

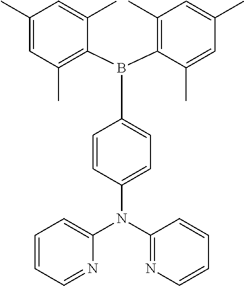

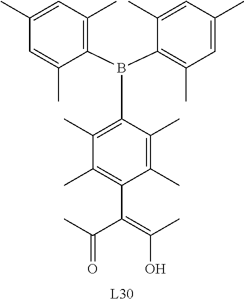

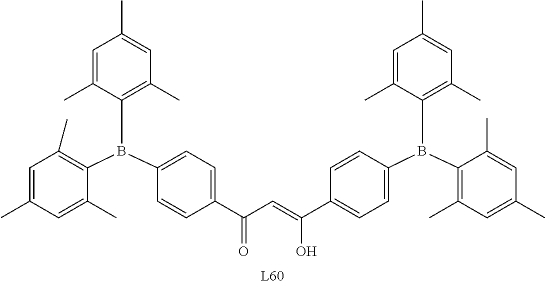

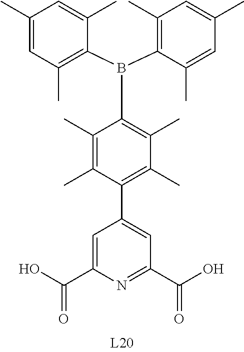

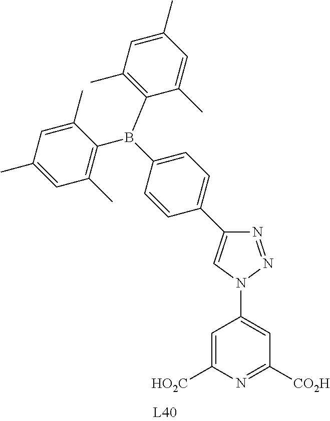 [SMILES: Cc1cc(C)c(B(c2ccc(-c3cn(-c4cc(C(=O)O)nc(C(=O)O)c4)nn3)cc2)c2c(C)cc(C)cc2C)c(C)c1]

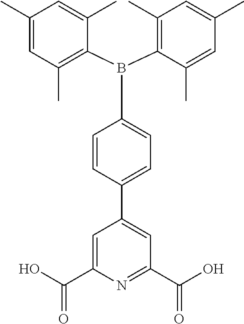

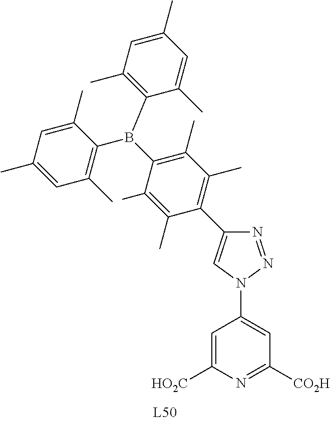 [SMILES: Cc1cc(C)c(B(c2c(C)cc(C)cc2C)c2c(C)c(C)c(-c3cn(-c4cc(C(=O)O)nc(C(=O)O)c4)nn3)c(C)c2C)c(C)c1]

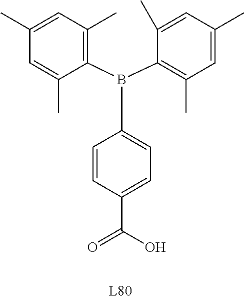

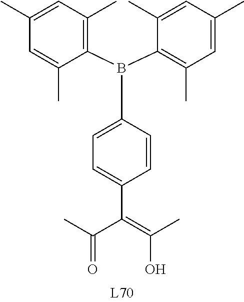

TABLE 4
Photophysical properties of Eu-10 and Eu-20.

| | | | | Φₛₒₗ/ | Φₛₛ/ |
|---|---|---|---|---|---|
| com- | λ_{abs} (nm) | | τ | Lanthanide | Lanthanide |
| plex | (ε, M⁻¹ cm⁻¹) | λₑₘ (nm) | (ms) | emission | emission |
| Eu-10 | 334 (104 015) | 595, 617 | 1.67 | 0.62 | 0.15 |
| Eu-20 | 333 (49 723) | 594, 617 | 1.72 | 0.36 | 0.06 |

Φₛₒₗ: emission quantum efficiency in solution (THF).
Φₛₛ: emission quantum efficiency in the solid state.

We claim:

1. A method of enhancing luminescence of rare earth metal ions comprising:
reacting rare earth metal ions with a triarylboron ligand to form a complex; and
irradiating the complex with UV light,
wherein the triarylboron ligand comprises (a) a binding portion and (b) a boron atom that is bound to three aryl moieties such that there are six positions of the aryl moieties that are ortho to the boron and the boron is sterically encumbered by substituents at two or more of the six ortho positions, wherein (i) at least two substituents at the six ortho positions comprise two or more carbons or (ii) at least four substituents at the six ortho positions are C₁.

2. The method of claim 1, wherein the aryl moieties are heteroaryl.

3. The method of claim 2, wherein the heteroatom of the heteroaryl participates in binding the rare earth metal ion.

4. The method of any one of claims 1 to 3, wherein the rare earth metal is lanthanum, cerium, praseodymium, neodymium, promethium, samarium, europium, gadolinium, terbium, dysprosium, holmium, erbium, thulium, ytterbium, or lutetium.

5. The method of any one of claims 1 to 3, wherein the rare earth metal is scandium or yttrium.

6. The method of any one of claims 1 to 4, wherein the rare earth metal is Tb or Eu.

7. The method of any one of claims 1 to 3, wherein the complex is 1Tb, 1Eu, 2Tb, 2Eu, 3Tb, 4Tb, 5Eu, 6Eu, Tb(L20)₃(Lₙₒₙ₋ₑₘᵢₛₛᵢᵥₑ)ₓ, Tb(L30)₃(Lₙₒₙ₋ₑₘᵢₛₛᵢᵥₑ)ₓ, Tb(L60) (Lₙₒₙ₋ₑₘᵢₛₛᵢᵥₑ)ₓ, Eu-10, Eu-20, or Eu-L60(Lₙₒₙ₋ₑₘᵢₛₛᵢᵥₑ)ₓ, Tb(L60)₃(Lₙₒₙ₋ₑₘᵢₛₛᵢᵥₑ)ₓ, Tb(L70)₃(Lₙₒₙ₋ₑₘᵢₛₛᵢᵥₑ)ₓ, Tb(L80)₃(Lₙₒₙ₋ₑₘᵢₛₛᵢᵥₑ)ₓ, Eu(L20)₃(Lₙₒₙ₋ₑₘᵢₛₛᵢᵥₑ)ₓ, Eu(L30)₃(Lₙₒₙ₋ₑₘᵢₛₛᵢᵥₑ)ₓ, Eu(L60)₃(Lₙₒₙ₋ₑₘᵢₛₛᵢᵥₑ)ₓ, Eu(L70)₃(Lₙₒₙ₋ₑₘᵢₛₛᵢᵥₑ)ₓ, or Eu(L80)₃(Lₙₒₙ₋ₑₘᵢₛₛᵢᵥₑ)ₓ, where x is a number from 1 to 6.

8. The method of any one of claims 1 to 7, wherein the triarylboron ligand is represented by a compound of formula (I) 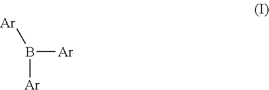
where B is boron; and
Ar is an aryl moiety that is a substituted or unsubstituted 5- or 6-membered ring that is optionally part of a fused ring system;
wherein the B is sterically encumbered by the presence of same or different non-hydrogen substituents located ortho to the boron, wherein if the substituents are only C₁, then at least four of the ortho positions are C₁, and if the substituents are C_{2-or-higher}, then at least two of the ortho positions are C_{2-or-higher}, and
wherein at least one Ar comprises a moiety that can bind to a metal ion.

9. The method of any one of claims 1 to 8, wherein the ligand is represented by a compound of formula (II): 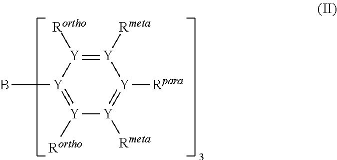
where B is boron;
Y is C or a heteroatom;
R^{meta} and R^{para} are independently H, C₁-C₆ aliphatic, or aryl, and optionally are further substituted by COOH, COOR; C(O)C═C(OH)R, arylCOOH, aryl(COOH)₂, arylNR₂ (R═H, pyridyl or aliphatic), aliphatic-OH, aliphatic-COOH, or combinations thereof; and
R^{ortho} is H or C₁-C₄ aliphatic;
wherein B is sterically encumbered such that at least four of the six R^{ortho}'s are non-hydrogen when R^{ortho} is H or C₁;
wherein at least two of the six R^{ortho}'s are non-hydrogen when R^{ortho} is H or C_{2-or-higher}; and
wherein the compound comprises a moiety that is capable of bonding with a rare earth metal ion.

10. The method of claim 9, wherein the moiety that is capable of bonding with a rare earth metal ion is carboxy.

11. The method of claim 1, wherein all six of the ortho positions are non-hydrogen.

12. A method of detecting fluoride, cyanide or a biological marker comprising:
contacting a test solution that potentially comprises fluoride, cyanide or a biological marker with a medium comprising a triarylboron bound-rare earth metal complex;
irradiating the medium with UV light; and
determining whether luminescence is produced at the wavelength of the ligand's fluorescence thereby indicating the presence of fluoride, cyanide or a biological marker, or whether luminescence is produced at the wavelength of the metal ion's emission indicating the absence of fluoride, cyanide or a biological marker;
wherein the triarylboron bound-rare earth metal complex comprises a triarylboron ligand, which comprises a boron bound to three aryl moieties having a total of six ortho positions relative to the boron, and the boron is sterically encumbered by substituents that are located at two or more of the six ortho positions, wherein (i) at least two of the six ortho positions are independently C_{2 or higher}, or (ii) at least four of the six ortho positions are C₁, and optionally all six of the ortho positions are non-hydrogen.

13. The method of claim 12, wherein the medium is liquid.

14. The method of claim 12, wherein the medium is paper impregnated with the complex.

15. The method of claim 12, wherein the medium is a polymer or resin.

16. A metal complex compound comprising:
a rare earth metal ion; and
a triaryl boron ligand,
wherein the triarylboron ligand comprises a boron atom bound to three substituted or unsubstituted aryl moieties such that there are six substituent positions on the aryl moieties that are ortho to the boron, and the boron is sterically encumbered by substituents at two or more of the six ortho positions, wherein (i) at least two of the six ortho positions are C_{2-or-higher} or (ii) at least four of the six ortho positions are C₁, and optionally all six of the ortho positions are non-hydrogen, and
wherein at least one of the three aryl moieties comprises a moiety that is capable of binding a rare earth metal ion.

17. The compound of claim 16, wherein the aryl moieties are heteroaryl.

18. The compound of claim 16, wherein the three aryl moieties are mesityl, mesityl and benzoate.

19. The compound of claim 16, wherein the three aryl moieties are mesityl, mesityl and diphenylcarboxylate.

20. The compound of claim 16, wherein at least one aryl moiety is carboxy-substituted.

21. The compound of claim 16, wherein two of the aryl moieties are carboxy-substituted.

22. The compound of claim 16, wherein three of the aryl moieties are carboxy-substituted.

23. The compound of claim 16, wherein an aryl moiety is pyridine.

24. The compound of claim 23, wherein the moiety that is capable of binding a rare earth metal ion is the nitrogen of the pyridine ring.

25. The compound of claim 16, wherein the ligand is a ligand that is shown in Table 3.

26. Ligand 4, Ligand 5, Ligand 6, L10, L20, L30, L40, L50, L60, L70, or L80.

27. 1Tb, 1Eu, 2Tb, 2Eu, 3Tb, 4Tb, 5Eu, 6Eu, Tb(L20)₃(Lₙₒₙ₋ₑₘᵢₛₛᵢᵥₑ)ₓ, Tb(L30)₃(Lₙₒₙ₋ₑₘᵢₛₛᵢᵥₑ)ₓ, Tb(L60)₃(Lₙₒₙ₋ₑₘᵢₛₛᵢᵥₑ)ₓ, Eu-10, Eu-20, Eu(L60)₃(Lₙₒₙ₋ₑₘᵢₛₛᵢᵥₑ)ₓ, Tb(L60)₃(Lₙₒₙ₋ₑₘᵢₛₛᵢᵥₑ)ₓ, Tb(L70)₃(Lₙₒₙ₋ₑₘᵢₛₛᵢᵥₑ)ₓ, Tb(L80)₃(Lₙₒₙ₋ₑₘᵢₛₛᵢᵥₑ)ₓ, Eu(L20)₃(Lₙₒₙ₋ₑₘᵢₛₛᵢᵥₑ)ₓ, Eu(L30)₃(Lₙₒₙ₋ₑₘᵢₛₛᵢᵥₑ)ₓ, Eu(L60)₃(Lₙₒₙ₋ₑₘᵢₛₛᵢᵥₑ)ₓ, Eu(L60)₃(Lₙₒₙ₋ₑₘᵢₛₛᵢᵥₑ)ₓ, Eu(L70)₃(Lₙₒₙ₋ₑₘᵢₛₛᵢᵥₑ)ₓ, or Eu(L80)₃(Lₙₒₙ₋ₑₘᵢₛₛᵢᵥₑ)ₓ, where x is a number from 1 to 6, and Lₙₒₙ₋ₑₘᵢₛₛᵢᵥₑ is a ligand that does not enhance Ln emission.

28. Use of the compound of claim 16 or 27 as dye that is substantially non-visible under visible light and becomes visible when contacted with UV light.

29. Use of the compound of claim 16 or 27 in paint that is substantially non-visible under visible light and becomes visible when contacted with UV light.

30. Use of the compound of claim 16 or 27 in ink that is substantially non-visible under visible light and becomes visible when contacted with UV light.

31. The use of claim 30, wherein the ink is used as an anti-counterfeiting tool.

32. The use of claim 30, wherein the ink is used as an anti-theft marking tool.

33. The use of claim 30, wherein the ink is printing ink.

34. Use of the compound of claim 16 or 27 in an electroluminescent device, sensor, or for cellular imaging.

35. The use of claim 34, wherein the electroluminescent device is an organic light emitting diode (OLED) or a light emitting diode (LED).

36. Use of the compound of claim 16 or 27 as a molecular switch, wherein presence of fluoride or cyanide acts as a trigger turning luminescence from the triarylboron ligand on and turning luminescence from the metal complex off.

37. A method of making 1Tb, comprising:
combining dissolved potassium 4-(dimesitylboryl)-2,3,5,6-tetramethylbenzoate and dissolved Tb(NO₃)₃.6H₂O; and
isolating product 1Tb.

38. A method of making 2Tb, comprising:
combining dissolved potassium 4′-(dimesitylboryl)biphenyl-4-carboxylate and dissolved Tb(NO₃)₃.6H₂O; and
isolating product 2Tb.

39. A method of making 1Eu, comprising:
combining dissolved Eu(NO₃)₃.6H₂O and dissolved 4-(dimesitylboryl)-2,3,5,6-tetramethylbenzoate; and
isolating product 1Eu.

40. A method of making 2Eu, comprising:
combining dissolved Eu(NO₃)₃.6H₂O and dissolved potassium 4′-(dimesitylboryl)biphenyl-4-carboxylate; and
isolating product 2Eu.

41. A method of making 3Tb, comprising:
combining dissolved Tb(NO₃)₃.6H₂O and dissolved tris(2′,3′,5′,6′-tetramethylbiphenyl-4-carboxylic acid)borane; and
isolating product 3Tb.

42. A method of making 4Tb, comprising:
combining dissolved Tb(NO₃)₃.6H₂O and dissolved tris(2,3,5,6-tetramethyl-4-benzoic acid)borane; and
isolating product 4Tb.

43. A method of making 5Eu, comprising:
forming a suspension of 5 and 1,10-phenanthroline;
heating;
increasing pH;
mixing the suspension with dissolved Europium(III)-chloride.6H₂O; and
isolating 5Eu.

44. A method of making 6Eu, comprising:
forming a suspension of 6 and 1,10-phenanthroline;
heating;
increasing pH;
mixing the suspension with dissolved Europium(III)-chloride.6H₂O;
heating to about 60° C.;
cooling; and
isolating 6Eu.

45. A method of making Ln-10, Ln-20, Ln(L30)₃(Lₙₒₙ₋ₑₘᵢₛₛᵢᵥₑ)ₓ, Ln(L40)₃(Lₙₒₙ₋ₑₘᵢₛₛᵢᵥₑ)ₓ, Ln(L50)₃(Lₙₒₙ₋ₑₘᵢₛₛᵢᵥₑ)ₓ, Ln(L60)₃(Lₙₒₙ₋ₑₘᵢₛₛᵢᵥₑ)ₓ, Ln(L70)₃(Lₙₒₙ₋ₑₘᵢₛₛᵢᵥₑ)ₓ, Ln(L80)₃(Lₙₒₙ₋ₑₘᵢₛₛᵢᵥₑ)ₓ comprising:
forming a suspension of Lₙₒₙ₋ₑₘᵢₛₛᵢᵥₑ and boryl ligand L-10, L-20, L30, L40, L50, L60, L70, or L80;
optionally heating;
increasing pH;
mixing the suspension with dissolved Ln(III) salt;
optionally heating;
cooling; and
isolating Ln(boryl ligand)₃(Lₙₒₙ₋ₑₘᵢₛₛᵢᵥₑ)ₓ,
where x is a number between 1 and 6 and Lₙₒₙ₋ₑₘᵢₛₛᵢᵥₑ is a ligand that does not enhance Ln emission.

46. A compound of general formula Ln(Bacac)₃(Lₙₒₙ₋ₑₘᵢₛₛᵢᵥₑ)ₓ, where Ln is a rare earth metal ion, Bacac can be the same or different and is a boryl functionalized diketone liand, Lₙₒₙ₋ₑₘᵢₛₛᵢᵥₑ is the same or different and is a non-emissive ligand, and x is a number from 1 to 6.

47. The compound of claim 46, wherein the Lₙₒₙ₋ₑₘᵢₛₛᵢᵥₑ is independently a chelate ligand, H₂O, alcohol, TOPO, or a combination thereof.

48. The compound of claim 46 or 47, wherein Ln(Bacac)₃(Lₙₒₙ₋ₑₘᵢₛₛᵢᵥₑ)ₓ is Ln(L30)₃(Lₙₒₙ₋ₑₘᵢₛₛᵢᵥₑ)ₓ, or Ln(L60)₃(Lₙₒₙ₋ₑₘᵢₛₛᵢᵥₑ)ₓ.

49. The compound of any one of claims 46 to 48, wherein Ln is Tb or Eu.
